(19) United States
(12) Patent Application Publication
(10) Pub. No.: US 2022/0386635 A1
(43) Pub. Date: Dec. 8, 2022

(54) NITRITE REPLACEMENT (CURING AIDS) CONTAINING NATURAL INGREDIENTS

(71) Applicant: KEMIN INDUSTRIES, INC., DES MOINES, IA (US)

(72) Inventors: Ines Colle, Bouwel (BE); Anja Verbiest, Olen (BE)

(73) Assignee: KEMIN INDUSTRIES, INC., DES MOINES, IA (US)

(21) Appl. No.: 17/723,433

(22) Filed: Apr. 18, 2022

Related U.S. Application Data
(60) Provisional application No. 63/176,331, filed on Apr. 18, 2021.

(51) Int. Cl. A23B 4/12; A23B 4/18; A23L 13/40

(52) U.S. Cl. CPC A23B 4/12; A23B 4/18; A23L 13/428; A23V 2002/00

(57) ABSTRACT

The present invention relates to a new curing aid that is nitrite replacement. The composition comprises natural ingredients, including but not limited to a blend of buffered dry vinegar and red radish, and optionally rosemary extract and green tea extract, in various ratios, which working together are able to mimic the desirable functions of nitrite in cured or processed meat including controlling the growth of Clostridium botulinum and Listeria monocytogenes.

### CROSS-REFERENCE TO RELATED APPLICATIONS

This application claims the benefit of priority to U.S. Provisional Patent Application No. 63/176,331, filed Apr. 18, 2021, entitled “NITRITE REPLACEMENT (CURING AIDS) CONTAINING NATURAL INGREDIENTS,” the entire disclosure of which is hereby incorporated by reference in its entirety.

### BACKGROUND OF THE INVENTION

In the 1950s and 1960s the potential to form carcinogenic nitrosamines in the stomach following ingestion of nitrite from food was discovered. Sindelar, J. J. and A. L. Milkowski, Human safety controversies surrounding nitrate and nitrite in the diet, Nitric Oxide. 26: 259-266 (2012). Most discussions regarding the safety of consumption of cured meat have focused on the deliberate addition of nitrite salts during the production process (Sindelar).

These public debates about the safety of cured meat left nitrite salt with a bad image. In addition, the consumer-driven increased demand for label-friendly meat products has challenged meat scientists to search for suitable alternatives. To date, attempts to identify an effective single replacement for nitrite have been unsuccessful. Alahakoon, A. U., D. D. Jayasena, S. Ramachandra, and C. Jo, Alternatives to nitrite in processed meat: Up to date. Trends in Food Science & Technology, 45: 37-49 (2015). Nitrite salt is known to be a multifunctional food additive. That multi-functionality has made it difficult to identify an alternative that confers all the properties and known benefits of nitrite. For instance, nitrite is responsible for the formation of the characteristic reddish-pink color of cooked cured meat. In addition, it protects against lipid oxidation and serves as an effective antimicrobial agent. For instance, nitrite suppresses the outgrowth of Clostridium botulinum and controls botulism. It also inhibits the growth and controls pathogens such as Listeria monocytogenes.

Anthocyanins are a class of natural pigments responsible for the red to blue colors of a wide range of fruits, vegetables, flowers, leaves, roots and other plant storage organs. Giusti, M. M. and R. E. Wrolstad, Acylated anthocyanins from edible sources and their applications in food systems, Biochemical engineering Journal. 14: 217-225 (2003). Anthocyanins are extracted from varying natural sources with water, concentrated, pasteurised and subsequently spray dried to powder formulations with maltodextrin as a carrier. Sajilata, M. and R. Singhal, Isolation and stabilisation of natural pigments for food applications, Stewart Postharvest Review. 2: 1-29 (2006). They have been used as food coloring, Guidance notes on the classification of food extracts with coloring properties (2013), with main applications in beverages, fruit preparations, confectionery and water ice (Sajilata).

Anthocyanins are most stable in foods of low pH and known to be susceptible to light, temperature, oxygen and enzymes (Sajilata). Findings of acylated anthocyanins with increased stability has increased commercial interest in anthocyanin pigments. Bakowska-Barczak, A., Acylated anthocyanins as stable, natural food colorants-a review, Polish Journal of Food and Nutrition Sciences. 14: 55 (2005). Red radish contains a significant amount of these acylated anthocyanins. The primary anthocyanins identified from red radishes are pelargonidin-3-sophoroside-5-glucoside derivatives. See, e.g., Giusti, M. M., H. Ghanadan, and R. E. Wrolstad, Elucidation of the structure and conformation of red radish (raphanus sativus) anthocyanins using one- and two-dimensional nuclear magnetic resonance techniques. Journal of Agricultural and Food Chemistry. 46: 4858-4863 (1998); Otsuki, T., H. Matsufuji, M. Takeda, M. Toyoda, and Y. Goda, Acylated anthocyanins from red radish (raphanus sativus l.), Phytochemistry. 60: 79-87 (2002); Wu, X. and R. L. Prior, Identification and characterization of anthocyanins by high-performance liquid chromatography—electrospray ionization—tandem mass spectrometry in common foods in the United States: Vegetables, nuts, and grains, Journal of Agricultural and Food Chemistry. 53: 3101-3113 (2005); Jing, P., S.-J. Zhao, S.-Y. Ruan, Z.-H. Xie, Y. Dong, and L. Yu, Anthocyanin and glucosinolate occurrences in the roots of Chinese red radish (raphanus sativus l.), and their stability to heat and pH, Food Chemistry. 133: 1569-1576 (2012).

The structures found in red radish are highly conjugated with sugars and acylated groups. As shown below, there are at least 12 anthocyanins structures found in red radish. However, Wu et al. (2005) identified up to 34 different complex structures. The two predominant anthocyanins that have been reported were pelargonidin-3-(p-coumaroyl)diglucoside-5-(malonoyl)glucoside and 3-(feruloyl)diglucoside-5-(malonoyl)glucoside.

Structures of anthocyanins from red radish (Otsuki et al. 2002)

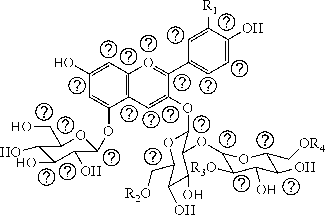

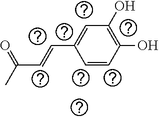

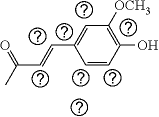

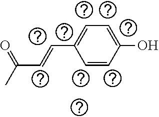

| Compound | R₁ | R₂ | R₃ | R₄ |
|---|---|---|---|---|
| 1 | H | H | H | feruloyl |
| 2 | OH | caffeoyl | H | feruloyl |
| 3 | H | caffeoyl | H | H |
| 4 | H | caffeoyl | H | caffeoyl |
| 5 | H | caffeoyl | H | feruloyl |
| 6 | H | p-coumaroyl | H | H |
| 7 | H | p-coumaroyl | H | caffeoyl |
| 8 | H | feruloyl | H | H |
| 9 | H | feruloyl | H | caffeoyl |
| 10 | H | p-coumaroyl | H | feruloyl |
| 11 | H | feruloyl | H | feruloyl |
| 12 | H | feruloyl | feruloyl | H |

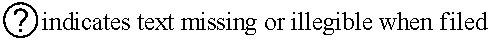

Red radish imparts orange-red colors, similar to FD&C No 40 (allura red), a synthetic food colorant. Giutsi (2003); Matsufuji, H., H. Kido, H. Misawa, J. Yaguchi, T. Otsuki, M. Chino, M. Takeda, and K. Yamagata, Stability to light, heat, and hydrogen peroxide at different pH values and dpph radical scavenging activity of acylated anthocyanins from red radish extract. Journal of Agricultural and Food Chemistry. 55: 3692-3701 (2007). Under acidic conditions in model juice systems, pelargonidins derivatives from red radish were able to match the color characteristics of allura red. Rodriguez-Saona, L. E., M. M. Giusti, and R. E. Wrolstad, Color and pigment stability of red radish and red-fleshed potato anthocyanins in juice model systems, Journal of Food Science. 64: 451-456 (1999).

Around neutral pH, however, anthocyanin and their complexes typically express purple colors and even slight changes in pH have a large effect on the resulting hue. Bakowska-Barczak (2005). For example, the acylated anthocyanins from black carrot extract provided bright strawberry red shade up to pH 4.5 but exhibit mauve to blue tones under neutral pH conditions. Bakowska-Barczak (2005). Additionally, color loss at neutral and mildly alkaline pHs remains relatively fast even for acylated anthocyanins. The variability of color across pH conditions and color loss has been considered a serious hurdle for any potential industrial commercialization. Fenger, J.-A., R. J. Robbins, T. M. Collins, and O. Dangles, The fate of acylated anthocyanins in mildly heated neutral solution, Dyes and Pigments. 178: 108326 (2020). This has limited the availability of anthocyanins and their complexes in commercial applications where pigment stability is desired across varying pH conditions.

In the food industry, there has been a long-felt need to address consumer preference for nitrite-free products that would be stable under storage conditions, which may vary over time. The researchers have worked to identify a suitable, natural nitrite alternative capable of addressing each of the nitrite functions described herein. Contrary to known limitations regarding anthocyanins and pigment stability across varying pH conditions, the researchers have unexpectedly identified compositions containing buffered dry vinegar and red radish extract that can replace nitrite and serve as a suitable nitrite alternative. The compositions of the present invention comprise different components in various ratios, which working together can mimic the functions of nitrite in processed meat. For instance, the nitrite replacement compositions of the present invention are capable of inhibiting the growth of pathogens, such as Clostridium botulinum and Listeria monocytogenes. Moreover, the compositions of the present invention are able to maintain pigment stability across varying pH conditions and storage conditions, including illuminated conditions, which when considered in view of the known physical characteristics of anthocyanins, was an unexpected and surprising result.

### SUMMARY OF THE INVENTION

The present invention relates to a new label-friendly solution to replace nitrite, which has been a long desired, but unmet need, in the food industry. The researchers have for the first time identified a blended composition that can serve as a nitrite replacement that contains natural ingredients, including for instance a composition that contains an effective amount of buffered vinegar and red radish extract. In at least one embodiment, the composition comprises dry buffered vinegar, red radish extract, and optionally at least one antioxidant. In at least one embodiment, the present invention is a composition that includes blends of an effective amount of buffered vinegar, red radish powder, green tea extract, and rosemary extract to mimic the properties of nitrite, including the ability to inhibit the growth of pathogens, such as Clostridium botulinum and Listeria monocytogenes. At least one embodiment of the present invention is nitrite-free and low in nitrate, and capable of maintaining pigment stability across varying pH conditions and storage conditions. The compositions of the present invention comprise different components in various ratios, which working together are able to mimic each of the desired functions of nitrite in cured meat products, serving as a nitrite replacement.

### DETAILED DESCRIPTION OF THE FIGURES

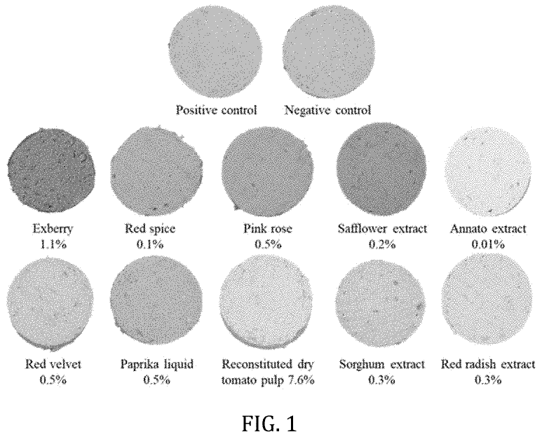

FIG. 1 depicts the appearance of cooked emulsified pork sausages before storage (0.5 cm slices); coloring foods were applied at the dosage suggested by the supplier as summarized in Table 2.

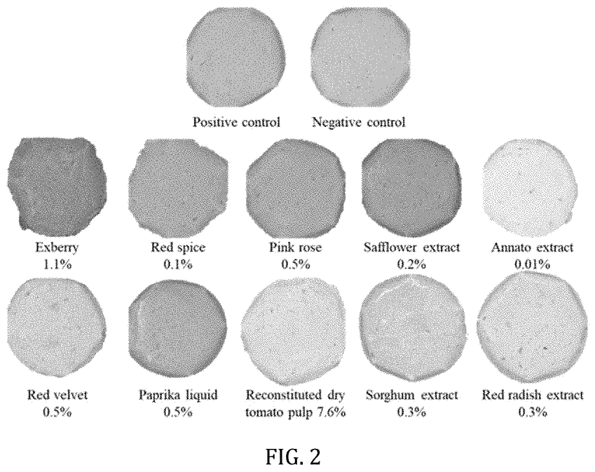

FIG. 2 depicts the appearance of cooked emulsified pork sausages after 72 h of vacuum-packed illuminated storage (0.5 cm slices); coloring foods were applied at dosage suggested by the supplier as summarized in Table 2.

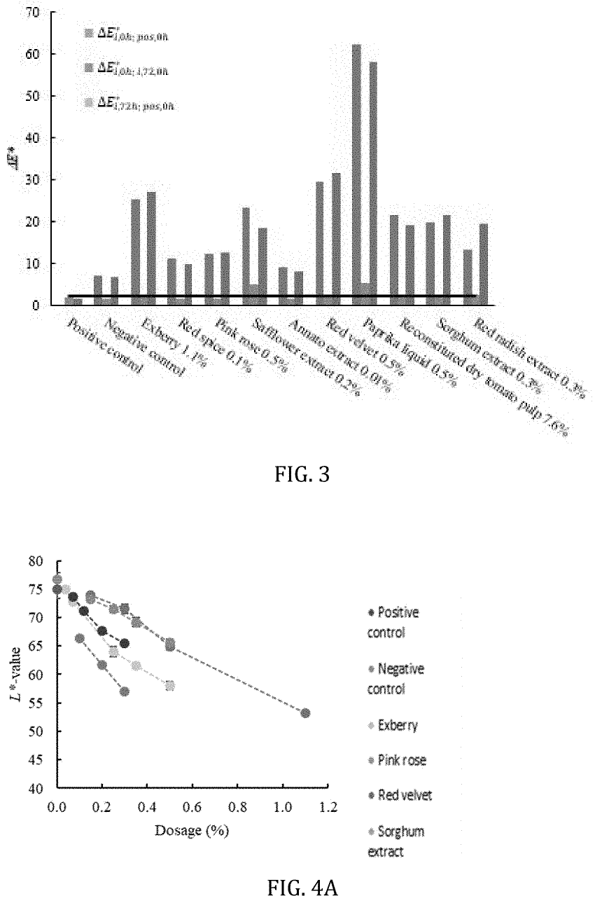

FIG. 3 depicts the color differences of emulsified cooked pork sausages calculated from average L*a*b*-values.

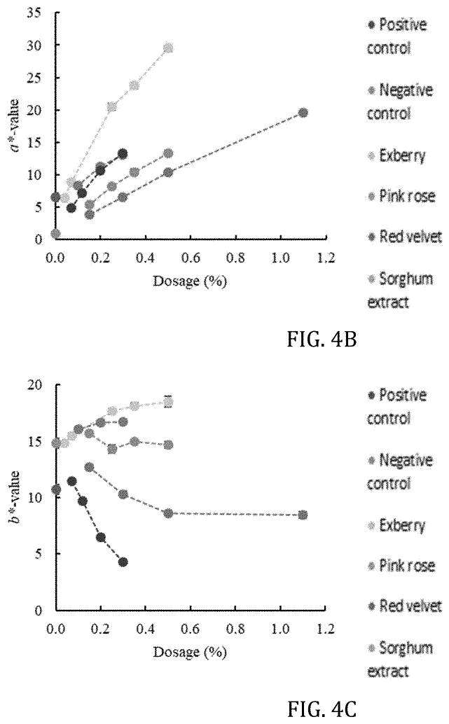

FIG. 4A depicts the color values for lightness (L*); FIG. 4B for redness (a*); and FIG. 4C for yellowness (b*) (average±standard deviation) of cooked emulsified pork sausages before storage (0 h).

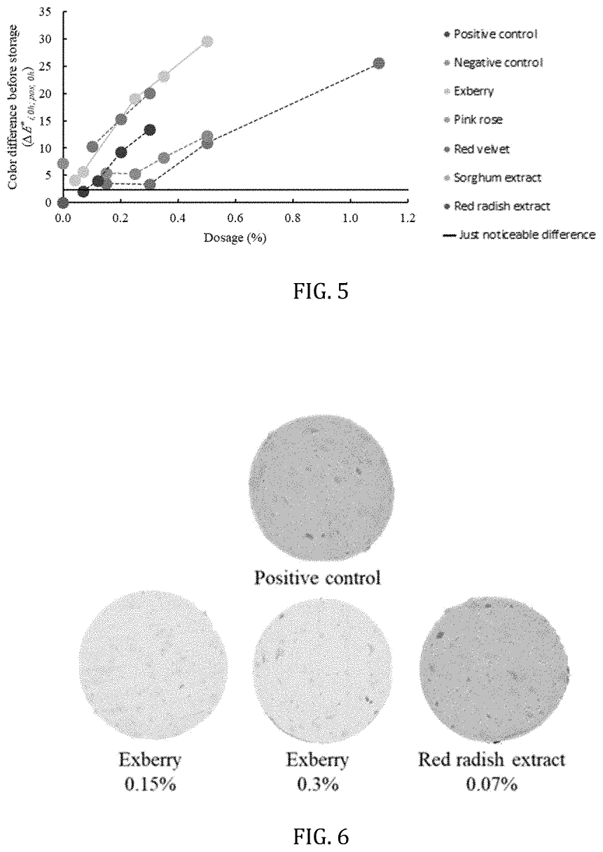

FIG. 5 depicts the color difference (ΔE_{i,0h; pos,0h}*) between the sausage containing different coloring foods before storage and the positive control before storage.

FIG. 6 depicts the appearance of the emulsified cooked pork sausages before storage that showed smallest color difference (ΔE_{i,0h; pos,0h}*) with the positive control (0.5 cm slices).

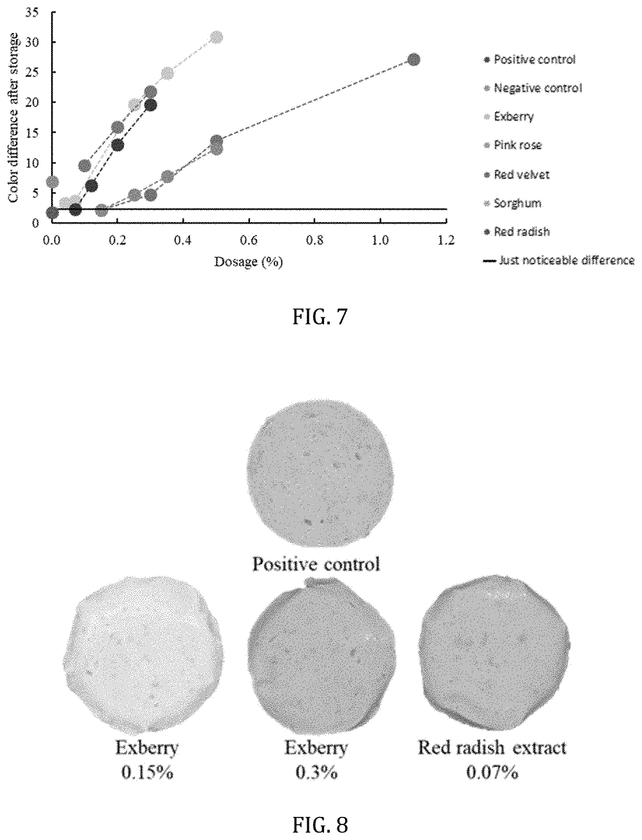

FIG. 7 depicts the color difference (ΔE_{i,72h; pos,0h}*) between the sausage containing different coloring foods after 72 h illuminated storage and the positive control before storage.

FIG. 8 depicts the appearance of the emulsified cooked pork sausages before storage that showed smallest color difference (ΔE(i,0 h; pos,0 h)\hat{ }*) with the positive control (0.5 cm slices).

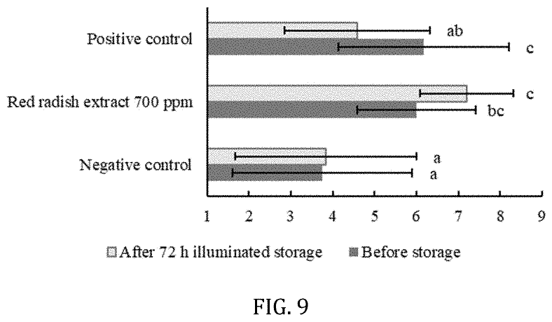

FIG. 9 depicts the sensory acceptance scores (n=12) (average±standard deviation) of cooked emulsified pork sausages before and after 72 h of illuminated storage. Significant differences (p<0.05) are indicated with different letters.

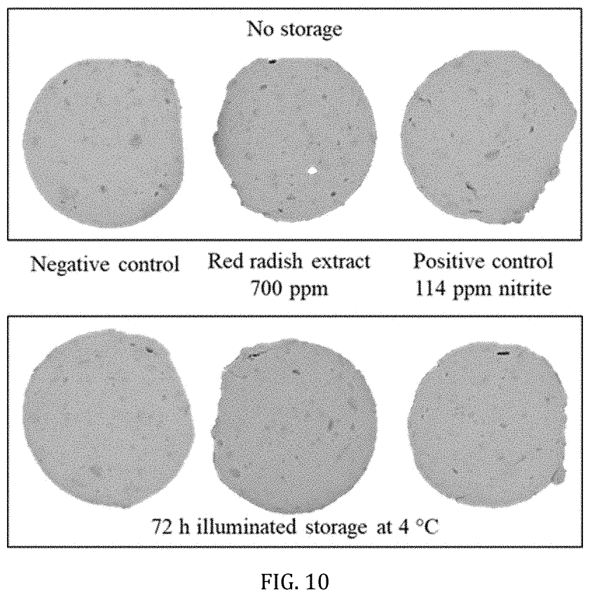

FIG. 10 depicts the appearance of negative control sample, cooked emulsified pork sausage with 0.07% red radish extract and positive control sample (5 mm slices) before and after 72 h of illuminated storage as evaluated by the sensory panel.

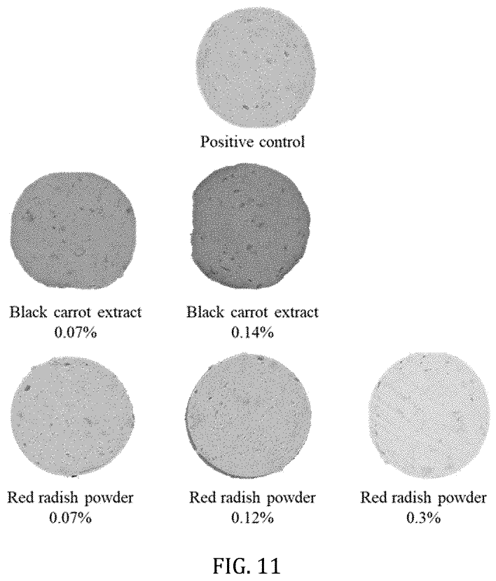

FIG. 11 depicts the appearance of emulsified cooked pork sausages before storage; sausage prepared with red radish powder are depicted for comparison.

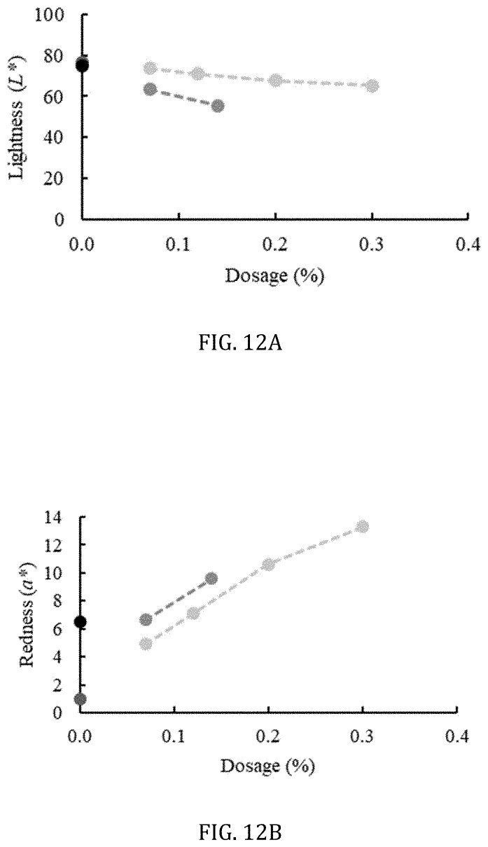

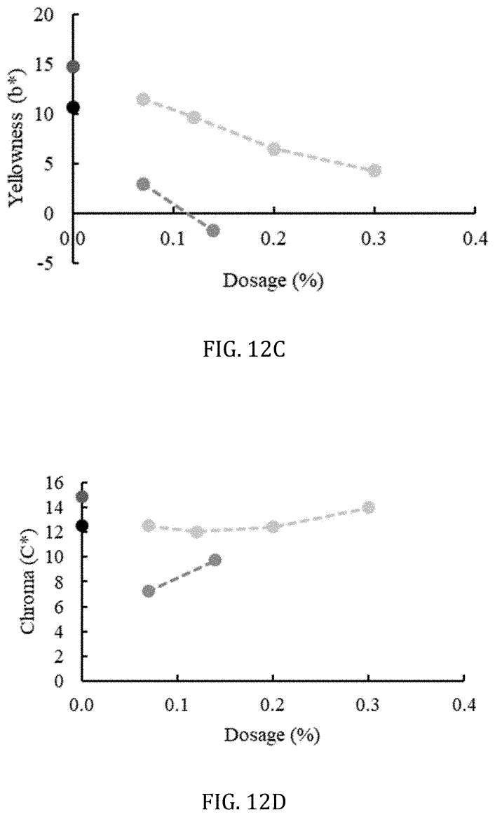

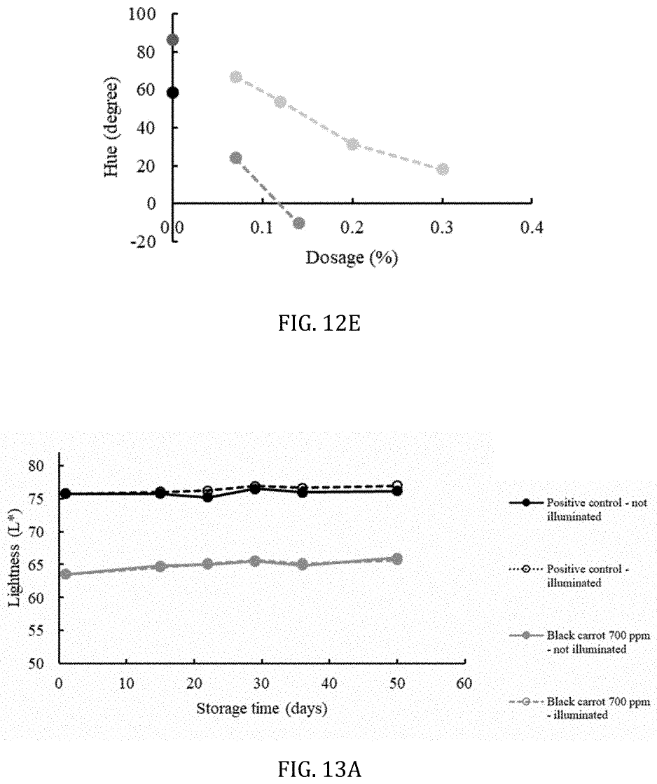

FIG. 12A depicts the color values for lightness (L*); FIG. 12B for redness (a*);

FIG. 12C for yellowness (b*); FIG. 12D for chroma (C*); and FIG. 12E for hue of cooked emulsified pork sausages before storage; sausage prepared with red radish powder are depicted for comparison.

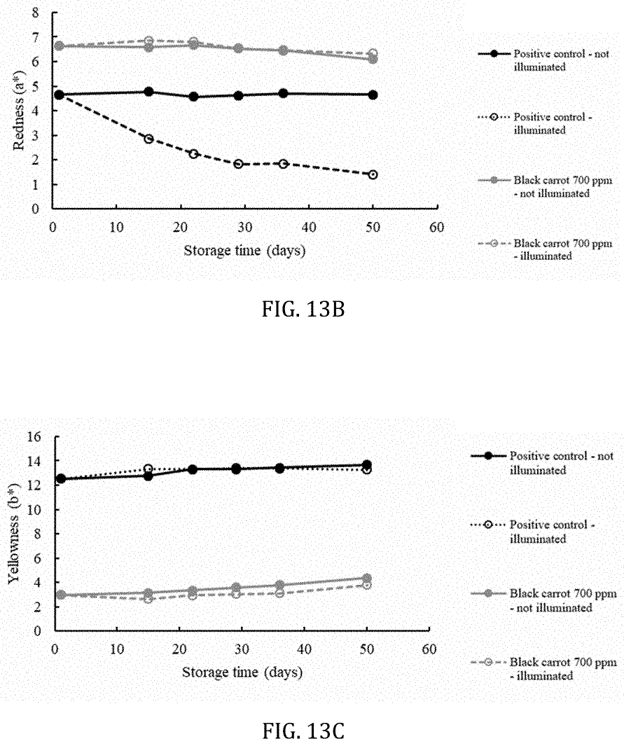

FIG. 13A depicts the color values for lightness (L*); FIG. 13B for redness (a*);

FIG. 13C for yellowness (b*) of emulsified cooked pork sausages stored in the dark or stored including 72 h of illumination.

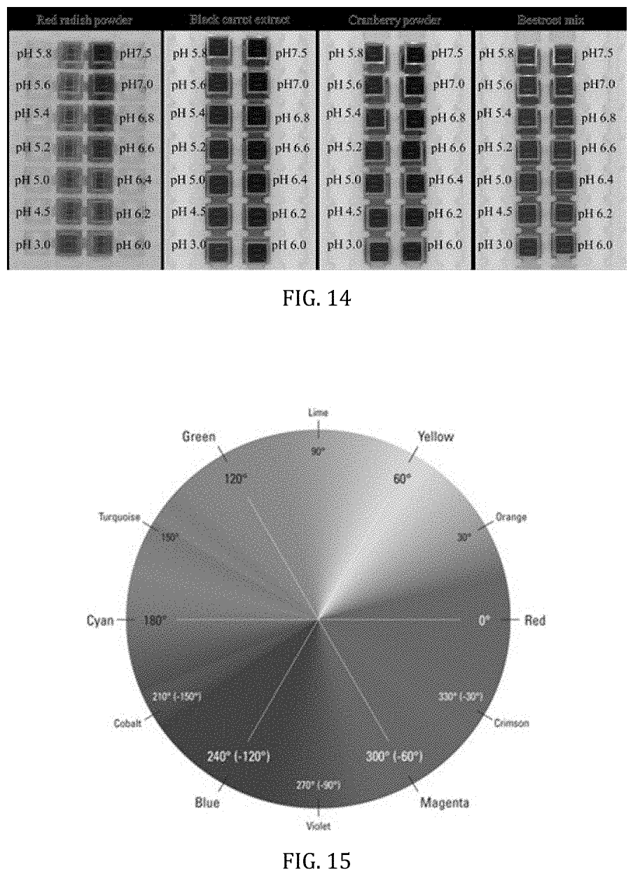

FIG. 14 depicts the coloring foods in citric acid monohydrate-disodium hydrogen phosphate buffer at different pH-levels depicting red radish powder, black carrot extract, cranberry powder and beetroot mix

FIG. 15 is a color wheel to demonstrate the appearance of a hue-value.

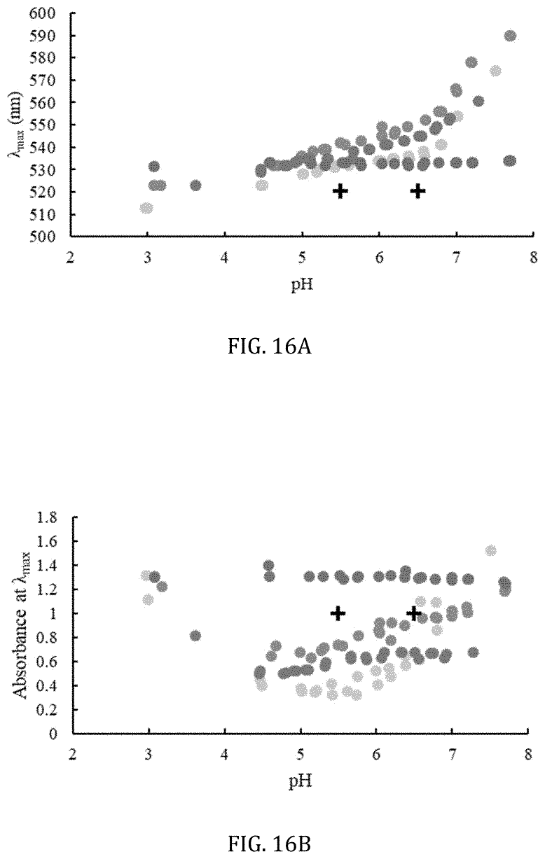

FIG. 16A-B depict pH dependent wavelength of maximal absorbance (Amax) and absorbance at Amax (n=2). The pH-range of interest, being the pH of processed meat, is indicated with (+).

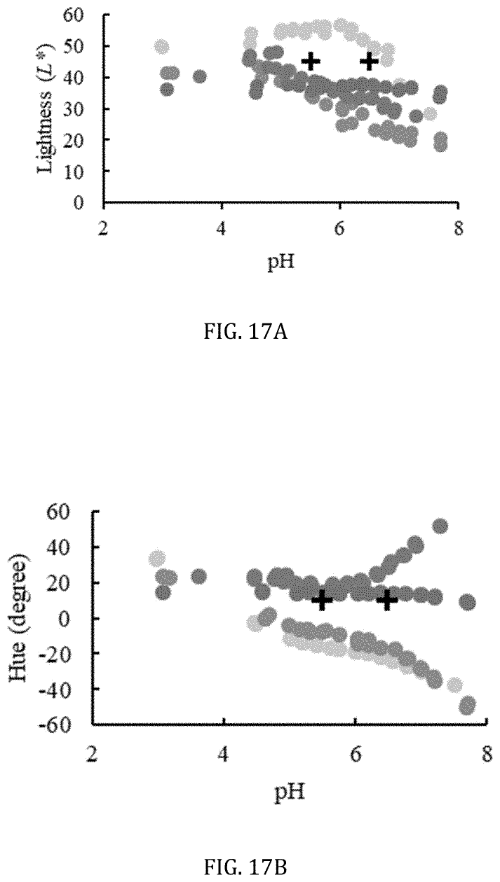

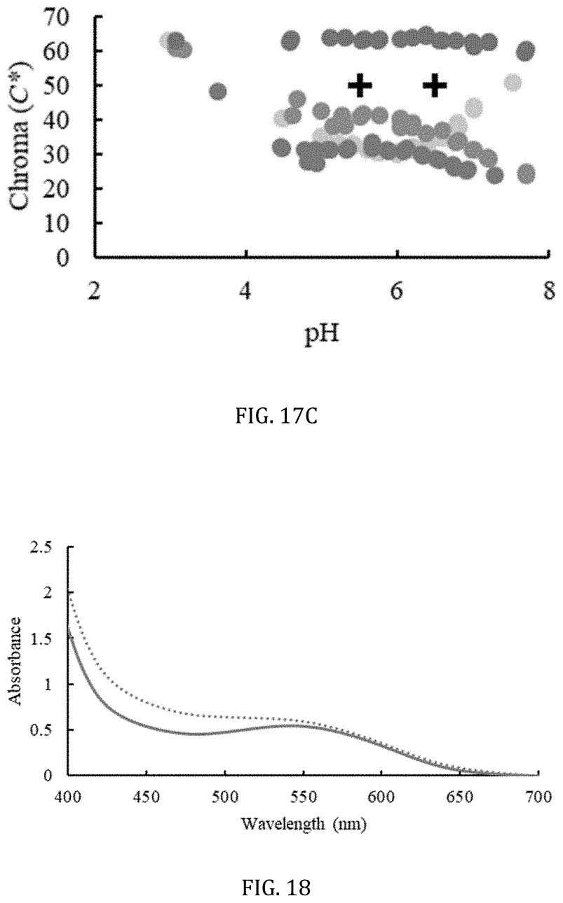

FIG. 17A-C depict pH dependent lightness (L*), hue and chroma (C*) (n=2) of red radish powder, black carrot extract, cranberry powder and beetroot mix. The pH-range of interest, being the pH of processed meat, is indicated with (+).

FIG. 18 depicts the UV-VIS spectra of cranberry powder in citric acid monohydrate-disodium hydrogen phosphate buffer at pH 6.4: not thermally treated and treated during 5 min at 72° C.

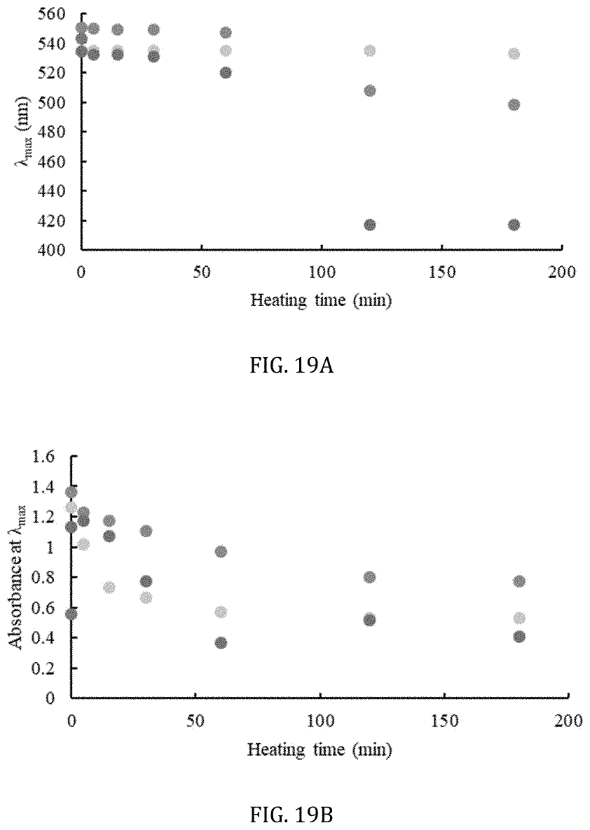

FIG. 19A-B depicts the average wavelength of maximal absorbance (Amax) and absorbance at Amax as a function of heating time at 72° C. (n=2) of red radish powder, black carrot extract, cranberry powder and beetroot mix.

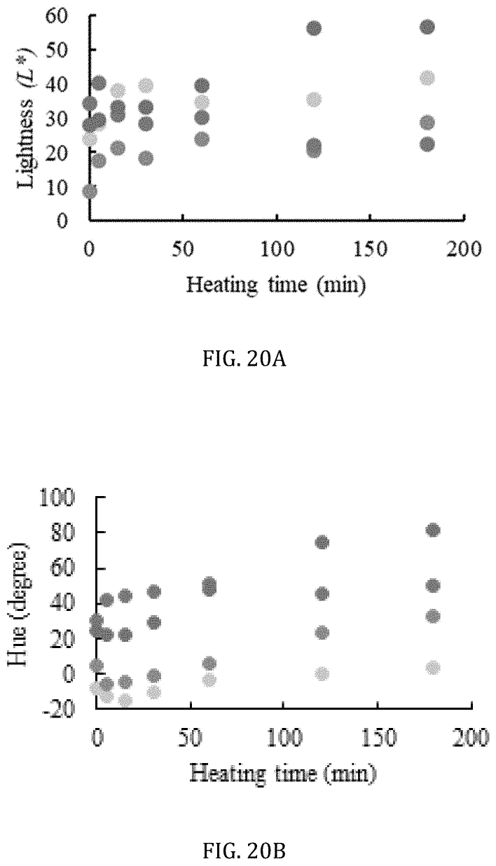

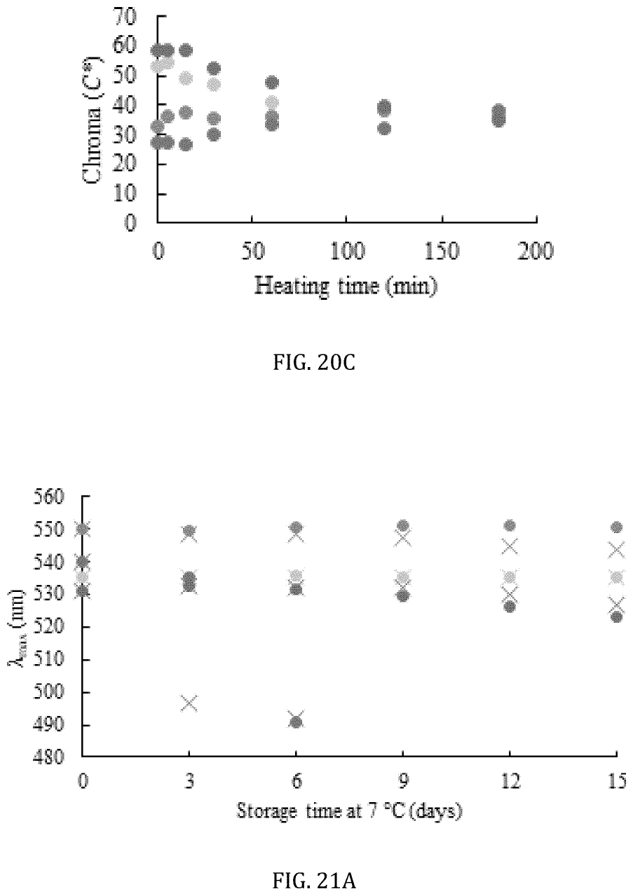

FIG. 20A-C depict the average lightness (L*), hue and chroma (C*) as a function of heating time at 72° C. (n=2) of red radish powder, black carrot extract, cranberry powder and beetroot mix.

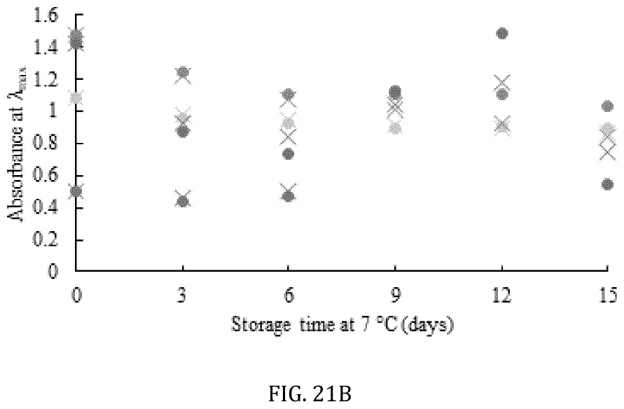

FIG. 21A-B depict the Average wavelength of maximal absorbance (Amax) and absorbance at Amax as a function of storage time (days) at 7° C. (n=2) of red radish powder stored under dark conditions red radish powder stored under illuminated conditions, black carrot extract stored under dark conditions, black carrot extract stored under illuminated condition, cranberry powder stored under dark condition, cranberry powder stored under illuminated conditions, beetroot mix stored under dark conditions, beetroot mix stored under illuminated condition.

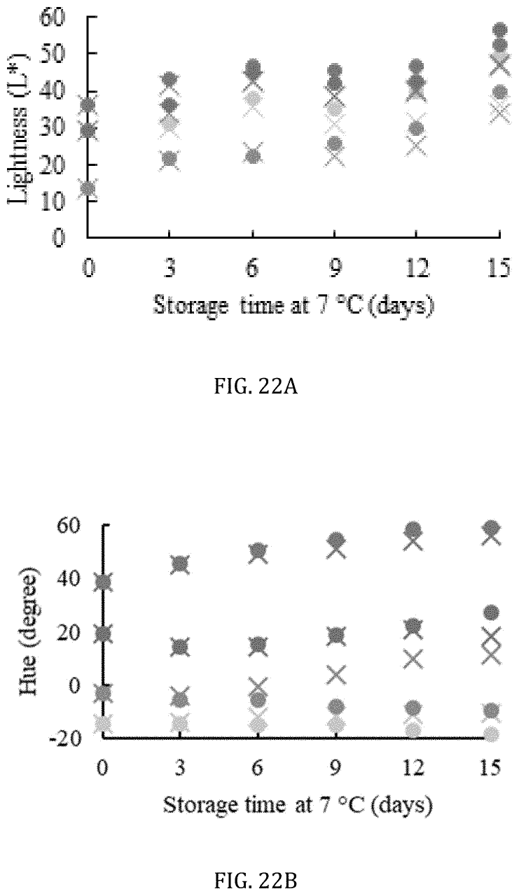

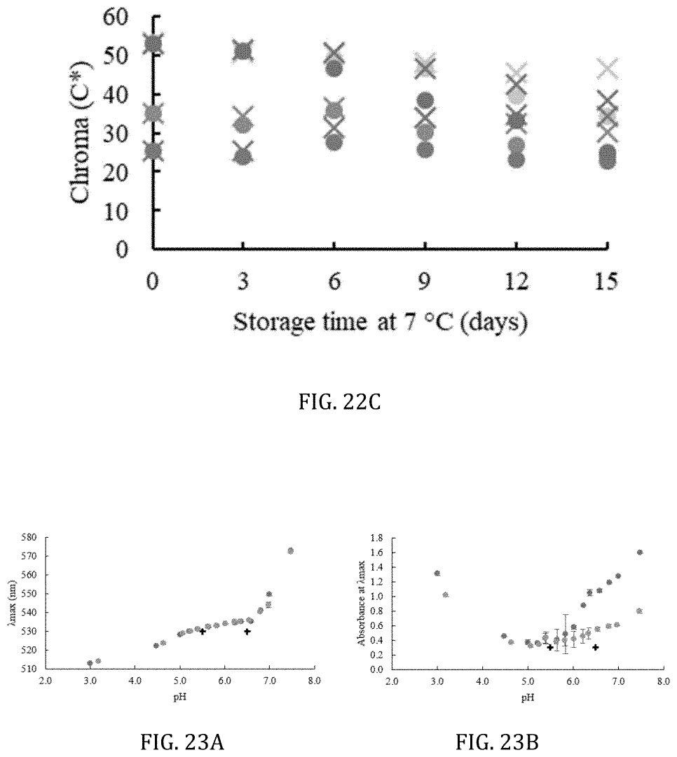

FIG. 22A-C depict the average lightness (L*), hue and chroma (C*) as a function of storage time (days) at 7° C. (n=2) of red radish powder stored under dark conditions red radish powder stored under illuminated conditions, black carrot extract stored under dark conditions, black carrot extract stored under illuminated conditions, cranberry powder stored under dark conditions, cranberry powder stored under illuminated conditions, beetroot mix stored under dark condition, beetroot mix stored under illuminated conditions.

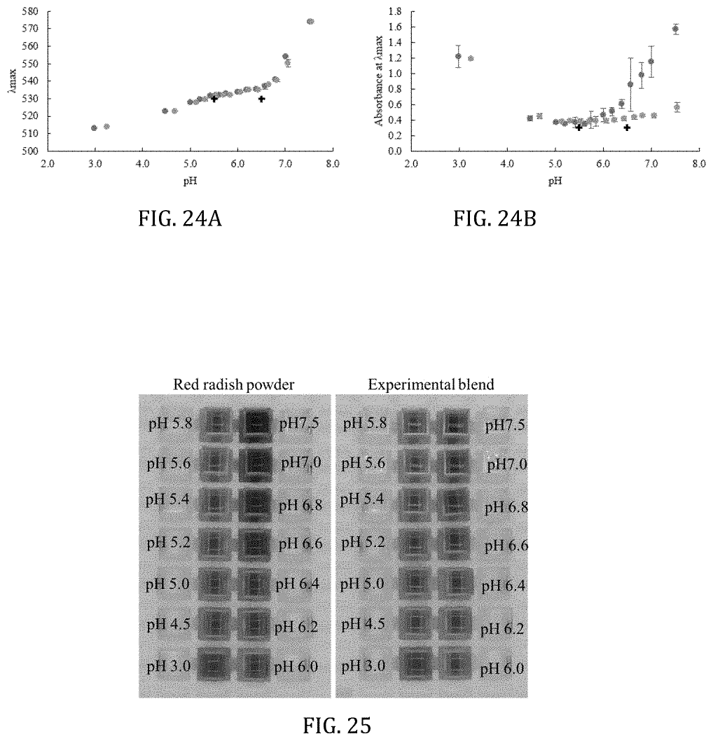

FIG. 23A-B depict pH dependent wavelength of maximal absorbance (Amax) and absorbance at Amax (average±standard deviation) (n=2) of red radish powder (batch n° 191124) and of the blend prepared with red radish powder (batch n° 191124). The pH range of interest, being the pH of processed meat, is indicated with (+). FIG. 24A-B depict pH dependent wavelength of maximal absorbance (Amax) and absorbance at Amax (average±standard deviation) (n=2) of red radish powder (batch n° 200925) and of the blend prepared with red radish powder (batch n° 200925). The pH range of interest, being the pH of processed meat, is indicated with (+).

FIG. 25 depicts red radish powder (batch n° 191124) and of the blend prepared with red radish powder (batch n° 191124) in citric acid monohydrate-disodium hydrogen phosphate buffer at different pH-levels.

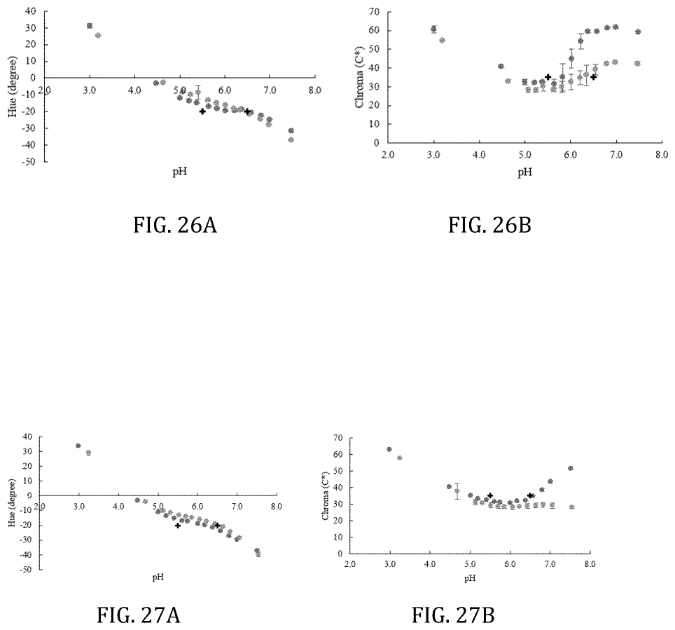

FIG. 26A-B depict pH dependent hue and chroma (average±standard deviation) (n=2) of red radish powder (batch n° 191124) and of the special blend prepared with red radish powder (batch n° 191124). The pH-range of interest, being the pH of processed meat, is indicated with (+).

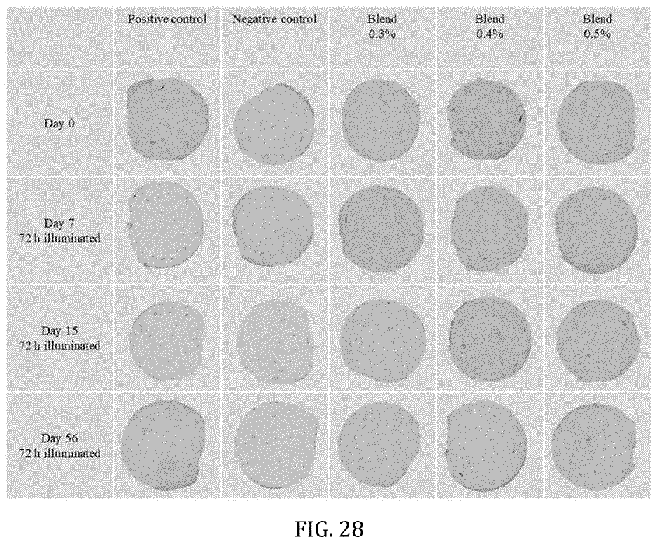

FIG. 27A-B depict pH dependent hue and chroma (average±standard deviation) (n=2) of red radish powder (batch n° 200925) and of the special blend prepared with red radish powder (batch n° 200925). The pH-range of interest, being the pH of processed meat, is indicated with (+). FIG. 28 depicts the appearance of cooked emulsified pork sausages prepared in experiment 1, stored at 7° C. including 72 h of illumination.

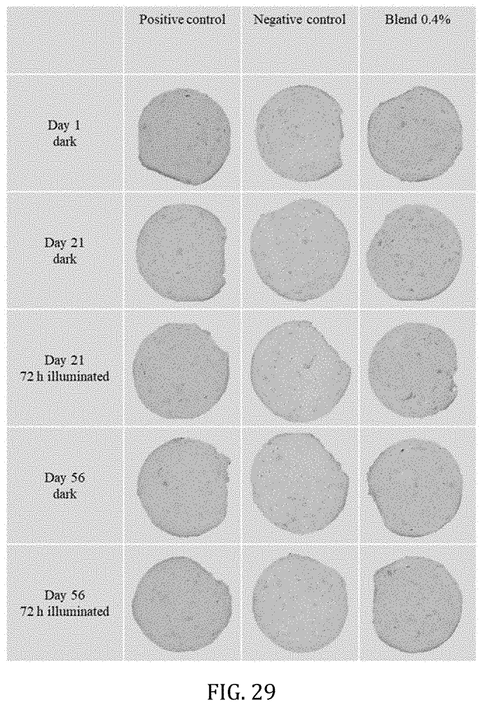

FIG. 29 depicts the appearance of cooked emulsified pork sausages prepared in experiment 2, stored at 7° C. with and without 72 h of illumination.

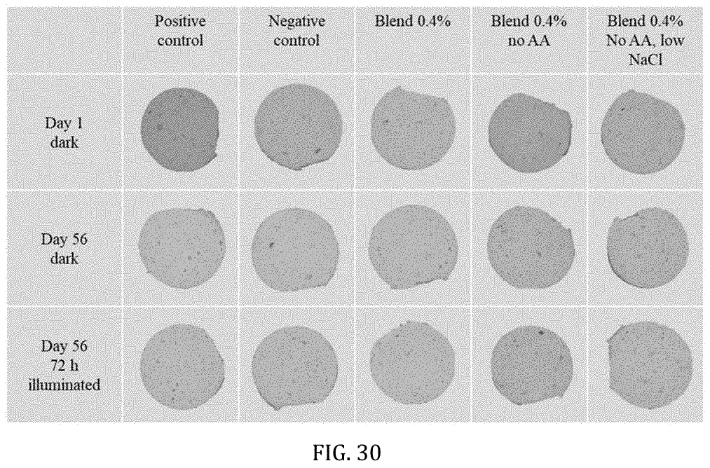

FIG. 30 depicts the appearance of cooked emulsified pork sausages prepared in experiment 3, stored at 7° C. with and without 72 h of illumination.

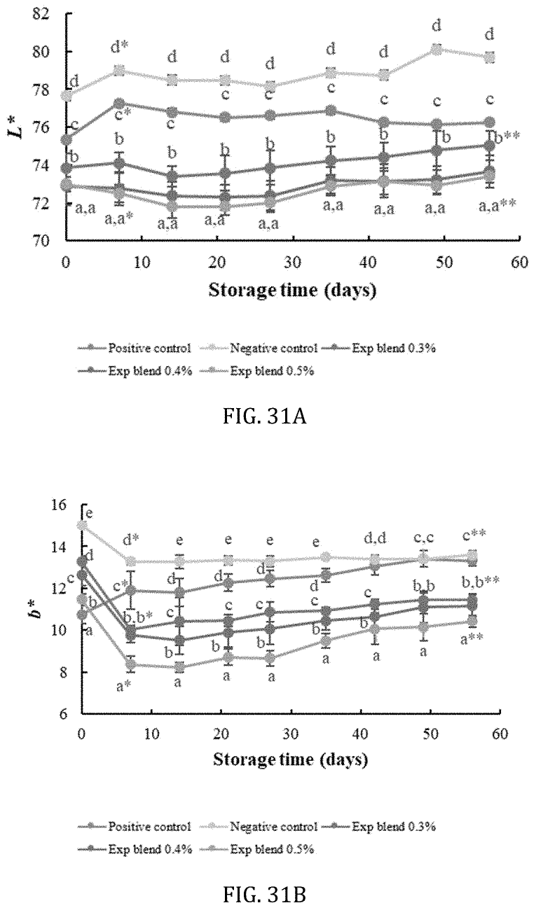

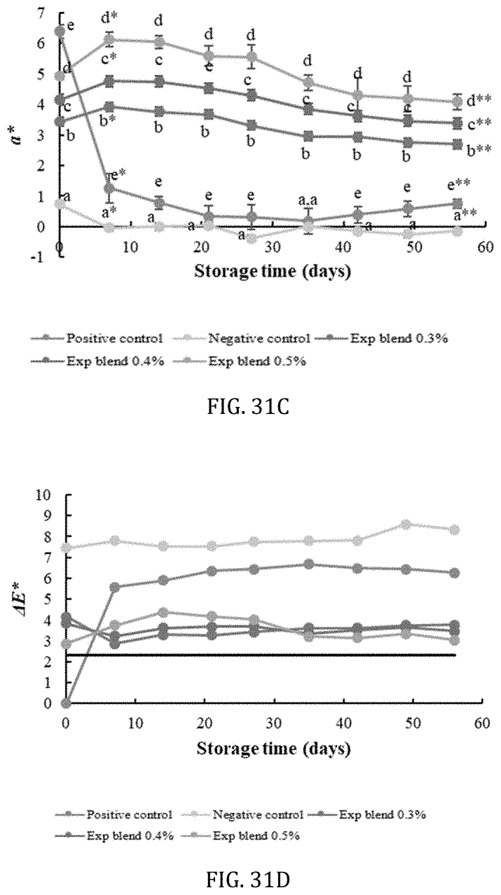

FIG. 31A-D depict the color values (n=3) (average±standard deviation) for lightness (L*), redness (a*) and yellowness (b*) and color difference (ΔE*) of cooked emulsified pork sausages stored at 7° C. including 72 h of illumination. Significant (p<0.05) differences within one time point are indicated with different letters. Significant (p<0.05) differences within one treatment are indicated with * between 0 and 7 days and with ** between 7 and 56 days.

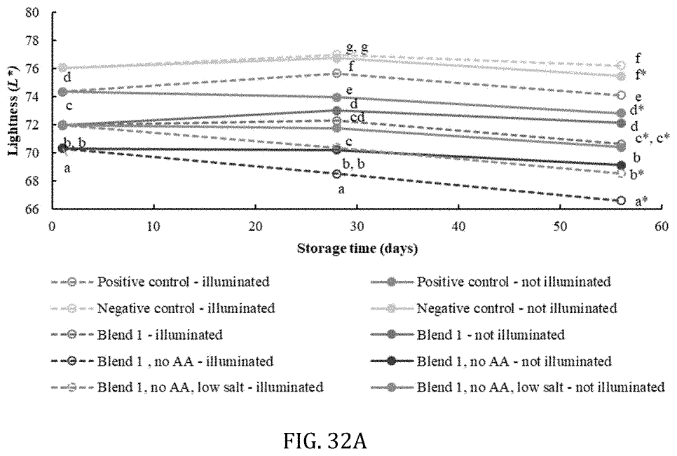

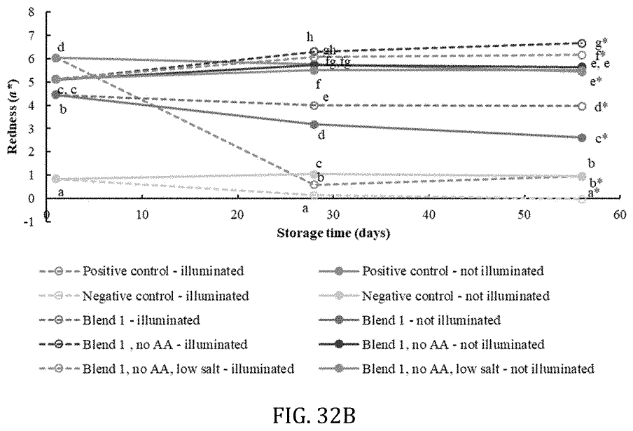

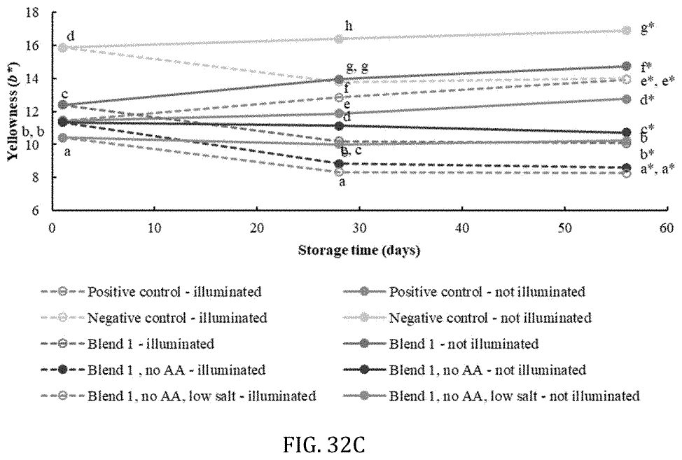

FIG. 32A-C depict the average color values (n=2) for lightness (L*), redness (a*) and yellowness (b*) of cooked emulsified pork sausages prepared in experiment 3, stored at 7° C. with and without 72 h of illumination. Significant (p<0.05) differences within one time point are indicated with different letters. Significant (p<0.05) differences between values at day 1 and day 56 within one treatment are indicated with *.

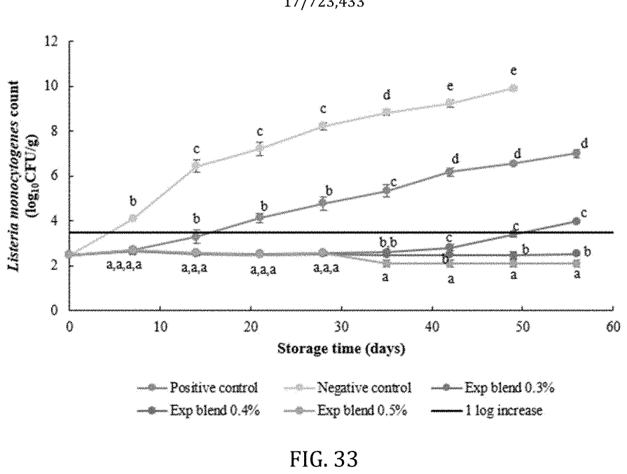

FIG. 33 depicts Listeria monocytogenes counts (n=3) (average±standard deviation) of cooked emulsified pork sausages stored at 7° C. Significant (p<0.05) differences within one time point are indicated with different letters.

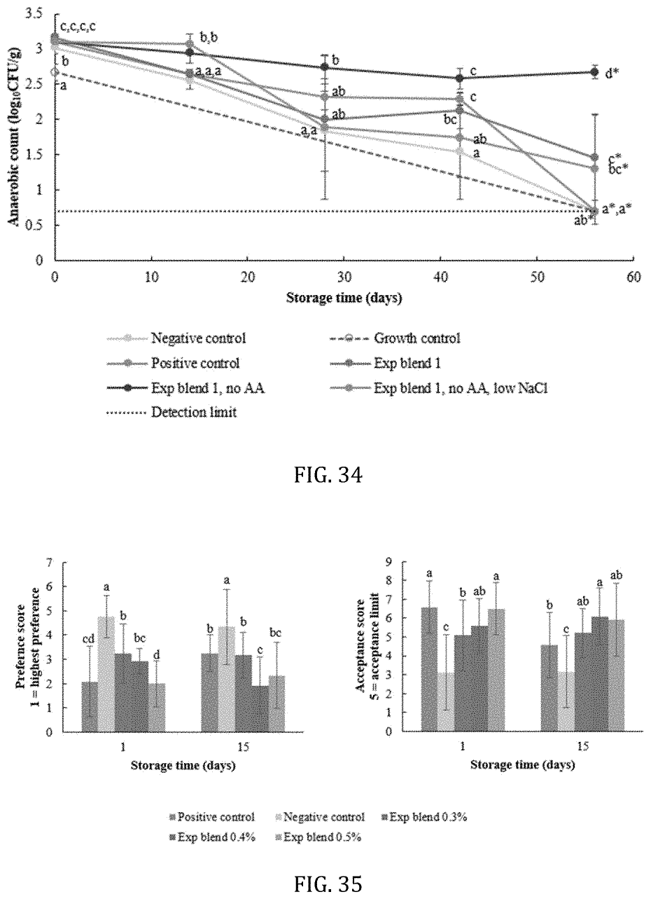

FIG. 34 depicts the anaerobic count (average±stdev) (n=2) of cooked emulsified pork sausages prepared in experiment 3 stored at 7° C. after inoculation with a spore suspension from a cocktail of C. botulinum spores. Significant (p<0.05) differences within one time point are indicated with different letters. Significant (p<0.05) differences between values at day 0 and day 56 within one treatment are indicated with *.

FIG. 35 depicts the preference and acceptance score (12 panelists) (average±standard deviation) of cooked emulsified pork sausages stored at 7° C. including 72 h of illumination. Significant (p<0.05) differences within one time point are indicated with different letters.

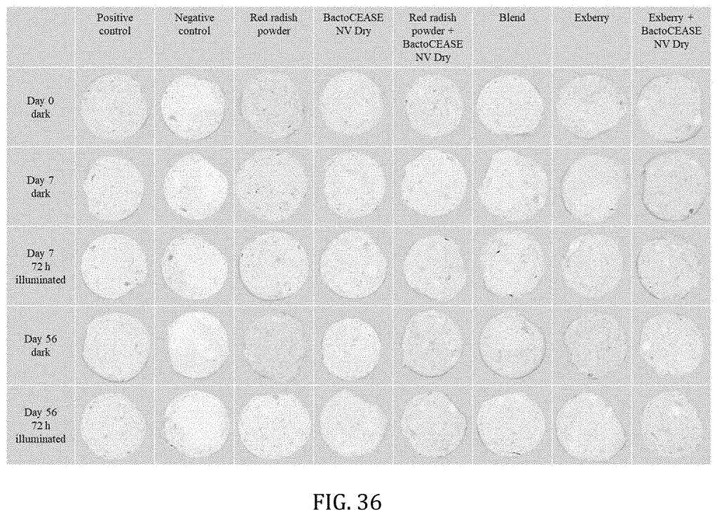

FIG. 36 depicts the appearance of cooked emulsified pork sausages, stored at 7° C. with and without 72 h of illumination.

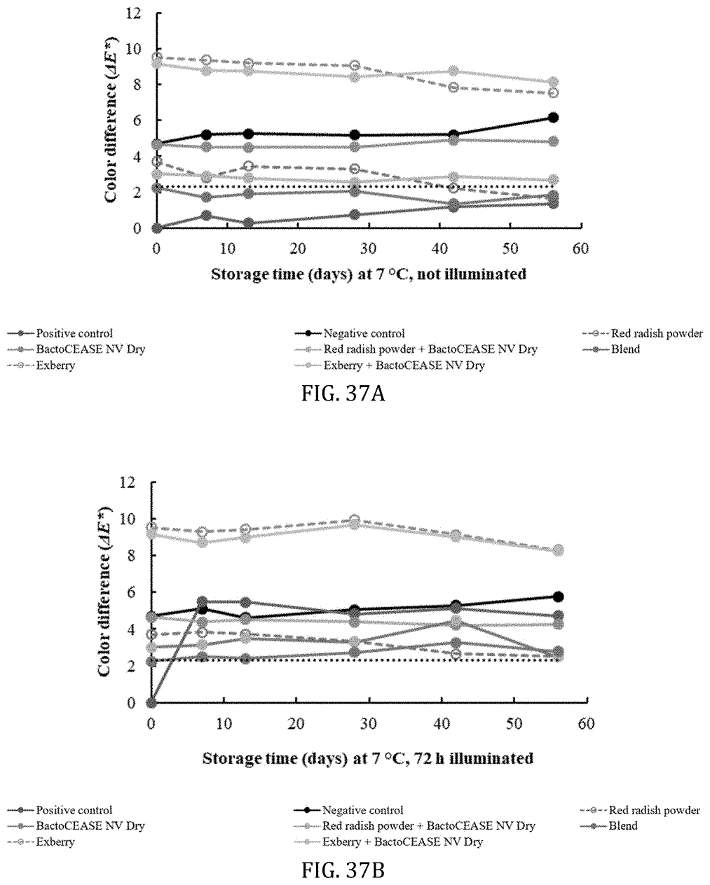

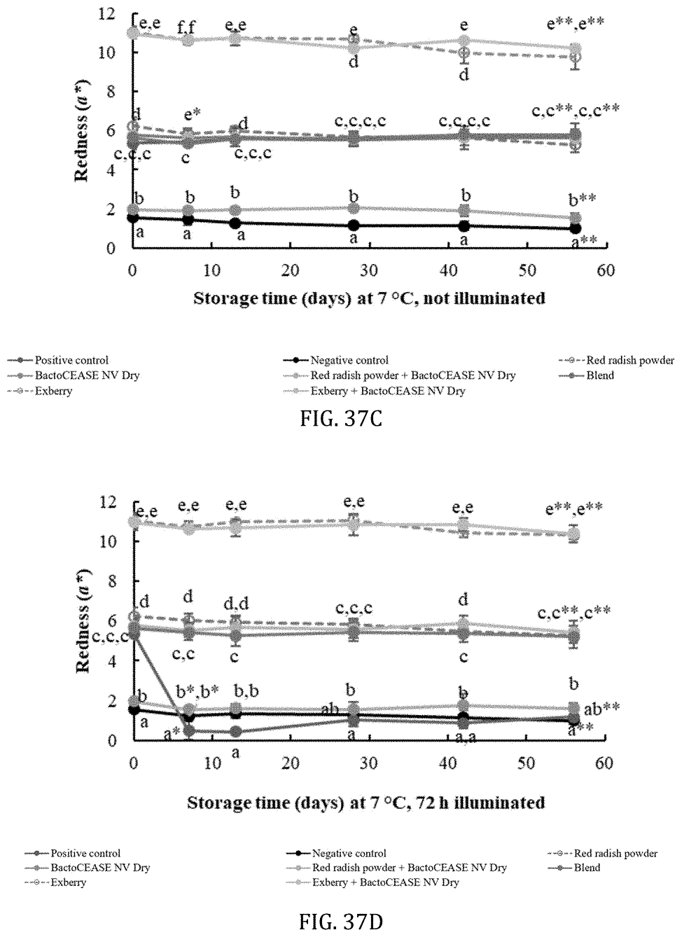

FIG. 37A and FIG. 37B depict color differences (ΔE*) and FIG. 37C and FIG. 37D depict the redness values (a*) (n=2) (average±standard deviation) of emulsified cooked pork sausages stored in the dark (FIG. 37A, FIG. 37C) or stored including 72 h of illumination (FIG. 37B, FIG. 37D). Significant (p<0.05) differences within one time point are indicated with different letters. Significant (p<0.05) differences within one treatment are indicated with * between 0 and 7 days and with ** between 0 and 56 days.

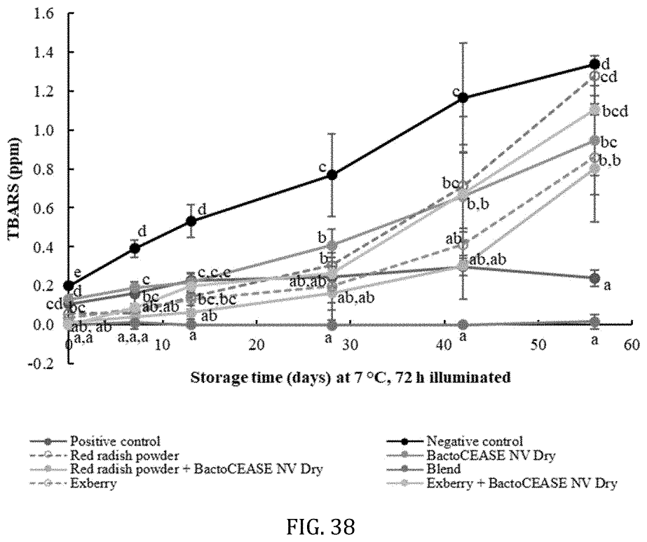

FIG. 38 depicts Thiobarbituric acid substance (TBARS) concentrations (n=2) (average±standard deviation) of emulsified cooked pork sausages stored at 7° C. Significant (p<0.05) differences within one time point are indicated with different letters.

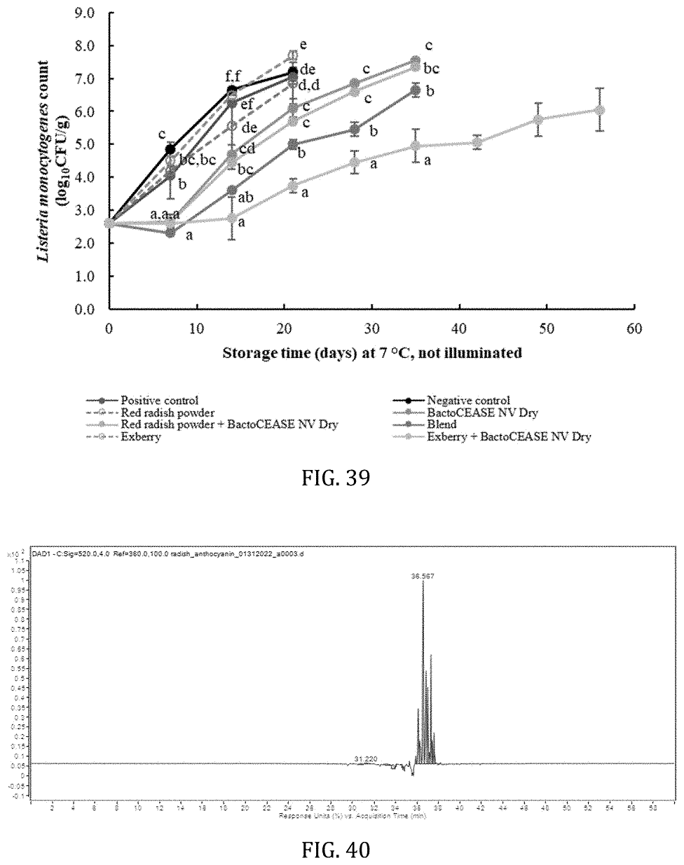

FIG. 39 depicts Listeria monocytogenes counts (n=2) (average±standard deviation) of emulsified cooked pork sausages stored at 7° C. Significant (p<0.05) differences within one time point are indicated with different letters.

FIG. 40 is an example of LC-DAD chromatogram at 520 nm of red radish powder.

### DETAILED DESCRIPTION OF THE INVENTION

For decades, the food industry has desired an alternative to nitrite for cooked cured meats. Part of the difficulty has been that potential replacements have not been able to match the multi-faceted profile and properties of nitrite. For instance, in order to be accepted as a suitable replacement, the composition would need to show efficacy as an antioxidant and antimicrobial agent. In addition, to be readily accepted, the composition would need to match the red or pink color observed in meats cured with nitrite and maintain stability during storage conditions.

The inventors have surprisingly discovered that adding a blended composition of buffered vinegar and red radish extract to the meat matrix can serve as a natural, label-friendly alternative to nitrite, for instance matching the desired red or pink color across varying pH levels under varying storage conditions. This is particularly unexpected where it had been widely understood that anthocyanins do not maintain pigment stability across different pH conditions, teaching away from the use of natural pigments that contain anthocyanins, such as red radish or black carrots.

The current invention relates to a composition or special blend that can be used as a nitrite replacement that contains natural ingredients, for example natural plant extracts, where the composition is capable of curing meat products including, but not limited to, luncheon meat, frankfurter sausages, liver paté, cooked ham and cured bacon. In at least one embodiment, the composition is a blend of buffered dry vinegar (BactoCEASE® NV Dry, Kemin Industries, Inc., Des Moines, Iowa) and red radish powder. In alternative embodiments, the present invention further comprises at least one antioxidant, such as rosemary extract, green tea extract, or both.

According to at least one embodiment of the present invention, the composition is in a dry powder form, although persons of ordinary skill in the art would understand that alternative aqueous forms would also fall within the scope of the present invention.

According to at least one embodiment of the present invention, the present invention is a composition that contains buffered vinegar in an amount ranging from about 65 to 80% by dry weight, for instance between 70 and 75% by dry weight, and red radish powder in an amount ranging from about 15 to 25% by dry weight, for instance between 15 and 20%. In alternative embodiments, the composition of the present invention further comprises rosemary extract in an amount ranging from about 1 to 11% by dry weight, for instance between 5 and 8.5%, and optionally green tea extract in an amount ranging from about 0.5 to 7.5% by dry weight, for instance between 1.5 and 5%. In at least one embodiment, the final composition has a pH (in 10% solution) within the range of about 5.5 to 6.5, with an acetic acid content ranging from about 44 to 54%, and a color value (E1% at 514 nm) ranging from about 7 to 10 g⁻¹ ml cm⁻¹.

For purposes of this invention, the buffered vinegar is comprised of vinegar and an alkali buffering agent including but not limited to sodium hydroxide, sodium carbonate, sodium bicarbonate, potassium hydroxide, potassium carbonate, and potassium bicarbonate. According to at least one embodiment of the present invention, the buffered dry vinegar is a dry powder, with a pH (in 10% solution) within the range of about 5.5 to 6.5, and more particularly an acetic acid content ranging from about 64 to 68%.

According to at least one embodiment of the present invention, the red radish extract is a dry powder, with a color value (E1% at 514 nm): >50 g⁻¹ ml cm and glycosinolates (including hydrolysis products): >500 ppm. According to at least one embodiment of the present invention, the buffered dry vinegar to red radish extract ratio falls within the range of 5:1 to 3:1, for instance 4:1.

According to at least one embodiment of the present invention, the one or more antioxidant may include a rosemary extract, wherein the extract is obtained from a rosemary plant and can be characterized as containing at least 8% by weight carnosic acid, and in at least one embodiment of the present invention contains from about 9.8 to 10.2% by weight carnosic acid. Depending on the application, the rosemary extract may be oil or water dispersible, as a dry or liquid product.

According to at least one embodiment of the present invention, the one or more antioxidant may include a green tea extract, wherein the final composition of the extract includes total polyphenols >85%, total catechins >60%, EGCG>32%. According to at least one embodiment, the green tea extract is provided in combination with the rosemary extract. According to at least one embodiment, the green tea extract is oil soluble.

As would be understood by persons of ordinary skill in the art, cured meat products can be divided into different categories (Table 1). It is important to keep in mind that whether the product is cooked or fermented and dried changes the properties with regard to pH, water activity (aw), color and flavor. For instance, a cooked emulsified pork sausage was selected as the first model system to validate the concept and identify potential natural plant extract (NPE) or combinations that can mimic the desired pink color of cooked cured emulsified sausages. Additionally, the selected NPE needs to retain the color, without negatively impacting the flavor or odor profile of the meat product during storage.

TABLE 1
Examples of cured meat categories.

| | Whole | Grounded/ |
|---|---|---|
| | muscle | emulsified |
| | meat | meat |
| Cooked | E.g. | E.g. frankfurter, |
| | cooked | bologna, |
| | ham | liver paté |
| Fermented | E.g. dry | E.g. salami |
| | ham | |

As discussed in greater detail below, the compositions of the present invention include red radish extract as an ingredient, which the researchers have identified as being able to mimic the appearance and colors observed in processed meat that has been cured with nitrite. The ratios and amounts of the ingredients used is important, particularly the red radish powder, in order to achieve the customer's desired color in the cooked cured meat product and to ensure stability of that color including during a variety of storage conditions and pH levels.

Indeed, persons of ordinary skill would appreciate that cooked cured meat products display a wide variety of colors. For instance, products containing carmine as a food colorant appear “pink” while products without carmine may have higher hue-vales and appear more “brown.” Importantly, the inventors have confirmed that the color of the meat prepared with the nitrite-free blends of the present invention mirror those that have been cured with nitrite and fall within the acceptable color range of nitrite-cured cooked meats.

For certain food products color cards are available to evaluate the color and quality. For instance, for catfish fillets, a scale is utilized to separate fillets into categories. Likewise, a color card exists for the salmon industry. However, to the best of the inventors' knowledge, there is no uniform color card available for cured meat. Nevertheless, the ratio of reflectance at 650 nm/570 nm is reported in the Meat Color Measurements Guideline (American Meat Science Association, 2012), which is incorporated in its entirety by its reference herein. These standards can be used to evaluate cured meat color intensity and fading, where ratio values of ±1.1 indicate no cured color, ±1.6 is a moderately faded cured color, 1.7 to 2.0 is a noticeably cured color, and 2.2 to 2.6 is an excellent cured color.

In addition to providing the desired color profile, any nitrite replacement would need to have low levels of nitrite and nitrate in order to be accepted and deemed a suitable alternative to nitrite. Carcinogenic N-nitroso compounds can be formed from nitrite in the presence of low molecular secondary amines. Honikel, K.-O., The use and control of nitrate and nitrite for the processing of meat products. Meat Science, 2008. 78(1): p. 68-76. Therefore, the use of nitrite in meat products is strictly regulated. For instance, in the European Union, the use of potassium nitrite (E 249) and sodium nitrite (E 250) in meat preparations, non-heated meat products and pasteurized meat products is limited to 150 ppm, while in sterilized meat products only 100 ppm is allowed. Regulation of the European Parliament and of the Council on Food Additives. No 1333/2008 (Dec. 16, 2008).

Additionally, in order to be fully embraced by the market as a nitrite replacement, the nitrite alternative would also need to be capable of controlling the outgrowth of Clostridium botulinum spores. The composition of the present invention is capable of controlling the growth of Clostridium botulinum spores, particularly through the combined action of buffered vinegar and red radish ingredients. To the best of the researchers' knowledge, this combination of buffered vinegar and red radish, as a source of antimicrobials, has never previously been considered as an anti-botulinum agent.

Where ranges are used in this disclosure, the end points only of the ranges are stated so as to avoid having to set out at length and describe each and every value included in the range. Any appropriate intermediate value and range between the recited endpoints can be selected. By way of example, if a range of between 0.1 and 1.0 is recited, all intermediate values (e.g., 0.2, 0.3, and so forth) and all intermediate ranges (e.g., 0.2-0.5, 0.45-0.789, and so forth) are included.

As used herein, the singular forms “a,” “an,” and “the” include plural referents unless the context clearly dictates otherwise. Thus, for example, reference to “an ingredient” refers to one or mixtures of ingredients, and reference to “the method of” includes reference to equivalent steps and methods known to those skilled in the art, and so forth.

The term “antioxidant” as used herein refers to a composition which prevents or delays the oxidation of food products. Antioxidants are generally classified as either synthetic or natural. Antioxidants include, but are not limited to, BHA, BHT, tert-butlyhydroquinone (TBHQ), gallates, ascorbic acid, erythorbic acid, ascorbyl palmitate, tocopherols, tocotrienols, carotenoids, anthocyanins, polyphenols, citric acid, ethoxyquin, EDTA, glycine, lecithin, polyphosphates, tartaric acid, trihydroxybutyrophenone, thiodipropionic acid, and dilauryl and distearyl esters.

The term “efficacious amount” or “effective amount” refers to an amount effective, at dosages and for periods of time necessary, to achieve the desired result. The effective amount of compositions of the invention may vary according to factors such as the composition or formulation of the product being treated with the methods and/or compositions of the present invention.

### EXAMPLES

### Example 1: Natural Plant Extract Screening

### Materials and Methods

Ground (5 mm) lean pork meat (80/20 cuttings) and back fat was obtained from a local butcher. The meat and fat were divided in portion and kept at −18° C. until use. Curing salt (Esco 0.5%/0.6% NaNO2 lot 36185059) was bought from Agora Culinair (Herentals, Belgium) and chopping phosphate Tari® K2 (di- and triphosphates) (lot 7-52615-56) was obtained from Foodpack B.V. (Harderwijk, The Netherlands). Ascorbic acid was obtained from Kemin Agrifood EMENA (RM00918, lot 1700203799). Ascorbic acid from Life Supplies (Olen, Belgium) (lot 1180150114) was used for the preparation of the samples for sensory analysis. Kitchen salt, potato starch (Anco) and crushed ice, made from UV filtered pure water, was bought in a local supermarket. Natural plant extracts containing red/pink pigments and commercially available blends were sourced and tested to mimic the cured color in cooked emulsified pork sausages, as summarized in Table 2.

TABLE 2
Screened products tested to mimic the cured
color in cooked emulsified pork sausages.

| Coloring food | Supplier | Origin* | Main pigment(s) |
|---|---|---|---|
| Exberry ® | GNT | Radish, | Pelargonidin 3 |
| shade red | | Carrot | sophoroside- |
| | | | 5-glucoside |
| | | | (derivatives) |
| | | | β-carotene |
| Red spice | Sensient | Padauk spice | Santalin |
| Extract L-WS | | | |
| Pink Rose CF | DDW | Red beet, | Betanin |
| | | Elderberry, | Cyanidin glycosides |
| | | Carrot | β-carotene |
| Safflower extract | Fuyang | Safflower | 80% carthamin* |
| | Bestop | | |
| | Impex Ltd. | | |
| Annato extract | Kancor | Annato | 40.6% norbixin* |
| 40% | Ingredients | | |
| | Ltd. | | |
| Red velvet | ROHA | Red beet, | Betanin |
| | dyechem | Safflower | Carthamin or |
| | | | carthamidine |
| Paprika Liquid | JNG | Paprika | Capsanthin |
| Dry tomato pulp | Lyrored | Tomato | Lycopene* |
| Sorghum extract | Organic | Red sorghum | 3- |
| | Herb Inc | grain | deoxyanthocyanidin |
| | | | (derivatives) |
| Red radish | Organic | Red radish | Pelargonidin 3 |
| extract | Herb Inc | | sophoroside- |
| | | | 5-glucoside |
| | | | (derivatives) |

*Information reported by the supplier

Sausage preparation. The meat mixture for the emulsified cooked pork sausages was prepared according to the recipes summarized in

Table 3. The curing salt containing 0.6% of sodium nitrite was used as the positive control sample, delivering 114 ppm sodium nitrite to the meat mixture. Kitchen salt was used for the negative control sample. For samples with a coloring food, different dosages of the coloring food were added to the negative control recipe and the ice content was adapted accordingly, to keep all other ingredient concentrations equal.

TABLE 3
Model system recipes of cooked emulsified pork sausage.

| | Positive | Negative |
|---|---|---|
| Ingredient | control % | control % |
| Lean pork meat | 40.00 | 40.00 |
| Back fat | 35.00 | 35.00 |
| Kitchen salt | / | 1.89 |
| Curing salt | 1.90 | / |
| Chopping | 0.30 | 0.30 |
| phosphate | | |
| Ascorbic acid | 0.05 | 0.05 |
| Potato starch | 2.50 | 2.50 |
| Ice | 20.26 | 20.27 |

Batches of 1.4 kg of meat mixture were prepared by mixing the partially defrosted (approximately −2° C.) lean meat with the ice using a Robot Cook (All Food Machines, Nazareth, Belgium) equipped with a smooth blade for 2 minutes at 3000 rpm. Next, chopping phosphate and salt (kitchen or curing salt) were added and mixed for 1 minute at 3000 rpm. Next, all other ingredients were added as well as the partially defrosted back fat (approximately −2° C.). An emulsified meat mixture was obtained by chopping for another 2.5-5 minutes at 3000 rpm.

The meat mixture was then stuffed in a previously soaked casing (diameter of 7 mm, GA4000 PG, Bema B.V., Waddinxveen, The Netherlands) using a Talsa sausage stuffer (F255, All Food Machines, Nazareth, Belgium). The casing was closed using clips and a manual clipper (Bema B.V., Waddinxveen, The Netherlands). From each meat mixture, three sausages were prepared which were cooked in a warm water bath, set at 74° C., during 70 min to reach a core temperature of 72° C. Subsequently, the sausages were cooled in cold tap water and kept at 4° C. until the next day.

Slicing, packaging and storage. Prepared sausages were cut into 0.5 cm slices and packed in vacuum pouches (50 mbar). As deli meats, such as emulsified cooked sausages, reach the consumer after storage in an illuminated (i.e., lighted) display in the shelf of supermarkets, the samples were stored at 4° C. during 72 h with continuous illumination. For pork display, light color of 2900-3750 K and intensities of 800-1600 lux have been recommended. See Kropf, D., Meat display lighting. However, suboptimal lighting conditions (Tubular fluorescent lamp, 4000 K, 2500 lux) were chosen to test the worst-case scenario.

Color evaluation. The color of the sausage was measured immediately after slicing and after 72 h of illuminated storage by determining CIE L*a*b*-values using a Hunterlab ColorFlex® Colorimeter (Elscolab NV, Kruibeke, Belgium). Illuminant D65/10° standard observer was used and the diameter of the port insert was 3.2 cm. Four random readings per sample were obtained and averaged. L* indicates the lightness, a* the redness and b* the yellowness of the sample. Color differences were calculated from average L*a*b*-values according to Equations 1, 2, and 3.

$${Δ E}_{i , 0 h ; pos , 0 h}^{*} = \sqrt{{( {L}_{i , 0 h}^{*} - {L}_{pos , 0 h}^{*} )}^{2} + {( {a}_{i , 0 h}^{*} - {a}_{pos , 0 h}^{*} )}^{2} + {( {b}_{i , 0 h}^{*} - {b}_{pos , 0 h}^{*} )}^{2}}$$

Equation 1. Color difference ΔE_{i,0h; pos,0h}*: color values of sausage i before storage (0 h) compared to color values of the positive control before storage (0 h).

$${Δ E}_{i , 0 h ; i , 72 h}^{*} = \sqrt{{( {L}_{i , 0 h}^{*} - {L}_{i , 72 h}^{*} )}^{2} + {( {a}_{i , 0 h}^{*} - {a}_{i , 72 h}^{*} )}^{2} + {( {b}_{i , 0 h}^{*} - {b}_{i , 72 h}^{*} )}^{2}}$$

Equation 2. Color difference ΔE_{i,0h; i,72 h}*: color values of sausage i before storage (0 h) compared to color values of sausage i after storage (72 h).

$${Δ E}_{i , 72 h ; pos , 0 h}^{*} = \sqrt{{( {L}_{i , 72 h}^{*} - {L}_{pos , 0 h}^{*} )}^{2} + {( {a}_{i , 72 h}^{*} - {a}_{pos , 0 h}^{*} )}^{2} + {( {b}_{i , 72 h}^{*} - {b}_{pos , 0 h}^{*} )}^{2}}$$

Equation 3. Color difference ΔE_{i,72 h; pos,0 h}*: color values of sausage i after storage (72 h) compared to color values of the positive control before storage (0 h).

The appearance was monitored by taking photographs in a photo box with LED illumination (3000 lux).

Sensory analysis. For some selected treatments, sausages were prepared as described above and slices of 5 mm where evaluated by a sensory panel (n=12) considering both color and taste. Hereto, an acceptance test was performed. Each individual was asked to score each sample using a 9-point hedonic scale. None of the panelists objected to eat the sample and all were familiar with the type of product.

Data analysis. From each meat mixture, three different sausages were made. From each sausage, the color of three slices was evaluated and the average and standard deviation of nine L*a*b-values was calculated. ΔE*-values were determined based on the average L*a*b-values. Analysis of variance (one-way ANOVA) and multiple range tests were performed on acceptance scores using STATGRAPHICS® Centurion XV (Statpoint Technologies, Inc., Warrenton, USA).

### Results

One-dosage screening of coloring foods. The coloring foods listed in Table 2 were added to the emulsified sausage at the dosage suggested by the supplier. When no dosage was suggested, a dosage of 0.3% was applied. In the case of the dry tomato pulp, the ingredient was reconstituted prior to its application. Hereto, the directions of the supplier were followed. One unit of dry tomato pulp was blended with 15 units of warm water.

The color of the sausages was evaluated based on their appearance. (FIG. 1.) shows that none of the sausages with coloring foods matched the color of the positive control before storage. After 72 h of vacuum-packed illuminated storage at 4° C., the positive control sample showed discoloration especially at the edges (FIG. 2) Discoloration at the edges was not observed for any sausage containing a coloring food.

Color differences (ΔE*-values) were calculated from the average L*a*b*-values (Equations 1-3). Although a perceptual color difference can't be uniquely determined, a ΔE*of approximately 2.3 has been reported as the just noticeable difference (JND). The ΔE_{i,0h; pos,0h}*-values (FIG. 3) confirmed that none of the coloring foods, applied at the dosage suggested by the supplier, matched the color formed by nitrite since all ΔE_{i,0h; pos,0h}*-values exceeded the JND. Except for the sausages containing safflower extract and paprika liquid, the color change due to illuminated vacuum packed storage (FIG. 3) was below 2.8 (ΔE_{i,0h; i,72 h}*≥2.8) When interpreting the ΔE_{i,0h; i,72 h}*-values one should consider the following. In case of the positive control the ΔE_{i,0h; i,72 h}*-value does not take into consideration the edge discoloration. The reported ΔE_{i,0h; i,72 h}*-values of the positive control sample represents the total decrease in L*, a* and b* in the center of the slice. In some cases, the ΔE_{i,0h; i,72 h}*-values do not solely represent decreases in L*, a* and b*. The sausages containing Exberry, Red velvet, sorghum extract, red radish extract showed lower L* and b*-values, but higher a*-values after storage. This explains why their ΔE_{i,72h; pos,0h}*-values are higher than their ΔE_{i,0h; pos,0h}*-values (FIG. 3.).

Based on the calculated ΔE*-values, one would conclude that annato extract was the best performing coloring food. However, this is in conflict with what would be intuitively concluded from the appearances of the sausages because the sausage containing annato extract did not appear pink at all (FIG. 1 and FIG. 2). Therefore, it was decided to further test all coloring foods which gave the emulsified cooked sausage a pink/red appearance (Exberry, Pink rose, Red velvet, sorghum extract and red radish extract). The safflower extract was not included in the multiple dosage screening because it contained 80% of carthamin, which would create additional labelling challenges.

Multiple dosage screening of coloring foods. The coloring foods which appeared pink/red in the first screening test were further evaluated at multiples dosages. Decreasing the dosage of the coloring foods resulted in sausages with higher L*-values which mean the sausages became lighter as the dosage decreased. (FIG. 4A). Also, the redness (a*-value) of the sausages decreased as the dosage decreased (FIG. 4B). In contrast, such general dose response was not valid for the yellowness (b*-value) of all prepared sausages (FIG. 4C). With respect to the Pink rose and sorghum extract, the b*-value did not clearly increase or decrease as the dosage decreased. For Exberry and red radish extract, the b*-value increased as the dosage decreased, while the b*-value decreased as a lower dosage of Red velvet was used. FIG. 4 shows that it is possible to match the L* and a*-value of the positive control using the right dosage of any of the tested coloring foods but sorghum extract. However, only by applying Exberry or red radish extract the b*-value of the nitrite containing sausage could be matched.

To evaluate the coloring food and the dosage needed to mimic the color of the positive control sample, color differences were calculated (Equation 1 and 3) using the average L*, a* and b* value of the positive control sample measured before storage. The color difference (ΔE_{i,0h; pos,0h}*) before storage is depicted in FIG. 5. Decreasing the dosage of Exberry below 0.3% and Pink rose below 0.25% did not result in a further decrease of the color difference. The sausage prepared with 0.07% of red radish extract had a color difference of 2.1 which was the only sample with a color difference below the JND. The second-best treatment was Exberry dosed at 0.3% with a color difference of 3.4 followed by Exberry at 0.15%. The appearance of these three best treatments is shown in FIG. 6.

The color difference between the sausages containing coloring food stored for 72 h exposed to light and the initial color of the positive control (not exposed to light) is shown in FIG. 7 The data shows that in some cases (Exberry applied at 0.15%; Pink rose dosed at 0.15, 0.25% and 0.35%; Red velvet at 0.04% and 0.07%) the color differences became smaller after illuminated storage. For Exberry dosed at 0.15% and Pink rose dosed at 0.15%, the color difference after illuminated storage was even smaller than the JND. In contrast, the color difference for sausages containing red radish extract increased after illuminated storage. Nevertheless, the color difference after illuminated storage of the sausage prepared with 0.07% red radish extract was still below the JND. FIG. 8 shows that the sausage with 0.07% red radish extract after 72 h of illuminated storage is slightly more pink than the positive control which was not exposed to light.

Based on color values (FIG. 4), calculated color differences (FIG. 5 and FIG. 7) and appearance (FIG. 6 and FIG. 8), the researchers concluded that red radish extract, applied at 0.07%, meets the expectation of a NPE that mimics the color generated by nitrite in a emulsified cooked pork sausage. This was further validated by a sensory analysis, described in detail below.
Sensory evaluation. The color and taste of the negative control, positive control and the sausage containing 0.07% radish extract were evaluated by 12 panelist who scored their acceptance ranging from 1 (=dislike extremely) to 9 (like extremely) (FIG. 9). The average acceptance score of the negative control sample before and after storage was below 4, meaning the sausage was slightly disliked. The remarks of the panelist indicated the sample was disliked because of its pale color (FIG. 10). Before storage, the acceptance score of the positive control and sausage with radish extract was not significantly different (p>0.05) and liked by the panelists (acceptance score above 5). No panelist mentioned an off-taste for the sample containing 0.07% red radish extract. After 72 h of illuminated (i.e., lighted) storage the acceptance score of the positive control decreased significantly. The panelist mentioned grey edges and unattractive color of the illuminated positive control sample (FIG. 10).

Following illuminated storage, the acceptance score of the sample containing red radish extract increased, although not significantly. Consequently, the acceptance score after 72 h illuminated storage was significantly higher for the sausage with red radish extract than for the positive control sample with nitrite. This may be attributed to its better color perception.

### Discussion

Multiple studies have previously evaluated the color of cooked emulsified meat products when natural plant extracts were used to decrease or replace nitrite. For instance, the addition of fucoxanthin extract from brown seaweed (0.01%-0.04%) in combination with a reduced nitrite level (80 ppm) decreased the lightness and increased the redness and yellowness of turkey meat sausages. Sellimi, S., et al., Enhancing color and oxidative stabilities of reduced-nitrite turkey meat sausages during refrigerated storage using fucoxanthin purified from the Tunisian seaweed cystoseira barbata. Food and Chemical Toxicology, 2017. 107: p. 620-629. Riazi et al. tested the effect of grape pomace in combination with reduced nitrite levels in cooked emulsified beef sausage and observed a reduction in redness. Riazi, F., et al., Oxidation phenomena and color properties of grape pomace on nitrite-reduced meat emulsion systems. Meat Science, 2016. 121: p. 350-358. Deda et al. concluded that nitrite could be reduced in frankfurters from 150 ppm to 100 ppm in combination with 12% tomato paste without any negative effect on quality. Deda, M., J. Bloukas, and G. Fista, Effect of tomato paste and nitrite level on processing and quality characteristics of frankfurters. Meat Science, 2007.76(3): p. 501-508. In other words, these earlier disclosures focused on reducing the overall nitrite level; there was no teaching or indication that any of these ingredients would be a suitable nitrite replacement.

Indeed, researchers previously reported undesirable consequences when nitrite was replaced. For example, it was reported that when no nitrite was included, the frankfurters with 12% tomato paste had higher values for lightness and yellowness and lower values for redness than the control sample. Zarringhalami et al. found that cooked beef sausage (55% meat) made with 120 ppm annatto extract had similar lightness and redness but much higher yellowness than sausages with 120 ppm nitrite. Zarringhalami, S., M. Sahari, and Z. Hamidi-Esfehani, Partial replacement of nitrite by annatto as a color additive in sausage. Meat Science, 2009. 81(1): p. 281-284. Kim et al. evaluated the color of cooked sausages made with wheat fiber colored with safflower red pigment. Cooked sausages formulated with 2% of the colored wheat fiber showed similar lightness and redness, but increased yellowness compared with the sausages with 120 ppm nitrite. Kim, H.-W., et al., Wheat fiber colored with a safflower (carthamus tinctorius 1.) red pigment as a natural colorant and antioxidant in cooked sausages. LWT-Food Science and Technology, 2015. 64(1): p. 350-355.

Armenteros et al. found that frankfurters with dog rose extract or strawberry tree extract resulted in very similar color values compared with frankfurters with 100 ppm nitrite. However, the negative control (without nitrite and without plant extracts) had an inexplicable high redness value compared with the positive control with 100 ppm nitrite making the results of the study questionable. Armenteros, M., et al., Application of natural antioxidants from strawberry tree (arbutus unedo l.) and dog rose (rosa canina l.) to frankfurters subjected to refrigerated storage. Journal of Integrative Agriculture, 2013. 12(11): p. 1972-1981.

The results of the study of Armenteros et al. are also in contrast with the Vossen study, which reported that frankfurters with dog rose extract were initially less red and more yellow compared to frankfurters with 100 ppm nitrite. Vossen, E., et al., Dog rose (rosa canina l.) as a functional ingredient in porcine frankfurters without added sodium ascorbate and sodium nitrite. Meat Science, 2012. 92(4): p. 451-457.

Contrary to these earlier studies and conventional thinking, the researchers have surprisingly shown that it is possible to closely match the typical nitrite cured color by applying 0.07% red radish extract to the meat mixture of an emulsified cooked pork sausage without negatively impacting the final texture. The initial color difference was smaller than the JND (FIG. 5) and accepted by the sensory panel (FIG. 9). Other tested coloring foods (see Table 2) were not withheld mainly because they resulted in sausage with a too high yellowness (FIG. 4). The color changes occurring during illuminated storage (FIG. 7) are more favorable for sausages containing red radish extract than for sausages with added sodium nitrite (FIG. 9). Therefore, the use of red radish extract has an additional advantage and benefit. It is well known that the pink cured meat color fades to gray when exposed to UV light and oxygen. Association, A. M. S., Amsa meat color measurement guidelines: Amsa. 2012: American Meat Science Association; Honikel, K.-O., The use and control of nitrate and nitrite for the processing of meat products. Meat Science, 2008. 78(1): p. 68-76.

Counter to earlier expectations, the exceptional color stability of the sausage with red radish extract might be attributed to the complicated multiple acylated structures of the anthocyanins. Jing, P., et al., Anthocyanin and glucosinolate occurrences in the roots of chinese red radish (raphanus sativus l.), and their stability to heat and pH, Food Chemistry, 2012. 133(4): p. 1569-1576.

This study shows that red radish extract in a cooked emulsified pork sausage is capable of obtaining the desired pink color with same acceptance score for color and taste as the nitrite standard. In addition, the red radish extract was capable of providing a better color retention, or color stability, in the meat compared to nitrite after illuminated storage.

### Example 2: Evaluation of Black Carrot Extract as an Alternative Source of Acylated Anthocyanins

### Materials and Methods

Red radish powder was identified as a natural ingredient capable of creating the desired pink color in nitrite-free emulsified cooked sausages. Additionally, the researchers demonstrated that sausages prepared with red radish powder have an improved color stability compared to the nitrite control. This was specifically true when the product was stored under illuminated conditions, as it is the case during retail display. It was hypothesized that the coloring property of red radish may be attributed to the acylated anthocyanins it contains. Jing, P., S.-J. Zhao, S.-Y. Ruan, Z.-H. Xie, Y. Dong, and L. Yu. 2012. Anthocyanin and glucosinolate occurrences in the roots of chinese red radish (raphanus sativus l.), and their stability to heat and ph. Food Chemistry. 133: 1569-1576; Giusti, M. M., H. Ghanadan, and R. E. Wrolstad. 1998. Elucidation of the structure and conformation of red radish (raphanus sativus) anthocyanins using one- and two-dimensional nuclear magnetic resonance techniques. Journal of Agricultural and Food Chemistry. 46: 4858-4863.

Black carrots have been reported as another potential source of acylated anthocyanins. Malien-Aubert, C., O. Dangles, and M. J. Amiot. 2001. Color stability of commercial anthocyanin-based extracts in relation to the phenolic composition. Protective effects by intra- and intermolecular copigmentation. Journal of Agricultural and Food Chemistry. 49: 170-176. Accordingly, the researchers evaluated whether black carrot extract could be an alternative for red radish powder to provide the desired pink color of cured meat.

The emulsified cooked pork sausages were prepared at two different dosages (700 ppm and 1400 ppm) of black carrot extract. The color of the sausage was compared to the nitrite control immediately after slicing and after storage in dark and illuminated conditions.

Black carrot extract (B033.S600000 lot G0034.191120) was obtained from Organic Herb Inc (Changsha, China).

Sausage preparation. The meat mixtures for the emulsified cooked pork sausages were prepared as described in Example 1. The sausages were cooked in a combi steamer (Eloma Joker MT, All Food Machines, Nazareth, Belgium) set at 80° C. and 100% relative humidity, during 35 min to reach a core temperature of 72° C. Subsequently, the sausages were cooled in cold tap water and kept at 4° C. until the next day.

Slicing, packaging and storage. Prepared sausages were cut into 2 mm slices and packed in vacuum pouches (50 mbar). The samples were stored at 7° C. up to 50 days. One portion of the samples were stored in complete darkness by placing the packages in a carton box and covering them with aluminum foil. Another portion of the samples were exposed to continuous illumination during the last 72 h of the storage period to represent display in the shelf of the supermarket. For pork display, light color of 2900-3750 K and intensities of 800-1600 lux have been recommended. However, suboptimal lighting conditions (Tubular fluorescent lamp, 4000 K, 2500 lux) were chosen as a worst-case scenario.

Color evaluation. The color of the sausages was measured by determining CIE L*a*b*-values as described in Example 1. L*a*b*-values were converted into polar coordinates L*C*h according to Equations 4 and 5, where L* indicates the lightness, C* the chroma or color saturation and h the color hue.

$$Formula to calculate chroma ( {C}^{*} ) from {a}^{*} and {b}^{*} .$$

$${C}^{*} = \sqrt{{a}^{* 2} + {b}^{* 2}} . \qquad Equation 4$$

$$Formula to calculate color hue ( h ) from {a}^{*} and {b}^{*} .$$

$$h = {tan}^{- 1} \frac{{b}^{*}}{{a}^{*}} ( degree ) . \qquad Equation 5$$

The appearance was monitored by taking photographs in a photo box with LED illumination (3000 lux).

### Results

Initial color evaluation. The color of the sausages was evaluated based on their appearance. FIG. 11 shows that the sausages prepared with black carrot extract did not match the color of the positive control before storage. As described in Example 1, nitrite-free sausages were prepared with red radish powder to obtain the desired color. Pictures of these are also shown for comparison reasons. The application of red radish powder (at 700 ppm and 1200 ppm) were closer in appearance to the color of the positive control than the use of black carrot extract. The sausages prepared with black carrot extract appeared more purple than pink.

The color values of the prepared sausage are depicted in FIG. 12, with the sausage prepared with red radish powder of Example 1 included as a comparison. By applying 700 ppm of black carrot extract the L*- and a*-value of the positive control could be approached. However, the b*-value considerably deviated. Much lower b*-values were observed indicating a less yellow and bluer product. This observation is also reflected in the calculated hue-values. The hue-value of the positive control was 58 degrees, while the hue-value of the sausage prepared with 700 ppm black carrot extract was only 24 degrees corresponding to a much less yellow color hue. Furthermore, the chroma-value of the sausages prepared with black carrot extract did not match the value of the positive control. Extrapolating the color values towards lower dosages of black carrot extract suggests that the desired values cannot be reached as a*-values and C*-values will become too small. As demonstrated in Example 1, by applying red radish powder (700 ppm) to a nitrite-free emulsified cooked pork sausage the researchers were capable of achieving similar color values of the nitrite cured positive control sample.

Color stability during the shelf life. The color of the positive control and of the sample prepared with 700 ppm black carrot extract was evaluated during 50 days of storage under dark conditions and during 50 days of storage with illumination during the last 72 h. Color values L*, a* and b* are shown in FIG. 13. All color values were relatively stable during storage except for the a*-value of the positive control which was illuminated during storage. For this sample the redness faded drastically over time.

### Discussion

Applying black carrot extract (0.07-0.14%) to emulsified cooked pork sausages did not provide the desired pink color to the nitrite-free product. The sausages appeared too purple. It was observed that the color stability during storage was excellent, even under illuminated conditions. The coloring compounds in black carrot have been identified as cyanidin-3-rutinoside-glucoside-galactoside acylated with one cinnamic acid. As described herein, previous trial work demonstrated that the application of red radish powder was capable of resulting in matching the appearance of the pink color of cured emulsified cooked sausages. The structural difference of the anthocyanins found in these two vegetables may explain the different obtained hue-values, where the aglycone in red radish anthocyanins is reported to be pelargonidin, while the anthocyanins in black carrot are based on the cyanidin aglycone.

### Example 3 Pigment Stabilities of Red Coloring Food

### Materials and Methods

Red radish powder was identified as a natural ingredient capable of creating the desired pink color in nitrite-free emulsified cooked sausages. It was hypothesized that the coloring property of red radish may be attributed to the acylated anthocyanins it contains. Jing, P., S.-J. Zhao, S.-Y. Ruan, Z.-H. Xie, Y. Dong, and L. Yu. 2012. Anthocyanin and glucosinolate occurrences in the roots of Chinese red radish (raphanus sativus l.), and their stability to heat and ph. Food Chemistry. 133: 1569-1576; Giusti, M. M., H. Ghanadan, and R. E. Wrolstad. 1998. Elucidation of the structure and conformation of red radish (raphanus sativus) anthocyanins using one- and two-dimensional nuclear magnetic resonance techniques. Journal of Agricultural and Food Chemistry. 46: 4858-4863.

The main drawback in use of anthocyanins in food is the low stability of their color properties¹⁶. Anthocyanin degradation typically occurs during thermal processing and storage¹⁷. Color stability and pigment stability are dependent on several factors, including pH, temperature and light intensity. Each anthocyanin displays specific chemical characteristics (charge, electronic distribution, planarity, and shape) modulating its reactivity and color stability over time. Accordingly, the researchers evaluated the pigment stability towards pH, heat and light in comparison to other products rich in anthocyanins. Red radish powder and black carrot extract were included because of their reported acylated anthocyanin content. Cranberry powder was chosen as it is expected to contain non-acylated anthocyanins and proanthocyanidins. Because beetroot red (rich in betalains) is widely used in the meat industry to enhance color, a commercial beetroot mix was also added in the study.

Materials. The studied coloring foods, together with their reported pigments, are listed in Table 5. Two batches of red radish powder and one batch black carrot extract were obtained from Organic Herb Inc (Changsha, China). According to the supplier these batches had color values (E^{1%}) of 50.58, 51.80 and 60.33 g⁻¹ ml cm⁻¹. Canberry powder (Exocyan Fruit 90 SD) was obtained from Nexira (Rouen Cedex, France). According to the analysis report of the supplier this ingredient contained 3.67% proanthocyanidins. Finally, a beetroot mix was obtained from Daris Food Ingredients (Bergeijk, The Netherlands).

TABLE 4
Coloring foods evaluated in this study.

| Ingredient | Supplier | Lot | Reported pigments |
|---|---|---|---|
| Red radish | Organic | Batch 1: | Anthocyanins: |
| powder | Herb Inc | G0034.200925 | Pelargonidin-3- |
| | B033.E05000 | Batch 2: | sophoroside-5-glucoside |
| | | G0484.210702 | acylated with one |
| | | | cinnamic acid and one |
| | | | aliphatic acid |
| Black carrot | Organic | G0034.191120 | Anthocyanins: Cyanidin- |
| extract | Herb Inc | | 3-rutinoside-glucoside- |
| | B033.S600000 | | galactoside acylated with |
| | | | one cinnamic acid |
| Cranberry | Nexira | 215594 | Anthocyanins: |
| powder | PFI500069 | | 3-monogalactosides, |
| | | | 3-monoarabinosides, |
| | | | 3-monoglycosides of |
| | | | cyanidin and peonidin |
| Beetroot mix | Daris Food | 211112003 | Betalains |
| | Ingredients | | |
| | 1DFI-178 | | |

pH measurements. The pH-values of the citric acid monohydrate-disodium hydrogen phosphate buffers and of the samples were measured using a WTW Inolab pH 720 device (Apeldoorn, The Netherlands).

pH stability assessment. The appropriate concentration of an aqueous stock solution of the coloring food was determined in a preliminary test showing that a x-fold dilution in a buffer solution at pH 3.0 resulted in an absorbance between 0.8 and 1.4 at the respective wavelength of maximal absorbance (Amax). Stock concentration, dilution factors and Amax-values are listed in Table.

TABLE 5
Aqueous stock concentrations, dilutions
factors and measured λₘₐₓ at pH 3.0, used for the
different coloring foods to assess the pH stability.

| | Aqueous stock | | |
|---|---|---|---|
| | concentration | Dilution | λₘₐₓ at |
| Ingredient | (g/100 ml) | factor | pH 3.0 |
| Red radish | 2.7 | 100 | 513 |
| powder | | | |
| Black carrot | 2.2 | 100 | 523 |
| extract | | | |
| Cranberry | 20.0 | 10 | 523 |
| powder | | | |
| Beetroot mix | 5.4 | 25 | 532 |

For each coloring food two replicates of the stock solution were prepared. The stock solutions were x-fold (see Table 5) diluted in citric acid monohydrate-disodium hydrogen phosphate buffer at different pH levels (pH 3.0 to pH 7.5). These buffers were prepared by mixing appropriate volumes of 0.1 M citric acid monohydrate and 0.2 M disodium hydrogen phosphate. Next, UV-VIS spectra were recorded and color measurements were performed as described in greater detail below.

Thermal stability assessment. The thermal stability of the pigments was assessed in a citric acid monohydrate-disodium hydrogen phosphate buffer at pH 6.4 to represent the pH of a cooked meat product. The appropriate concentration of the coloring food (Table 6) was determined in a preliminary test showing an absorbance between 0.6 and 1.4 at the respective wavelength of maximal absorbance at pH 6.4. For each coloring food two replicates of the solution were prepared and the initial UV-VIS spectra and color values (see below) were determined. Next, sample aliquots (30 ml) were divided in 6 different falcon tubes (50 ml) and heated in a water batch set at 72° C. during 5, 15, 30, 60, 120, and 180 minutes. After the thermal treatment, samples were cooled and protected from light prior to measuring the UV-VIS spectra and color values, as described below.

TABLE 6
Concentration in citric acid monohydrate-
disodium hydrogen phosphate buffer at pH 6.4
and corresponding λₘₐₓ used for the different
coloring foods to assess the thermal and light stability.

| | Concentration | λₘₐₓ at |
|---|---|---|
| Ingredient | in (g/100 ml) | pH 6.4 |
| Red radish powder | 0.090 | 535 |
| Black carrot extract | 0.052 | 550 |
| Cranberry powder | 2.400 | 543 |
| Beetroot mix | 0.200 | 532 |

Light stability assessment. The light stability of the pigments was assessed in a citric acid monohydrate-disodium hydrogen phosphate buffer at pH 6.4 to represent the pH of a cooked meat product. The same concentration of the coloring food was used as for the thermal stability assessment (Table). For each coloring food two replicates of the solution were prepared and the initial UV-VIS spectra and color values (see below) were determined. Next, sample aliquots were divided in two petri dishes (25 ml). One petri dish was covered with aluminum foil to protect the sample from light. Samples were stored at 7° C. and exposed to light 12 hours/day (LED light, 3000 K, 1600 lux). The UV-VIS spectra and color values (see below) were measured after 3, 6, 9, 12 and 15 days of storage.

UV-VIS spectra. Absorption spectra of the samples at different pH-values were scanned from 300 to 750 nm using a UV-VIS spectrophotometer (Shimadzu UV-1800 series) and UVProbe 2.7 software. A sampling interval of 1 nm was used. From the recorded absorbance spectra, the wavelength of maximal absorbance (Amax) and the absorbance at Amax (A at Amax) were determined.

Color measurement. The color of the samples was analyzed by determining CIE L*a*b*-values. Illuminant D65/10° standard observer was used and the diameter of the port insert was 6.4 cm. Four random readings per sample were obtained and averaged. L*a*b*-values were converted into polar coordinates L*C*h according to Equations 4 and 5, where L* indicates the lightness, C*the chroma or color saturation and h the color hue.

Data analysis. The parameters λₘₐₓ, A at λₘₐₓ, C* and h were statistically analysed using the General Linear Model (GLM) procedure (STATGRAPHICS® Centurion XVIII, Statpoint Technologies, Inc., Warrenton, USA). The pH of the sample (A) and the heating time (min) (B) were evaluated as quantitative factors (A, B). The effect of the quadratic terms was also included in the model. For the light stability assessment, the illumination condition (dark versus illuminated) was studied as a categorical factor (C). The storage time at 7° C. (days) was evaluated as a quantitative factor (D). The effects of C, D, D*D and C*D were included in the model.

### Results

pH-stability. Pictures of the coloring food samples at different pH-values are shown in FIG. 14. The wavelength of maximal absorbance (Amax) and its corresponding absorbance (A at Amax) were determined from the recorded UV-VIS spectra. These parameters are shown as a function of pH in FIG. 16. The pH dependent hue- and chroma-values are depicted in FIG. 17.

For red radish powder, black carrot extract and cranberry powder Amax clearly increased with increasing pH, while for beetroot mix the Amax did not change as a function of pH. GLM analysis (Table) confirmed that pH and the quadratic term in pH were significant terms to describe Amax for red radish powder, black carrot extract and cranberry powder. Furthermore, neither pH nor the quadratic term in pH were significant terms to describe Amax for beetroot mix. Especially at pH >6.6 the bathochromic shifts were large for red radish powder and black carrot extract. For red radish powder, an average shift of 4 nm was observed between pH 6.6 and 6.8; of 13 nm between pH 6.8 and 7.0 and of 20 nm between pH 7.0 and 7.5. Within the pH-range of interest for cooked meat applications (pH 5.5-6.5) the spectral shifts were limited (5.5 nm shift between pH 5.4 and pH 6.6). For black carrot an average shift of 9.5 nm was observed between pH 6.6 and 6.8; of 12.5 nm between pH 6.8 and 7.0 and of 12 nm between pH 7.0 and 7.5. Within the pH-range of interest for meat applications (pH 5.5-6.5) the spectral shifts were larger (14.5 nm shift between pH 5.4 and pH 6.6) compared to the spectral shift of red radish powder in the pH-range. For cranberry powder the bathochromic shifts at pH >6.6 were smaller: an average shift of 3.5 nm was observed between pH 6.6 and 6.8; of 4 nm between pH 6.8 and 7.0 and of 8 nm between pH 7.0 and 7.5. However, within the pH-range of interest for cooked meat applications (pH 5.5-6.5) the spectral shifts were also larger (10 nm shift between pH 5.4 and pH 6.6) compared to the spectral shift of red radish powder.

The absorbance at Amax as a function of pH was almost constant for beetroot mix. Nevertheless, according to the GLM model, pH and the quadratic term in pH were significant terms to describe the absorbance at Amax. However, the model R² was very low and the estimated coefficients very small (Table 8). For red radish powder, black carrot extract and cranberry powder a large hypochromic effect was observed between pH 3.0 and pH 4.5. For black carrot extract and cranberry powder, the absorbance increased again from pH 5.0 and above. The hyperchromic effect observed for red radish powder was very pronounced and mainly happened between pH 5.8 and pH 7.5. GLM analysis also showed the largest coefficients for red radish powder (Table).

The effect of pH on lightness (L*) (FIG. 17) was most pronounced for cranberry powder and black carrot extract, both becoming steadily darker as the pH increased. Decrease in L* with increasing pH was also observed for red radish powder at pH >6. For red radish powder, L* showed a maximum value were chroma showed a minimum value. The pH dependency of L* for beetroot mix seemed limited. GLM analysis (Table 9) also showed that pH and/or the quadratic term in pH were significant terms to describe L*. However, the model fit for beetroot mix was not satisfying, which confirms the limited pH dependency for this coloring food. For red radish powder, black carrot extract and beetroot mix the hue-value decreased with increasing pH (FIG. 17). For red radish powder the hue changed from about 33 to −37 degree suggesting a color change from orange to crimson (a deep red color, inclining to purple) (FIG. 15) along with a pH change from 3.0 to 7.5. The hue of the black carrot extract ranged from about 23 to −50 degree corresponding to a color change of orange-red to reddish purple. The change in hue was much less pronounced for beetroot mix. With a change from about 15 to 9 degree the color remained orange-red. In contract to this, the hue of the cranberry powder increased with increasing pH from about 23 to 51 degree. This meant a color change from orange-red to orange-yellow. For all tested coloring food, the general linear models to describe the hue-value (Table 10) showed significant terms in pH and/or the quadratic term in pH. The estimated coefficients for beetroot mix were much smaller than for red radish powder and black carrot extract. Within the pH-range of interest for meat applications (pH 5.5-6.5) the hue-values of red radish powder and black carrot extract were similar and ranging from −15 to −24 degree (pH 5.4 and pH 6.4). These hue-values correspond with a carmine red (scarlet red) appearance.

For red radish powder, black carrot extract and cranberry powder, an increase in pH caused a decrease in chroma indicating the color became duller. For the red radish powder the chroma increased again for pHs >6.0. The chroma of the beetroot mix was quite stable over the studied pH range. GLM analysis (Table 11) showed that chroma-values can be modelled using pH and/or the quadratic term in pH. However, the model fit was not always very good (see small R²). The small estimated coefficients for beetroot mix confirmed the limited pH dependency of the chroma for this coloring food.

TABLE 7
General linear model to describe λₘₐₓ (A, A*A). Significant terms (p < 0.05) are indicated with *.

| | Red radish powder | | | Black carrot extract | | | Cranberry powder | | | Beetroot mix | |
|---|---|---|---|---|---|---|---|---|---|---|---|
| | | Coefficient ± | | | Coefficient ± | | | Coefficient ± | | | Coefficient ± |
| Term | P-value | std error | | P-value | std error | | P-value | std error | | P-value | std error |
| pH of sample [A] | 0.0003* | −17 | ± 4 | 0.0151* | −9 | ± 3 | 0.0000* | −25 | ± 5 | 0.9024 | n/a |
| pH of sample*pH | 0.0000* | 2.6 | ± 0.4 | 0.0000* | 1.6 | ± 0.3 | 0.0000* | 3.5 | ± 0.4 | 0.5011 | n/a |
| of sample (A*A) | | | | | | | | | | | |
| R² | 85.4 | | | 96.7 | | | 95.2 | | | 39.0 | |

TABLE 8
General linear model to describe absorbance at λₘₐₓ (A, A*A). Significant terms (p < 0.05) are indicated with *.

| | Red radish powder | | Black carrot extract | | Cranberry powder | | Beetroot mix | |
|---|---|---|---|---|---|---|---|---|
| | | Coefficient ± | | Coefficient ± | | Coefficient ± | | Coefficient ± |
| Term | P-value | std error | P-value | std error | P-value | std error | P-value | std error |
| pH of sample (A) | 0.0000* | −2.1 ± 0.1 | 0.0003* | −0.52 ± 0.12 | 0.0000* | −0.9 ± 0.1 | 0.0409* | 0.06 ± 0.03 |
| pH of sample*pH | 0.0000* | 0.21 ± 0.01 | 0.0002* | 0.05 ± 0..01 | 0.0000* | 0.09 ± 0.01 | 0.0169* | −0.01 ± 0.00 |
| of sample (A*A) | | | | | | | | |
| R² | 90.1 | | 45.4 | | 85.2 | | 35.6 | |

TABLE 9
General linear model to describe L* (A, A*A). Significant terms (p < 0.05) are indicated with *.

| | Red radish powder | | Black carrot extract | | Cranberry powder | | Beetroot mix | |
|---|---|---|---|---|---|---|---|---|
| | | Coefficient ± | | Coefficient ± | | Coefficient ± | | Coefficient ± |
| Term | P-value | std error | P-value | std error | P-value | std error | P-value | std error |
| pH of sample (A) | 0.0000* | 35 ± 4 | 0.1923 | n/a | 0.0040* | 14 ± 5 | 0.0032* | 4 ± 1 |
| pH of sample*pH | 0.0000* | −3.9 ± 0.4 | 0.0041* | −1.0 ± 0.3 | 0.0002* | −1.8 ± 0.4 | 0.0023* | −0.4 ± 0.1 |
| of sample (A*A) | | | | | | | | |
| R² | 76.9 | | 87.6 | | 86.4 | | 33.2 | |

TABLE 10
General linear model to describe hue (A, A*A). Significant terms (p < 0.05) are indicated with *.

| | Red radish powder | | Black carrot extract | | Cranberry powder | | Beetroot mix | |
|---|---|---|---|---|---|---|---|---|
| | | Coefficient ± | | Coefficient ± | | Coefficient ± | | Coefficient ± |
| Term | P-value | std error | P-value | std error | P-value | std error | P-value | std error |
| pH of sample (A) | 0.0000* | −38 ± 2 | 0.0000* | −55 ± 7 | 0.9196 | n/a | 0.0016* | 3 ± 1 |
| pH of sample*pH | 0.0000* | 2.4 ± 0.2 | 0.0000* | 5.6 ± 0.6 | 0.0073* | −1.2 ± 0.4 | 0.0002* | −0.4 ± 0.1 |
| of sample (A*A) | | | | | | | | |
| R² | 96.5 | | 87.1 | | 95.0 | | 66.5 | |

TABLE 11
General linear model to describe chroma (A, A*A). Significant terms (p < 0.05)are indicated with *

| | Red radish powder | | Black carrot extract | | Cranberry powder | | Beetroot mix | |
|---|---|---|---|---|---|---|---|---|
| | | Coefficient ± | | Coefficient ± | | Coefficient ± | | Coefficient ± |
| Term | P-value | std error | P-value | std error | P-value | std error | P-value | std error |
| pH of sample (A) | 0.0000* | −54 ± 7 | 0.0030* | −20 ± 6 | 0.0081* | −9 ± 3 | 0.0002* | 4 ± 1 |
| pH of sample*pH | 0.0000* | 5.2 ± 00.7 | 0.0150* | 1.5 ± 0.6 | 0.4764 | n/a | 0.0001* | −0.4 ± 0.1 |
| of sample (A*A) | | | | | | | | |
| R² | 54.9 | | 68.8 | | 90.7 | | 56.4 | |

Thermal-stability. For red radish powder, black carrot extract and beetroot mix, Amax and the absorbance at λₘₐₓ decreased as a function of heating time (FIG. 19) (Table 12 and Table 13). A sudden drop in λₘₐₓ was observed after heating black carrot extract and beetroot mix for 2 h. The decrease in λₘₐₓ for red radish powder during the entire heating period of 3 h was negligible (2 nm). Upon heating cranberry powder, a wavelength of maximal absorbance around 540 nm was no longer present (FIG. 18). Therefore, only datapoints at time 0 min are depicted in FIG. 19. The effect of the heating time on the lightness was different for the different coloring foods (FIG. 20). For red radish powder and black carrot extract, the solution initially became lighter (L*-value increased) and seemed to reach a plateau value after 30 min. GLM analysis for these two coloring foods showed that the change in L* could not be significantly described by the heating time and/or the quadratic term of time (Table). The L*-value of the cranberry powder decreased with increasing heating time, indicating the solution became darker. The opposite was observed for the beetroot mix, where the L*-value increased with heating time. The hue-value of all coloring foods increased upon heating (FIG. 20 and Table 15). After 3 h of heating, this change was the smallest for red radish powder. With a final hue-value of 3.9 degrees, red radish powder was the only coloring food solution with a red appearance upon thermal treatment. Also, the effect of the heating time on the chroma-value was different for the different coloring foods (FIG. 20). For red radish powder and beetroot mix, the chroma-value decreased with increasing time. Both the heating time as the quadratic term were significant terms to describe the change (Table 16). The chroma of the black carrot extract solution was rather stable upon heating, while a small increase was observed for the cranberry powder.

TABLE 12
General linear model to describe λₘₐₓ (B, B*B). Significant terms (p < 0.05) are indicated with *.

| | Red radish powder | | Black carrot extract | | Cranberry powder | | Beetroot mix | |
|---|---|---|---|---|---|---|---|---|
| | | Coefficient | | Coefficient | | Coefficient | | Coefficient |
| Term | P-value | ± std error | P-value | ± std error | P-value | ± std error | P-value | ± std error |
| Heating time (B) | 0.0017* | 0.014 ± 0.003 | 0.0657 | n/a | n/d | n/d | 0.0000* | −0.77 ± 0.08 |
| Heating time* | 0.0000 | −0.0001 ± 0.0000 | 0.3477 | n/a | n/d | n/d | Not sig | |
| Heating time (B*B) | | | | | | | | |
| R² | 92.9 | | 92.5 | | n/d | | 88.8 | |

TABLE 13
General linear model to describe absorbance at λₘₐₓ (B, B*B). Significant terms (p < 0.05) are indicated with *.

| | Red radish powder | | Black carrot extract | | Cranberry powder | | Beetroot mix | |
|---|---|---|---|---|---|---|---|---|
| | | Coefficient | | Coefficient | | Coefficient | | Coefficient |
| Term | P-value | ± std error | P-value | ± std error | P-value | ± std error | P-value | ± std error |
| Heating time (B) | 0.0005* | −0.011 ± 0.002 | 0.0000* | −0.007 ± 0.001 | n/d | n/d | 0.0002* | −0.013 ± 0.002 |
| Heating time* | 0.0038* | 0.00005 ± 0.00001 | 0.0004* | 0.00002 ± 0.00000 | n/d | n/d | 0.0023* | 0.00005 ± 0.00001 |
| Heating time (B*B) | | | | | | | | |
| R² | 78.0 | | 95.4 | | n/d | | 85.0 | |

TABLE 14
General linear model to describe L* (B, B*B). Significant terms (p < 0.05) are indicated with *.

| | Red radish powder | | Black carrot extract | | Cranberry powder | | Beetroot mix | |
|---|---|---|---|---|---|---|---|---|
| | | Coefficient | | Coefficient | | Coefficient | | Coefficient |
| Term | P-value | ± std error | P-value | ± std error | P-value | ± std error | P-value | ± std error |
| Heating time (B) | 0.2439 | n/a | 0.1924 | n/a | 0.0004* | −0.08 ± 0.02 | 0.0000* | 0.17 ± 0.02 |
| Heating time* | 0.5074 | n/a | 0.5423 | n/a | Not sig | n/a | Not sig | n/a |
| Heating time (B*B) | | | | | | | | |
| R² | 32.8 | | 46.6 | | 66.2 | | 87.0 | |

TABLE 15
General linear model to describe hue (B, B*B). Significant terms (p < 0.05) are indicated with *.

| | Red radish powder | | Black carrot extract | | Cranberry powder | | Beetroot mix | |
|---|---|---|---|---|---|---|---|---|
| | | Coefficient | | Coefficient | | Coefficient | | Coefficient |
| Term | P-value | ± std error | P-value | ± std error | P-value | ± std error | P-value | ± std error |
| Heating time (B) | 0.0000* | 0.09 ± 0.01 | 0.0000* | 0.20 ± 0.02 | 0.0160* | 0.25 ± 0.09 | 0.0000* | 0.56 ± 0.08 |
| Heating time* | Not sig | n/a | Not sig | n/a | 0.0488* | −0.0011 ± 0.0005 | 0.0328* | −0.0011 ± 0.0005 |
| Heating time (B*B) | | | | | | | | |
| R² | 80.2 | | 88.6 | | 52.9 | | 96.5 | |

TABLE 16
General linear model to describe chroma (B, B*B). Significant terms (p < 0.05) are indicated with *.

| | Red radish powder | | Black carrot extract | | Cranberry powder | | Beetroot mix | |
|---|---|---|---|---|---|---|---|---|
| | | Coefficient | | Coefficient | | Coefficient | | Coefficient |
| Term | P-value | ± std error | P-value | ± std error | P-value | ± std error | P-value | ± std error |
| Heating time (B) | 0.0002* | −0.21 ± 0.04 | 0.0632 | n/a | 0.0000 | 0.06 ± 0.01 | 0.0000* | −0.23 ± 0.03 |
| Heating time* | 0.0093* | 0.0006 ± 0.0002 | 0.1031 | n/a | Not sig | | 0.0072* | 0.0005 ± 0.0001 |
| Heating time (B*B) | | | | | | | | |
| R² | 90.4 | | 31.2 | | 83.8 | | 97.5 | |

Light-stability. Changes in the spectral properties of the studied coloring foods during storage at 7° C. under dark and illuminated conditions are illustrated in FIG. 21 For cranberry powder no wavelength of maximal absorbance could be observed after 6 days of storage. Therefore, no data points are depicted for day 9 up to day 15. The UV-VIS spectra for these days were similar to the one observed after thermal treatment (FIG. 18). λₘₐₓ for red radish powder was very stable over time and only a limited decrease in absorbance was observed. GML analysis (Table 17) indicated that the interaction term between illumination and storage time was not significant, meaning that the illumination conditions did not affect how λₘₐₓ and the absorbance at λₘₐₓ changed over time. In contrast, the interaction term was significant for black carrot extract. Therefore, one could conclude that the applied illumination conditions did influence the change of λₘₐₓ and of the absorbance at λₘₐₓ during storage. Similar conclusion could be drawn for cranberry powder with regard to the effect on the absorbance and for beetroot mix with regard to the effect on λₘₐₓ. FIG. 22 shows the color values lightness, hue and chroma as a function of storage time under dark and illuminated conditions. In general, the L*-value tended to increase over time, indicating the coloring food solution became lighter. Only for red radish powder there was a significant (Table 18) different trend between storage under dark and under illuminated conditions. Applying illumination during storage decreased the effect on the L*-value. Illumination conditions significantly affected the hue of all anthocyanin rich samples during storage (Table). This was most pronounced for black carrot extract for which the hue-value increased from −3 to 11 degrees when applying illumination, while it decreased to −10 degrees in the dark. In general, C*-values decreased during storage, except for the cranberry powder sample stored including light exposure. Whether or not the samples were subjected to light significantly affected the change in C* over time (Table). Under illuminated conditions C*-values were larger than under dark conditions.

TABLE 17
P-values for the terms tested in the general linear model to describe λₘₐₓ and A at
λₘₐₓ (C, D, D*D, C*D). Significant terms (p < 0.05) are indicated with *.

| | Red radish | | Black carrot | | Cranberry | | | |
|---|---|---|---|---|---|---|---|---|
| | powder | | extract | | powder | | Beetroot mix | |
| | | A at | | A at | | A at | | A at |
| Term | λₘₐₓ | λₘₐₓ | λₘₐₓ | λₘₐₓ | λₘₐₓ | λₘₐₓ | λₘₐₓ | λₘₐₓ |
| Illumination (C) | 0.4494 | 0.2313 | 0.5993 | 0.6934 | 0.2759 | 0.8016 | 0.4975 | 0.9530 |
| storage time (days) | 0.3769 | 0.0000* | 0.8288 | 0.0000* | 0.1584 | 0.0000* | 0.0063* | 0.4030 |
| (D) | | | | | | | | |
| storage time | 0.3184 | 0.0001* | 0.1841 | 0.0004* | 1.0000 | 0.0000* | 0.0000* | 0.6908 |
| (days)*storage time | | | | | | | | |
| (days) (D*D° | | | | | | | | |
| Illumination*storage | 0.7821 | 0.2032 | 0.0000* | 0.0087* | 0.9548 | 0.0358* | 0.0030* | 0.9216 |
| time (days) (C*D) | | | | | | | | |
| R² (%) | 10.1 | 88.9 | 84.1 | 91.8 | 83.6 | 94.8 | 88.4 | 13.5 |

TABLE 18
P-values for the terms tested in the general linear model to describe L*, hue and C*(C, D, D*D, C*D).
Significant terms (p < 0.05) are indicated with *.

| | Red radish powder | | | Black carrot extract | | | Cranberry powder | | | Beetroot mix | | |
|---|---|---|---|---|---|---|---|---|---|---|---|---|
| Term | L* | hue | C* | L* | hue | C* | L* | hue | C* | L* | hue | C* |
| Illumination | 0.4727 | 0.4241 | 0.0966 | 0.6322 | 0.1194 | 0.9673 | 0.6292 | 0.8063 | 0.7556 | 0.9812 | 0.6297 | 0.6683 |
| (C) | | | | | | | | | | | | |
| storage time | 0.3739 | 0.0062* | 0.1021 | 0.0407* | 0.7714 | 0.4806 | 0.1104 | 0.0000* | 0.0029* | 0.0602 | 0.2036 | 0.2581 |
| [days] (D) | | | | | | | | | | | | |
| storage time | 0.3219 | 0.0060* | 0.1635 | 0.3416 | 0.0812 | 0.0196* | 0.8746 | 0.0000* | 0.0237* | 0.8034 | 0.0551 | 0.0881 |
| (days)* | | | | | | | | | | | | |
| storage | | | | | | | | | | | | |
| time (days) | | | | | | | | | | | | |
| (D*D° | | | | | | | | | | | | |
| Illumination* | 0.0016* | 0.0000* | 0.0001* | 0.0668 | 0.0000* | 0.0243* | 0.0773 | 0.0044* | 0.0000* | 0.2259 | 0.1991 | 0.0038* |
| storage time | | | | | | | | | | | | |
| (days) (C*D) | | | | | | | | | | | | |
| R² (%) | 80.1 | 94.2 | 89.8 | 87.5 | 94.9 | 77.0 | 70.7 | 98.2 | 86.7 | 69.9 | 39.5 | 87.8 |

### Discussion

Current data demonstrated the limited pH dependency of the spectral parameters and color values of beetroot mix. Betalains in red beet are reported to be relatively stable at a wide range of pHs between 3 and 7. The color of red beetroot extract is expected to change from red towards blue as the pH increases above 7.0. Nevertheless, also Thimmaraju et al. did not show significant shift in color in terms of Hunter values (L*, a* and b*) between pH 3 and 9. In a red beet solution, the absorbance at 530 nm, the wavelength representative for betacyanin, was also relative stable between pH 4 and pH 7. The pH dependent chromaticity of the red radish powder, black carrot extract and cranberry powder can be attributed to the anthocyanins it contains. It is very well known that anthocyanins exist in various colored and colorless forms: red flavylium cation, colorless carbinol pseudo-base, blue-purple quinoidal-base, and pale yellow chalcone. The form that predominates is largely determined by pH. The flavylium cation only predominates at very low pH (<2). Increasing the pH results in a decrease of color intensity and the concentration of the flavylium cation, as it is hydrated by nucleophilic attack of water to the colorless carbinol pseudo-base. When the pH increases further the carbinol form yields the colorless chalcone. Also, a proton loss of the flavylium cation takes place as the pH increases and the blue-purple quinoidal form rises. Scientific literature has reported that acylated anthocyanins were more stable to pH changes than non-acylated ones. The acylation makes the anthocyanins more stable through intramolecular co-pigmentation, protecting the flavylium chromophore from the nucleophilic attack of water. It is suggested that diacylated anthocyanins might be more stable than mono-acylated and non-acylated ones due to a sandwich type stacking. Based on this theory, following pH-stability could have been expected: cranberry powder (non-acylated)<black carrot (mono-acylated derivates)<red radish powder (mono acylated and di-acylated derivatives). The current study showed that pH changes impacted the color values of these three coloring foods quite differently (FIG. 17). The cranberry powder solution turned more yellow as the pH increased while the solution of black carrot extract and red radish powder turned more purple. This is consistent with the study of Malien-Aubert et al., which reported that for acylated anthocyanins (red radish and purple carrot) the hue angle decreased when the pH increased while the hue angle was stable or increased when the pH was raised in colorants containing only non-acylated anthocyanins. The solution of cranberry powder and black carrot extract also became darker and duller as pH was raised while for red radish powder an extremum was observed around pH 6.0. The color properties of red radish anthocyanins in different pH aqueous systems is consistent with this study, where Jing et al. detected decreasing hue angles with increasing pH. In addition, they observed a decrease in chroma when the pH increased from 1.5 to 4.5. For pH >4.5, the chroma increased again resulting in more vivid color. This is consistent with the current study (FIG. 17), L* showed a maximum where chroma showed a minimum value.

Beetroot mix was shown to be the least thermally stable of the studied coloring food. It is rather well known that heating of betalains cause discoloration and that betanin becomes light brown if gradually heated²⁵. Betalains are degraded at elevated temperatures due to decarboxylation and dehydrogenation reactions²⁴. Elbandy and Abdelfadeil²⁷ found that heating red beetroot extract for 3 min at 85° C. induced an additional λₘₐₓ at 460 nm suggesting a structural alteration had occurred. This might also explain the sudden drop in λₘₐₓ from about 520 nm to about 420 nm after 2 hours of heating (FIG. 20). Thermal degradation of anthocyanins has been mainly investigated at acidic pH^{18, 30-32}. Under acidic conditions anthocyanins are expected to be more stable than under neutral pH conditions. For example, Kirca et al.³³ showed that increasing the pH form 4.3 to 6.0 enhanced the degradation of anthocyanins from black carrot during heating. Fenger et al.³⁴ suggested that the irreversible degradation of anthocyanins in neutral solution is probably kinetically controlled by an initial step of one- or two-electron autoxidation of the anionic base. In acid¹⁸ but also in neutral solution³⁴, acylated anthocyanins showed higher resistance to color loss caused by heating compared to their nonacylated homologs. Based on this theory the following thermal stability could have been expected: cranberry powder (non-acylated²²)<black carrot (mono-acylated derivates²⁰)<red radish powder (mono acylated and di-acylated derivatives^{1, 20}). This order was reflected in the stability of the λₘₐₓ-values but not in the other measured parameters. Additionally, the presence of sugars in the coloring food samples might have impacted the degradation rate of anthocyanins. Both protective effects of sugars^{35, 36} as well was accelerating effects¹⁸ have been reported in literature.

Light is known to influence the stability of beetroot pigments even at low temperature. Degradation due to light is caused by the absorbance of light in UV and visible wavelengths leading to excitation of electrons and consequently higher reactivity²⁴. Also for anthocyanins, light exposure has been reported to accelerate color loss³⁷ and pigment degradation^{38, 39}. Bononi and Tateo¹⁹ exposed a dried cranberry powder extract in a thin layer to natural light and ambient temperature. They observed an almost total degradation of the anthocyanins after 30 days. This is consistent with the current results for cranberry powder for which no λₘₐₓ was detected after 6 days of storage (FIG. 21). Yoshida et al.⁴⁰ suggested that stability of acylated anthocyanins to light highly depends on the molecular stacking preventing E- to Z-isomerisation. This hypothesis was also supported by Matsufuji et al.²⁹.

Red radish powder was the only coloring food evaluated in the current study for which illumination did not affect how the spectral properties changed over time. Matsufuji et al.²⁹ indicated that for red radish extract the number of intramolecular acyl units contribute to the stability to light irradiation at lower pH, whereas the characteristics of intramolecular acyl units influence the stability at high pH. They also suggested that some unknown anthocyanins were formed by photodegradation. In addition, the changes in hue-value during illuminated storage of the red radish powder solution were limited and the effect of light exposure on the lightness and color intensity were favorable.

### Conclusion

The color hue provided by the coloring foods or agents (in the pH range of cooked meat) is critical for any nitrite replacement for cured meat products. Within the pH-range of interest for meat applications (pH 5.5-6.5) the hue-values of red radish powder and black carrot extract were similar and ranged from −15 to −24 degree (pH 5.4 and pH 6.4). For red radish powder this was validated in emulsified cooked pork sausages (Example 1), however, black carrot did not provide the desired hue in emulsified cooked pork sausage (Example 2). Although the spectral and color properties of beetroot mix showed perfect pH stability, its hue-values were far from the desired pink-reddish color.

The obtained results also demonstrated a unique combination of spectral and color properties for red radish powder including limited spectral shifts within the pH-range of interest for cooked meat applications (pH 5.5-6.5) and an extremum in lightness and chroma around pH 6.0. In addition, red radish powder was the only coloring food solution at pH 6.4 which still had a red appearance upon 3 hours of thermal treatment. In summary, red radish powder was also the only coloring food evaluated in the current study for which exposure to light did not affect how the spectral properties changed over time. Furthermore, the changes in hue-value during illuminated storage were limited and the effect of light exposure on the lightness and color intensity were favorable.

### Example 4: Effect of pH on Color Characteristics

### Materials and Methods

For purposes of this study, red radish powder was combined with buffered vinegar, green tea extract and rosemary extract as a blend to study the capability of the blend to serve as a nitrite replacement in cured meat. Because buffered vinegar, green tea extract and rosemary extract might affect the color characteristics of the red radish blend, the researchers evaluated the effect of pH on the color characteristics.

Materials. Two different batches of red radish powder were obtained with reported color value E^{1%}(514 nm) of 50.80 and 50.58 g¹ ml cm⁻¹. With these batches of red radish powder, two samples were prepared comprising the following ingredients: 73.5% wt BactoCEASE NV Dry (Kemin Industries, Des Moines, Iowa), 18.0% wt red radish powder, 6% wt rosemary extract (with 10% carnosic acid) and 2.5% green tea extract (total polyphenols: 87.98%; total catechins: 71.66%; epigallocatechin gallate (EGCG): 36.91%).

Sample preparations. The appropriate concentration of an aqueous red radish powder stock solution was determined in a preliminary test showing that a 100-fold dilution of a 2.7% (m/v %) solution (at pH 3.0) resulted in an absorbance of approximately 1 at 514 nm. The concentration of the stock solution of the special blend was calculated to be 15.0% (m/v %) based on equivalent concentration of red radish powder. Stock solutions from two different raw material batches of red radish powder and 2 replicates per batch were prepared resulting in 4 different stock solutions for each sample. The stock solutions were 100-fold diluted in citric acid monohydrate-disodium hydrogen phosphate buffer at different pH levels (pH 3.0 to pH 7.5). These buffers were prepared by mixing appropriate volumes of 0.1 M citric acid monohydrate and 0.2 M disodium hydrogen phosphate.

pH measurements. The pH of the citric acid monohydrate-disodium hydrogen phosphate buffers and of the samples was measured using a WTW Inolab pH 720 device.

UV-VIS spectra. Absorption spectra of the samples at different pH-values were scanned as described in Example 3.

Color measurement. The color of the samples was analyzed as described in Example 3.

### Results

Spectral characteristics at different pH values. The wavelength of maximal absorbance (λₘₐₓ) and its corresponding absorbance was determined from the UV-VIS spectra. This was done for the red radish powder samples as well as for the special blend samples. The parameters are shown as a function of pH in FIG. 23 for batch n° 191124 and in FIG. 24 for batch n° 200925. The results of the two different batches were almost identical. For both batches λₘₐₓ increased with increasing pH. Especially at pH >6.6 the bathochromic shifts are large. For red radish powder an average shift of 5 nm was observed between pH 6.6 and 6.8 of 11 nm between pH 6.6 and 6.8 and of 22 nm between pH 7.0 and 7.5. Within the pH range of interest for meat application (pH 5.5-6.5) the spectral shifts were limited (5 nm shift between pH 5.4 and pH 6.6). In addition, FIGS. 23 and 24 showed no difference in λₘₐₓ existed between the red radish powder and the special blend at a particular pH-value. Nevertheless, a large difference in absorbance was observed between the red radish powder and the special blend for pH >6.0. The hyperchromic effect observed for red radish powder between pH 5.8 and pH 7.5 was much less pronounced in the special blend.

Color properties at different pH values. Pictures of the samples made with batch 191124 at different pH values are shown in FIG. 25. The hue and chroma values are depicted in FIGS. 26 and 27, respectively. The hue angle changed from about 30 to −40 suggesting a color change from orange-red to rose-magenta along with a pH change from 3.0 to 7.5. An increase in pH from 3.0 to 5.2 caused a decrease in chroma indicating the color became duller. For the red radish powder the chroma increased again for pHs >6.0. For the special blend this latter increase was limited (batch n° 191124) or even absent (batch n° 200925).

### Discussion

The spectral characteristic and color properties of the special blend differed from the pure red radish powder in terms of absorbance and chroma, while no significant difference was found in λₘₐₓ and hue. This demonstrates that the color tint was equal but different in intensity.

Co-pigmentation is defined as (i) the formation of noncovalent complexes involving an anthocyanin or anthocyanin-derived pigment and a co-pigment and (ii) the subsequent changes in optical properties of the pigment. Trouillas, P., J. C. Sancho-Garcia, V. De Freitas, J. Gierschner, M. Otyepka, and O. Dangles. 2016. Stabilizing and modulating color by copigmentation: Insights from theory and experiment. Chemical Reviews. 116: 4937-4982 (2016). In general, co-pigmentation is observed as a bathochromic shift. The color of the anthocyanin therefore changes to more blue through co-pigmentation. Co-pigmentation can also be observed by a hyperchromic effect, in which the intensity of an anthocyanin color is fortified. Rein, M., Copigmentation reactions and color stability of berry anthocyanins (2005). Co-pigmentation can take place by several interactions including self-association, metal complexation, intramolecular and intermolecular complex formation. Trouillas (2015), Rein (2005). The absence of a spectral shift when increasing the concentration of pelargonidin derivatives from red radish was interpreted by Willer-Maatsch et al. as an indication that these types of anthocyanins lack the ability to self-associate. Müller-Maatsch, J., L. Bechtold, R. M. Schweiggert, and R. Carle, Co-pigmentation of pelargonidin derivatives in strawberry and red radish model solutions by the addition of phenolic fractions from mango peels, Food Chemistry. 213: 625-634 (2016). Also, the effect of Fe3+ on the spectrum of acylated pelargonidin derivatives extracted from red radish has been studied before. Wang, L.-S., X.-D. Sun, Y. Cao, L. Wang, F.-J. Li, and Y.-F. Wang, Antioxidant and pro-oxidant properties of acylated pelargonidin derivatives extracted from red radish (raphanus sativus var. Niger, brassicaceae). Food and Chemical Toxicology. 48: 2712-2718 (2010). Wang reported a concentration dependent bathochromic shift and hyperchromic effect in 0.1% HCl.

Furthermore, intramolecular co-pigmentation in red radish has been mentioned as the main stabilising effect. Diacylation in red radish anthocyanins enhances the stability by a sandwich type stacking preventing the addition of nucleopliles (water) to the C-2 and C-4 positions diminishing the formation of the pseudobase. Rodriguez-Saona (1999). In addition, the presence of the acylating groups produces a bathochromic shift changing the hue towards red or red-purple compared to the orange-red pelargonidin-3-sophoroside-5-glucoside. Giusti (2003). However, this intramolecular co-pigmentation mechanism cannot explain the differences in spectral characteristics and color properties between the red radish powder and the special blend as both samples contained equal amounts of red radish powder. Finally, intermolecular co-pigmentation between anthocyanins and other flavonoid molecules could also improve the color of the anthocyanin by reducing the production of the carbinol psuedobase, ultimately leading to an intensification of color and increased stability. Müller-Maatsch, J., L. Bechtold, R. M. Schweiggert, and R. Carle, Co-pigmentation of pelargonidin derivatives in strawberry and red radish model solutions by the addition of phenolic fractions from mango peels, Food Chemistry. 213: 625-634 (2016). Delocalised electrons of the chromophore may interact with the neighbouring co-pigment, potentially leading to a shift in hue.

Several studies on intermolecular co-pigmentation considering red radish anthocyanins and/or catechins (as present in the special blend via the green tea extract) were found in literature. Müller-Maatsch (2016); Escribano-Bailon, T., O. Dangles, and R. Brouillard, Coupling reactions between flavylium ions and catechin, Phytochemistry. 41: 1583-1592 (1996); Santos-Buelga, C., S. Bravo-Haro, and J. C. Rivas-Gonzalo, Interactions between catechin and malvidin-3-monoglucoside in model solutions, Zeitschrift für Lebensmittel-Untersuchung and Forschung. 201: 269-274 (1995); Stebbins, N. B., L. R. Howard, R. L. Prior, C. Brownmiller, R. Liyanage, and J. O. Lay, Formation, tentative mass spectrometric identification, and color stability of acetaldehyde-catalyzed condensation of red radish (raphanus sativus) anthocyanins and (+) catechin, Beverages. 5: 64 (2019).

Intermolecular co-pigmentation of red radish anthocyanins at pH 3.5 and gallic acid derivatives from mango peel has been mentioned by Müller-Maatsch et al. (2016). A hyperchromic effect was observed, while a bathochromic shift was nearly absent (<3 nm). In weakly acidic solutions containing catechin combined with two different synthetic 3-methoxyflavylium ions the UV-VIS spectra showed hyperchromic effects and bathochromic shifts. Escribano-Bailon (1996). In addition, acetaldehyde catalysed condensation of red radish anthocyanins and catechin resulted in a more vivid purple color with lower hue angle. Stebbins (2019).

The previous literature on co-pigmentation does not support the observation of the current study, however. Instead, the results are precisely contradictory, showing hyperchromic effects instead of the hypochromic effect observed in the current study. However, it should be noted that all studies found in literature were performed in more acidic conditions of pH 3 to 4 while the hypochromic effect of the experimental blend was observed for pH-values >6 (FIG. 23 and FIG. 24).

Until now, there has been no explanation for the researcher's observed hypochromic effect. This surprising and unexpected result, the increased stability of the color intensity in the special blend within the pH range of processed meat (pH 5.5-6.5), is a significant advantage and promising for future commercialization of the special blend as a nitrite salt replacement. Indeed, the improved pH stability of the color intensity increases the applicability of the special blend for cured meat products with recipe dependent pH-values and also the capability to account for batch to batch variability in pH.

### Example 5: Special Blend in Emulsified Cooked Pork Sausage

The researchers studied emulsified cooked pork sausages and observed that the compositions of the present invention, when applied at a range of up to about 0.4 to 1.5%, for instance about 0.4 to 0.9%, and in at least one embodiment about 0.4 to 0.5%, to a cooked emulsified pork sausage was able to replace all nitrite functionalities.

### Materials and Methods

Experimental set up. The current study consists of three separate experiments as outlined in Table 19. In the first experiment the invented blend was applied at three different dosages to an emulsified cooked pork sausage and compared to a cooked emulsified pork sausage with and without NaNO2. The following parameters were evaluated: 1) initial color and color changes during storage including a period of 72 h of illumination, 2) outgrowth of L. monocytogenes, and finally 3) sensorial acceptance. The second experiment focused on the potential outgrowth of C. botulinum. The blend was applied at 0.4%. Sausages were prepared using the special blend of Example 4 but excluding ascorbic acid (AA) from the recipe in the third experiment. In addition, the third experiment focused on the protective action of the invented blend towards C. botulinum. For experiment 3, the following parameters were evaluated: 1) color and color stability, 2) outgrowth of C. botulinum spores, and 3) formation of botulinum toxin.

TABLE 19
Experimental set up of the study.

| | Experiment 1 | | Experiment 2 | | Experiment 3 | |
|---|---|---|---|---|---|---|
| Treatments | 1. Positive control | | 6. Positive control | | 1. Positive control | |
| | (with NaNO₂) | | (with NaNO₂) | | (with NaNO₂) | |
| | 2. Negative control | | 7. Negative control | | 2. Negative control | |
| | (without NaNO₂) | | (without NaNO₂) | | (without NaNO₂) | |
| | 3. 0.30% blend | | 8. 0.40% blend | | 3. Growth control (without | |
| | 4. 0.40% blend | | | | NaNO₂, without NaCl) | |
| | 5. 0.50% blend | | | | 4. 0.40% blend 1 | |
| | | | | | 5. 0.40% blend 1, no AA | |
| | | | | | 6. 0.40% blend 1, no AA, | |
| | | | | | low NaCl | |
| Storage | 8 weeks, 7° C., 72 h | | 8 weeks, 7° C., 72 h | | 8 weeks, 7° C., 72 h | |
| conditions | illumination | | illumination | | illumination | |
| | | | 8 weeks, 7° C., no | | 8 weeks, 7° C., no | |
| | | | illumination | | illumination | |
| Analysis | Parameter | Frequency | Parameter | Frequency | Parameter | Frequency |
| | Appearance | Weekly | Appearance | Day 1, 21, 56 | Appearance | Day 1, |
| | and color | Weekly | Clostridium | Every 2 | and color | 28, 56 |
| | Listeria | Day 1 | botulinum | weeks | Lipid | Day 1, |
| | monocytegenes | & 15 | challenge | | oxidation | 28, 56 |
| | challenge | | test** | | Clostridium | Every 2 |
| | test* | | | | botulinum | weeks |
| | Sensory | | | | challenge test^{$} | |
| | | | | | Toxin | Day 1, |
| | | | | | detection^{$$} | 56 |

*analysis performed by Micro Smedt (Herentals, Belgium)
**analysis performed by the research group of Food Microbiology and Food Preservation of the University of Gent (FMFP-UGent)
^{$}analysis performed by the department of Food Science at Liège University (ULiège) (Liège, Belgium)
^{$$}analysis performed by Sciensano (Brussels, Belgium)

Materials. The blend was prepared by mixing red radish powder, green tea extract and rosemary extract. After an initial mixing step, dry buffered vinegar was added to the blend and homogenized once more.

Sausage preparation. The meat mixture for the emulsified cooked pork sausages were prepared according to the recipes summarized in Table 20. Recipes of cooked emulsified pork sausage.

TABLE 20
Recipes of cooked emulsified pork sausage.

| | | | | | | | Special blend | | |
|---|---|---|---|---|---|---|---|---|---|
| | | | Growth | | | | | | No |
| | | | control | | | | | | AA, |
| Ingredient | Positive | Negative | without | | | | | No | low |
| (%) | control | control | salt | Special blend | | | | AA | salt |
| Lean pork meat | 40.00 | 40.00 | 40.00 | 40.00 | | | 0.40 | | |
| Back fat | 35.00 | 35.00 | 35.00 | 35.00 | | | 35.00 | | |
| Kitchen salt | / | 1.89 | n/a | 1.89 | | | 1.89 | 1.20 | 1.20 |
| Curing salt | 1.90 | n/a | n/a | n/a | | | n/a | | |
| Chopping | 0.30 | 0.30 | 0.30 | 0.30 | | | 0.30 | | |
| phosphate | | | | | | | | | |
| Ascorbic acid | 0.05 | 0.05 | 0.05 | 0.05 | | | n/a | n/a | n/a |
| Potato starch | 2.50 | 2.50 | 2.50 | 2.50 | | | 2.50 | | |
| Special blend | n/a | n/a | n/a | 0.30 | 0.40 | 0.50 | 0.40 | | |
| Ice | 20.26 | 20.26 | | 19.96 | 19.86 | 19.76 | 19.86 | 19.91 | 20.60 |

n/a: not applicable,
AA: ascorbic acid

The sausages were cooked in a combi steamer (Eloma Joker MT, All Food Machines, Nazareth, Belgium) set at 80° C. and 100% relative humidity, during 35 min to reach a core temperature of 72° C. Subsequently, the sausages were cooled in cold tap water and kept at 4° C. until the next day. For the first experiment all treatments were prepared in triplicate. For the second and third experiment all treatments were prepared in duplicate.

Slicing, packaging and storage. Prepared sausages were cut into 2 mm slices and packed in vacuum pouches (50 mbar). The samples were stored at 7° C. up to 8 weeks. In the first experiment samples were exposed to continuous illumination during the last 72 h of the storage period to represent display in the shelf of the supermarket. For pork display, light color of 2900-3750 K and intensities of 800-1600 lux have been recommended¹⁴. However, suboptimal lighting conditions (Tubular fluorescent lamp, 4000 K, 2500 lux) were chosen as a worst-case scenario. In the second and third experiment, a part of the samples was also stored in complete darkness by placing the packages in a carton box and covering them with aluminum foil.

Color evaluation. The color of the sausages was measured as described in Example 1. Color differences were calculated from average L*a*b-values according to Equation 6.

$$Color difference {Δ E}_{i , j ; pos , 0}^{*} : color values of sausage i after j days of storage compared to color values of the positive control before storage ( 0 days ) .$$

$${Δ E}_{i , j ; pos , 0}^{*} = \sqrt{{( {L}_{i , j}^{*} - {L}_{pos , 0}^{*} )}^{2} + {( {a}_{i , j}^{*} - {a}_{pos , 0}^{*} )}^{2} + {( {b}_{i , j}^{*} - {b}_{pos , 0}^{*} )}^{2}} . \qquad Equation 6$$

The appearance was monitored by taking photographs in a photo box with LED illumination (3000 lux).

Microbiological analysis. For the first experiment, microbiological analysis was performed by Micro Smedt (Herentals, Belgium). At the start of the shelf life samples were inoculated with a cocktail of three Listeria monocytogenes strains: LMG 23905 (origin cooked ham), LMG 23194 (origin Wijnedaele cheese) and LMG 23774 (origin smoked salmon). The inoculum was applied to the surface of the cooked sausage using a needle and septum. The inoculum size was 300 colony forming units (CFUs)/g sample. The samples were stored at 7° C. After different time points the number of L. monocytogenes was determined.

For the second experiment, microbiological analysis was performed by the research group of Food Microbiology and Food Preservation of the University of Gent (FMFP-UGent) (Gent, Belgium) and included a C. botulinum challenge test. A spore suspension from a cocktail of C. botulinum spores (Type A: NCTC 7272, Type E: LFMFP-CB 707 and Type E: LFMFP-CB 666) was heated (10 min, 65° C.) and cooled immediately in an ice water bath. The cooked emulsified pork sausages (4 slices, 100 g) were inoculated with 50 μl of the spore suspension (1.6×10⁶ spores/ml) to obtain an inoculum size of approximately 800 spores/g. The samples were stored at 7° C. up to 8 weeks and were analyzed on day 0 (before and after inoculation), day 14, day 28, day 42 and day 56. Sampling was performed in an anaerobic chamber to avoid any contact with oxygen. Plating was done on tryptone glucose yeast extract agar and plates were incubated during 72 h at 30° C. under anaerobic conditions.

For the third experiment, the C. botulinum challenge test was performed by the Department of Food Science of Liege University (Liege, Belgium). Hereto pre-sliced, vacuum packed samples in portions of 50 g were transferred to the Experimental Unit for Food Processing, Department of Food Science, Liege University (Liege, Belgium). Samples were inoculated at 3 log₁₀CFU/g on the surface with a cocktail of spores from 3 Group II non-proteolytic type B C. botulinum strains (BL7 ULiège collection; 300.05 Pasteur Institute, Paris, France; 815.12 Pasteur Institute, Paris, France). The samples were stored at 7° C. up to 8 weeks and were analyzed on day 0, day 14, day 28, day 42 and day 56. Classical culture was realized using tryptose sulphite agar incubated under anaerobic conditions at 30° C. during 48 h before numbering colonies observed in the core of the media. For the control treatments (negative control, growth control and positive control) non-inoculated samples were analyzed on day 0 and on day 56 to confirm C. botulinum was absent. The analysis was carried out in triplicate.

Sensory analysis. Sausages prepared in experiment 1 were evaluated after 1 day of storage (no illumination). Sensory analysis was also performed after 15 days (including 72 h of illumination). The untrained sensory panel (n=12) performed a combined preference and acceptance test considering both color, smell and taste. Each individual was asked to rank the samples and to score each sample using a 9 point hedonic scale where 1=dislike extremely, 2=dislike very much, 3=dislike moderately, 4=dislike slightly, 5=neither like nor dislike, 6=like slightly, 7=like moderately, 8=like very much, and 9=like extremely¹¹. None of the panelists objected to eat the sample and all were familiar with the type of product.

Data analysis. From each meat batter, the color of three slices was evaluated and the average and standard deviation from 9 (experiment 1) or 6 (experiment 3) L*a*b-values were calculated. ΔE*-values were determined based on the average L*a*b-values. Analysis of variance (one-way ANOVA) and multiple range tests (95.0 percent Least Significant Difference procedure LSD) were performed using STATGRAPHICS® Centurion XVIII (Statpoint Technologies, Inc., Warrenton, USA) on the following parameters: L*a*b-values, TBARS concentration, L. monocytogenes counts, anaerobic accounts, preference and acceptance scores.

### Results

Appearance and color evaluation. The appearance and color of the cooked emulsified sausages were evaluated immediately after slicing (day 0) and afterwards weekly following a 72 h period of illumination. Photographs taken at day 0, 7, 15 and 56 are shown in FIG. 28. After 7 days, the positive control showed clear discoloration. In contrast, the samples containing the blend seemed to have a more intense pink color after 7 days than at day 0. During the trial, it was observed that the color of the slices was different at the top side than at the bottom side. The top side of the slice of the positive control was more faded than the bottom side. This could have been expected since the top side was directly illuminated during 72 h. However, for the samples with the invented blend the opposite was observed. The top side was more pink than the bottom side. Because of this unexpected observation, two storage conditions were included in the second and third experiment. The first condition was the same as in experiment 1 (72 h of illumination at the end of the storage time). The second condition was complete darkness by storing the samples in a carton box and covering them with aluminum foil. Pictures are shown in FIG. 29 and FIG. 30. The positive control showed clear discoloration but only when the sample was exposed to light. The opposite was true for the samples containing the invented blend together with ascorbic acid. The illuminated samples were more pink than the samples kept in the dark (FIG. 29). Samples prepared with the invented blend excluding ascorbic acid maintained their pink color during dark and illuminated storage (FIG. 30). The L*a*b*-values and calculated color differences of the sausages are shown in FIG. 31. The L*-values of the cooked sausages prepared with the invented blend were lower compared to the positive control (p<0.05). A dosage of 0.3% of the blend resulted in a higher L*-value than a dosage of 0.4% and 0.5% (p<0.05). This was the case during the entire storage period. The a*-values of the sausages with the special blend were initially lower than the a*-value of the positive control (p<0.05). These a*-values increased as the dosage of the blend increased (p<0.05). The a*-value of the positive control dropped drastically after 1 week (including 72 h of illumination) (p<0.05), while the a*-values of the sausages containing the blend slightly increased in the beginning of storage (p<0.05) which was followed by a slow decrease. The b*-value of the positive control slightly increased during storage (p<0.05). The b*-values of the sausages prepared with the blend decreased after 1 week of storage (p<0.05). After the first week the b*-values slightly increased again (p<0.05). The color differences compared to the initial color of the positive control are also depicted in FIG. 31. The initial color difference was the smallest for the sausage containing 0.5% of the special blend. During the first 2 weeks of storage the color difference increased, followed by a decrease. The color differences of the sausages with 0.3% and 0.4% were similar. They decreased after the first week and remained constant afterwards.

The L*a*b-values of the sausages prepared in experiment 3 are shown in FIG. 32. Just as in experiment 1, the initial L*-values of the cooked sausages prepared with the invented blend were lower compared to the positive control (p<0.05). The results showed that the b*-value of the sausages prepared with the invented blend (including AA) increased when stored in the dark (p<0.05). However, this was not the case when no AA was added. Significant (p<0.05) decrease in a*-values were found during storage for the positive control samples stored in illuminated as well as in dark conditions. All initial a*-values of the sausages prepared with the invented blend were lower (p<0.05) than the a*-value of the positive control (p<0.05). However, the a*-values of the samples prepared with the invented blend but without AA were higher than the a*-values of the sausages prepared with the blend (including AA) (p<0.05). The a*-values of the samples prepared with the invented blend without AA did not decrease during storage.

Microbial growth. The emulsified cooked sausages prepared in experiment 1 were inoculated with 300 CFU/g of a cocktail of L. monocytogenes and the number of CFU's was followed during 8 weeks (FIG. 34). The number of CFU's in the negative control sample increased from 0 up to 7 weeks to reach almost 9 log₁₀CFU/g. For the positive control the L. monocytogenes count started to increase after 1 week, reaching 7 log₁₀CFU/g after 8 weeks. In the sausage with 0.3% of the invented blend a slight increase in the number of L. monocytogenes was noticed after 42 days. When the blend was dosed at 0.4 or 0.5% no increase in L. monocytogenes could be observed within the shelf life of 8 weeks.

Duplicate samples from experiment 2 were inoculated with a cocktail of C. botulinum spores at approximately 2.9 log₁₀CFU/g. Before inoculation the anaerobic count was below the detection limit of 1 log₁₀CFU/g. The anaerobic count, presumable C. botulinum, was evaluated during the shelf life (Table). In the negative control growth was observed. However, the growth was not consistently over all samples. The challenge test indicated no growth of C. botulinum in any of the positive control samples. Also no significant growth (>0.5 log₁₀CFU/g⁴⁵) was observed in the sample prepared with 0.4% of the invented blend.

TABLE 21
Anaerobic count (log₁₀CFU/g) of cooked emulsified pork sausages stored
at 7° C. after inoculation with a spore suspension from a cocktail of C. botulinum
spores (Type A: NCTC 7272, Type E: LFMFP-CB 707 and Type E: LFMFP-CB 666).

| | Positive | | Negative | | | |
|---|---|---|---|---|---|---|
| Storage time | control | | control | | Blend 0.4% | |
| (days) | Repl 1 | Repl 2 | Repl 1 | Repl 2 | Repl 1 | Repl 2 |
| 0 | 3.08 | 2.73 | 2.77 | 3.00 | 2.89 | 2.68 |
| 14 | 2.75 | 2.70 | 2.69 | 5.30 | 2.84 | 2.84 |
| 28 | 2.61 | 2.62 | 2.83 | 2.66 | 2.78 | 2.82 |
| 42 | 2.67 | 2.46 | 3.63 | 2.88 | 2.79 | 2.74 |
| 56 | 2.49 | 2.43 | 2.59 | 2.75 | 2.65 | 2.77 |

Repl = Replicate

Duplicate samples of sausages prepared in experiment 3 were inoculated with a cocktail of C. botulinum spores at approximately 3 log₁₀CFU/g. Before inoculation, the anaerobic count was below the detection limit of 0.7 log₁₀CFU/g. Therefore, it can be concluded that the raw materials used for preparing the cooked emulsified pork sausages did not naturally contain C. botulinum cells. The initial anaerobic count after inoculation was slightly lower (p<0.05) for the growth and negative control than for the other samples (FIG. 35). The anaerobic count was evaluated during the shelf life and is depicted in FIG. 35. No growth of C. botulinum was detected. On the contrary, the anaerobic count decreased (p<0.05) in all samples during the storage period. This decrease was more pronounced for the control samples than for the invented blend samples. Furthermore, the samples were analyzed for the presence of botulinum toxins. At day 0 five aliquots of the growth control sample were evaluated. In none of them toxin was detected. At day 56 all samples were evaluated. The results are summarized in Table 22. The growth control was the only sample in which C. botulinum toxin was detected. The type detected was botulinum toxin B. Type A, E and F were not found.

TABLE 42
Number of samples in which botulinum
toxin was detected to total analyzed samples.

| Treatment | Day 0 | Day 56 |
|---|---|---|
| Negative control | n/d | 0/2 |
| Growth control | 0/5 | 1/2* |
| Positive control | n/d | 0/2 |
| Blend | n/d | 0/2 |
| Blend, no AA | n/d | 0/2 |
| Blend, no AA, low NaCl | n/d | 0/2 |

n/d: not determined
*Type B toxin was detected

Sensory evaluation. Emulsified cooked sausage prepared in experiment 1 were evaluated by a taste panel on color, smell and taste after 1 day of storage (not illuminated) and after 15 days of storage including 72 h of illumination. Preference and acceptance scores are shown in FIG. 36. Overall, the negative control sample was perceived the worst and had an acceptance score below the acceptance limit. At day 1, the sample prepared with 0.5% of the invented blend was preferred above the sausage with 0.4% of the invented blend. After 15 days there was no significant difference between these two treatments. The sample containing 0.4% or 0.5% of the special blend had the same or better preference and acceptance score than the positive control. This was the case after 1 day of storage (not illuminated) and after 15 days of storage including 72 h of illumination.

### Discussion

The current study indicated that when kept in the dark, the nitrite containing cooked sausage slices maintained their redness for a longer time than the slices made with the invented blend. It was hypothesized that the presence of ascorbic acid in the recipe accelerated the degradation of anthocyanin pigments present in the red radish powder. For that reason, sausages were prepared using the special blend excluding ascorbic acid from the recipe. This treatment improved the color compared with the treatment with the special blend and including ascorbic acid. The initial redness (a*-value) was higher and the pink color remained more stable during storage (with and without exposure to illumination) up to 8 weeks. In addition, the undesired increase in yellowness during dark storage was not observed for the sample prepared with the special blend but without ascorbic acid. The color changes occurring during illuminated storage where more favorable for the sausages prepared with the invented blend than for the positive control. Especially the redness of was more stable, as shown in FIGS. 31 and 32. The redness of the positive control faded drastically during illuminated storage. It is well known that the pink cured meat color fades to gray when exposed to light and oxygen. The slightly different pink color generated by using about 0.4% or 0.5% of the present invention instead of nitrite, did not result in a penalty on the preference or acceptance score during a sensory analysis considering color, smell and taste (FIG. 36).

The growth of L. monocytogenes was most rapid in the negative control sample. This could have been expected since L. monocytogenes can grow at refrigerated temperatures⁵⁰. Moreover its growth is little affected by anaerobic atmosphere⁵¹. The outgrowth of L. monocytogenes was delayed in the positive control sample with nitrite. A formulation is considered to be effective in preventing the growth of L. monocytogenes if replicate growth studies show less than 1 log increase in the number of L. monocytogenes. The positive control reached a 1 log increase after 14 days. Therefore, its shelf life is still limited. The obtained results are in accordance with previous studies. Sodium nitrite reduced the growth rate and increased the lag time of L. monocytogenes in vacuum packed cooked meats stored at 5° C. Verkleij and Oostrom⁵⁴ reported that L. monocytogenes inoculated in bologna type sausage with 160 and 80 ppm nitrite did not increase during the entire storage period of 32 days at 7° C. However, they mentioned the presence of lactate in the product which is known to have anti-Listeria activity. In the sample with 0.3% of the invented blend, growth of L. monocytogenes was substantially delayed, extending the shelf life to 49 days. Applying 0.4% and 0.5% of the blend inhibited the growth of L. monocytogenes completely during the entire shelf life. With regard to the outgrowth of L. monocytogenes, the invented blend clearly outperformed the treatment with nitrite. Except in the negative control sample, no outgrowth of C. botulinum spores was detected. The results therefore suggest that the hurdles in the samples with 0.4% of the invented blend were sufficient to prevent outgrowth of the spores. In the literature, it has been mentioned that organic acids and salts of organic acids have the potential to provide an additional barrier against growth of C. botulinum. Natural fermentates containing mixtures of propionic acid, lactic acid and acetic acid have been able to inhibit spore germination of non-proteolytic C. botulinum in cooked ham stored at 7° C. up to 30 days⁵⁶. For instance, Koch et al. have shown that the presence of sodium lactate inhibited growth of C. botulinum in sausages with 2% water-phase salt and pH 6.2 at 5° C. and 8° C. In their study, sodium acetate (0.25%) did not prevent growth. It could be hypothesized that dry buffered vinegar, next to pH, a_{w}, and salt content, is an important contributor to the growth barrier by providing acetic acid/acetate.

Apart from the growth control, all other samples remained nontoxic during the 8-week shelf life. This demonstrates that the spores were unable to germinate and develop into a toxic culture when the invented blend was applied. Previously, Jafari et al. detected C. botulinum toxins in hot dogs prepared without nitrite and no toxins in hot dogs prepared with 120 ppm sodium nitrite. Lebrun et al. very recently evaluated outgrowth and toxinogenesis of C. botulinum group II type B in cooked ham model samples containing NaNO2 concentrations of 0, 30, 60 or 80 ppm and NaCl concentrations of 0, 1.2, 1.35, 1.6, 1.7, 1.8 or 1.9%. Storage conditions that could be encountered during the supply chain (14 days at 4° C., 1 h at 20° C. cold chain rupture, 33 days at 8° C.) were applied. In inoculated samples devoid of nitrite, toxin was detected. Miller et al. tested the efficacy of 2% and 6% pyruvate, lactate, acetate, citrate and propionate in an uncured turkey product with pH 6 containing 1.4% of salt. All tested compounds delayed neurotoxin production but only up to 18 days of storage was considered.

### Conclusion

The current study demonstrates that the invented blend containing dry buffered vinegar, red radish powder, rosemary extract and green tea extract can replace nitrite salts in emulsified cooked pork sausage when correctly dosed. The special blend generated a similar pink color as that observed with nitrite. This was particularly the case when ascorbic acid was excluded from the emulsified cooked pork sausage. The slightly different pink color generated by using about 0.4% or 0.5% of the present invention instead of nitrite, did not result in a penalty on the preference or acceptance score during a sensory analysis considering color, smell and taste. The color changes occurring during illuminated storage were more favorable for the sausages prepared with the special blend than for the positive control with nitrite. This was observed by the researchers in multiple case studies. It is widely accepted that consumers select a food product with their eyes, so products need to look fresh and tasty. As deli meats reach the consumer after illuminated display in the shelf of supermarkets our invented solution offers an advantage over the use of nitrite with regard to color stability.

The compositions of the present invention create additional hurdles for microorganisms to grow, where external parameters (packaging atmosphere, storage temperature) and intrinsic meat product parameters (pH, water content and water activity) work in concert with the antimicrobial components from the invented blend. The present invention outperformed nitrite with regard to L. monocytogenes outgrowth. Additionally, the use of the composition of the present invention as a nitrite replacement was able to deliver the additional advantage of a higher protection against this foodborne pathogen or the possibility to eliminate additional preservatives such as lactates, acetates and di-acetates. The compositions of the present invention also demonstrated effectiveness against C. botulinum germination and outgrowth in cooked emulsified pork sausages stored at 7° C. up to 8 weeks.

### Example 6: Evaluation in Meat Matrix with Low Salt

The objective of the current study was three-fold. The first objective was to validate the invented blend as a nitrite replacement solution in a more challenging meat matrix using low salt levels. Second, the aim was to gain insight in the potential synergistic or additive effects of the different constituents in the blend. Third, the current study evaluated the efficacy of the Exberry® product combination to replace nitrite salts in sausages.

### Materials and Methods

Experimental set up. A low salt emulsified cooked pork sausage was selected as study matrix. The salt level of 1.2% was chosen based on the market trend to reduce the salt content in meat products without compromising on the organoleptic and technological quality. Moreover, the salt level of 1.2% was selected to challenge the invented blend with a reasonable risk for C. botulinum outgrowth. The experimental set up of the current study is outlined in Table. Treatments #3-6 were designed to gain insight in the additive or synergistic effects of the different constituents in the blend. The treatments were dosed in such a way that they all delivered 720 ppm red radish powder and/or 0.29% dry buffered vinegar. Treatment #7 evaluated the Exberry® products applied at the dosage suggested by the supplier and treatment #8 addressed the combination of Exberry® products with buffered vinegar (BactoCEASE NV Dry) as no antimicrobial activity of the Exberry® products was expected. All samples were stored vacuum packed at 7° C. during 8 weeks. The following parameters were evaluated 1) cooking yield, 2) pH of the meat batter and end product, dry matter content and salt content, 3) acetic acid content, 4) appearance and color, 5) lipid oxidation, 6) outgrowth of Listeria monocytogenes and 7) outgrowth of Clostridium botulinum spores.

TABLE 23
Experimental set up of the study.

| | Experiment 1 | |
|---|---|---|
| Treatments | 1. Positive control (with NaNO₂) | |
| | 2. Negative control (without NaNO₂) | |
| | 3. 0.07% red radish powder | |
| | 4. 0.29% BactoCEASE ® NV Dry | |
| | 5. 0.07% red radish powder + 0.29% BactoCEASE NV Dry | |
| | 6. 0.40% blend | |
| | 7. 0.45% Exberry ® | |
| | 8. 0.45% Exberry ® + 0.29% BactoCEASE NV Dry | |
| Storage | 8 weeks, 7° C., 72 h illumination | |
| conditions | 8 weeks, 7° C., no illumination | |
| Analysis | Parameter | Frequency Week 0 |
| | Cooking yield | Week 0 |
| | pH, a_{w}, dry matter | Week 0 |
| | content, salt content* | |
| | Acetic acid content | Day 0, 7, 13, 28, 42, 56 |
| | Appearance and color | Day 0, 7, 13, 28, 42, 56 |
| | Lipid oxidation | Weekly |
| | Listeria monocytogenes | Bi-weekly |
| | challenge test** | |
| | Clostridium botulinum | |
| | challenge test*** | |

*analysis based on sodium content performed by Phytocontrol Analytics (Nimes, France).
**analysis performed by Micro-Smedt (Herentals, Belgium)
***analysis performed by the research group of Food Microbiology and Food Preservation of the University of Gent (FMFP-UGent) (Ghent, Belgium)

Materials. Ground (5 mm) lean pork meat (80/20 cuttings) and back fat was obtained from a local butcher. The meat and fat were divided in portions and kept at −18° C. until use. Curing salt (Esco 0.5%/0.6% NaNO2 lot 36185059) was bought from Agora Culinair (Herentals, Belgium) and chopping phosphate Tari® K2 (di- and triphosphates) (lot 7-52615-56) was obtained from Foodpack B.V. (Harderwijk, The Netherlands). A sample of ascorbic acid was obtained from Life Supplies (Olen, Belgium) (lot 1180150114). Kitchen salt, potato starch (Anco) and crushed ice, made from UV filtered pure water, were bought in a local supermarket. Red radish powder was obtained from Organic Herb Inc (Changsha, China). According to the supplier the powder had a color value E1% (514 nm) of 50.58 g¹ ml cm⁻¹. Exberry® Shade Intense Strawberry (84150006 lot SAM20-130073) and Exberry® Shade Brilliant Orange (10180001, lot SAM90-100772) were obtained from GNT (New York, USA). As stated on the product specification sheets, Exberry® Shade Intense Strawberry is manufactured from radish and carrot and Exberry® Shade Brilliant Orange is manufactured from pepper and carrot. The invented blend was prepared by mixing red radish powder, green tea extract and rosemary extract according to the ratios presented in Table 24. After an initial mixing step, dry buffered vinegar (BactoCEASE NV Dry) was added to the blend and homogenised once more.

TABLE 5
Composition of the invented blend.

| | | | | Active |
|---|---|---|---|---|
| | | | | component |
| Ingredient | % | Supplier | Lot | and % |
| BactoCEASE ® | 73.5 | Kemin | 1377211 | Acetic acid: |
| NV Dry | | 330110 | | 66.3% |
| Red radish | 18.0 | Organic | G0034.200925 | Pelargonidin- |
| powder | | Herb Inc | | 3-sophoroside- |
| | | B033.E05000 | | 5-glucoside |
| | | | | (derivatives): |
| | | | | unknown |
| Rosemary | 6.0 | Kemin | 2100200493 | Carnosic |
| extract | | RM00794 | | acid: 10.0% |
| Green tea | 2.5 | AVT India | 2000205020 | Total polyphenols: |
| extract | | RM00814 | | 97.72%; Total |
| | | | | Catechins: 74.5%; |
| | | | | EGCG: 39.24% |

EGCG: Epigallocatechin gallate.

Sausage preparation. The meat mixture for the emulsified cooked pork sausages were prepared according to the recipes summarized in Table 25 using the method described in Example 1. The sausages were cooked in a combi steamer (Eloma Joker MT, All Food Machines, Nazareth, Belgium) set at 80° C. and 100% relative humidity, during 35 min to reach a core temperature of 72° C. Subsequently, the sausages were cooled in cold tap water and kept at 2° C. until slicing. All treatments were prepared in duplicate.

TABLE 25
Recipes of emulsified cooked pork sausage.

| | | | | | Red radish | | | |
|---|---|---|---|---|---|---|---|---|
| Treatment | | | | | powder + | | | Exberry + |
| # | Pos. | Neg. | Red | BactoCEASE | BactoCEASE | | | BactoCEASE |
| Ingredient | control | control | radish | NV Dry | NV Dry | Blend | Exberry | NV Dry |
| (%) | 1 | 2 | 3 | 4 | 5 | 6 | 7 | 8 |
| Lean pork meat | 40.00 | 40.00 | 40.00 | 40.00 | 40.00 | 40.00 | 40.00 | 40.00 |
| Back fat | 35.00 | 35.00 | 35.00 | 35.00 | 35.00 | 35.00 | 35.00 | 35.00 |
| Kitchen salt | n/a | 1.19 | 1.19 | 1.19 | 1.19 | 1.19 | 1.19 | 1.19 |
| Curing salt | 1.20 | n/a | n/a | n/a | n/a | n/a | n/a | n/a |
| Chopping | 0.30 | 0.30 | 0.30 | 0.30 | 0.30 | 0.30 | 0.30 | 0.30 |
| phosphate | | | | | | | | |
| Ascorbic acid | 0.05 | n/a | n/a | n/a | n/a | n/a | n/a | n/a |
| Potato starch | 2.50 | 2.50 | 2.50 | 2.50 | 2.50 | 2.50 | 2.50 | 2.50 |
| Red radish | n/a | n/a | 0.07 | n/a | 0.07 | n/a | n/a | n/a |
| powder | | | | | | | | |
| BactoCEASE ® | n/a | n/a | n/a | 0.29 | 0.29 | n/a | n/a | 0.29 |
| NV Dry | | | | | | | | |
| Blend | n/a | n/a | n/a | n/a | n/a | 0.40 | n/a | n/a |
| Exberry ® | n/a | n/a | n/a | n/a | n/a | n/a | 0.40 | 0.40 |
| Shade | | | | | | | | |
| Intense | | | | | | | | |
| Strawberry | | | | | | | | |
| Exberry ® | n/a | n/a | n/a | n/a | n/a | n/a | 0.05 | 0.05 |
| Shade | | | | | | | | |
| Brilliant | | | | | | | | |
| Orange | | | | | | | | |
| Ice | 20.95 | 21.01 | 20.94 | 20.72 | 20.65 | 20.61 | 20.56 | 20.27 |

n/a: not applicable

Slicing, packaging and storage. Prepared sausages were cut into 2 mm slices and packed in vacuum pouches (50 mbar). The samples were stored at 7° C. up to 8 weeks. Part of the samples were exposed to continuous illumination (LED light, 3000 K, 1600 lux) during the last 72 h of the storage period to represent display in the shelf of the supermarket. For pork display, light color of 2900-3750 K and intensities of 800-1600 lux have been recommended. A second part of the samples were stored in complete darkness by placing the packages in aluminium pouches.

Water activity (a_{w}). The a_{w}-value of the sliced sausages was determined by blending the samples with a kitchen blender. Next an aliquot (2.0 g) was placed in a a_{w}-measuring cup and transferred into an AquaLab Pre water activity meter (LA Biosystems B.V., Waalwijk, The Netherlands) at 25° C.

Moisture content. The dry matter content of the samples was quantified by transferring 2.0 g of pre-mixed sausages in a pre-weighted aluminum moisture pan. Samples were dried in an oven set at 135° C. for 2 h. The final mass was determined after cooling in a desiccation chamber. The dry matter content was calculated according to Equation 7.

$$Formula to calculate moisture content ( \% ) .$$

$$Moisture content ( \% ) = 100 - \frac{initial mass of sample - mass of pan}{final mass of sample - mass of pan} \times 100. \qquad Equation 7$$

Determination of salt content. The salt content of the emulsified cooked sausages was determined by Phytocontrol Analytics (Nimes, France) and was calculated based on the sodium content of the sample. The salt in the aqueous phase was calculated according to Equation 8.

$$Formula to calculate salt content in aqueous phase ( \% ) .$$

$$Salt content in aqueous phase ( \% ) = \frac{salt content}{salt content + moisture content} . \qquad Equation 8$$

Determination of acetic acid content. The acetic acid content in emulsified cooked sausages was determined according to the standard operation procedure for volatile organic acids. An aqueous extract was acidified with formic acid and the acetic acid content was quantified by gas chromatography and a flame ionisation detector using valeric acid as internal standard.

Color evaluation. The color of the sausages was measured by determining CIE L*a*b-values as described in Example 1. Color differences were calculated from average L*a*b-values according to Equation 6. The appearance was monitored by taking photographs in a photo box with LED illumination (3000 lux).

Evaluation of lipid oxidation. Lipid oxidation in the cooked sausages was evaluated by measurement of the thiobarbituric acid reactive substances (TBARS) according to AOCS Official method Cd 19-90. Additional background readings were made to take into account the color of the extract solution when red radish powder or Exberry was used. Hereto, 2 ml of centrifuged and filtered extraction solution together with 2 ml of trichloroacetic acid were combined. The absorbance at 532 nm was measured and subtracted from the absorbance of the sample (2 ml extraction solution+2 ml thiobarbituric acid).

Listeria monocytogenes challenge study. The L. monocytogenes challenges study was performed by Micro-Smedt as described in Example 5.

Clostridium botulinum challenge study. The C. botulinum challenge test was performed by the research group of Food Microbiology and Food Preservation of the University of Ghent (FMFP-UGent) as described in Example 5. The emulsified cooked pork sausages (4 slices, 100 g) were inoculated with 50 μl of the spore suspension (1.0×10⁷ spores/ml for the first replicates and 1.1×10⁷ spores/ml for the second replicates) to obtain an inoculum size of approximately 500 spores/g. The samples were stored at 7° C. up to 8 weeks and were analyzed on day 0 (before and after inoculation), day 14, day 28, day 42 and day 56.

Data analysis. Every treatment was prepared in duplicate. For each replicate, the color of three slices was evaluated and the average and standard deviation of 6 L*a*b-values were calculated. ΔE*-values were determined based on the average L*a*b-values. Analysis of variance (one-way ANOVA) and multiple range tests (95.0 percent Least Significant Difference procedure) were performed using STATGRAPHICS® Centurion XVIII (Statpoint Technologies, Inc., Warrenton, USA) on the following parameters: cooking yields, 10^{pH}-values, a_{w}-values, moisture contents, salt contents, salt in the aqueous phase contents, acetic acid content, a*-values, TBARS concentration and Listeria monocytogenes counts.

### Results

Physico-chemical parameters. Table summarizes the physico-chemical parameters measured. All treatments resulted in non-significantly different (p>0.05) cooking yields of more than 99%. In general, the pH of the meat batter was slightly lower than after cooking. Some significant differences (p<0.05) were found between the pH-values of the different treatments; The sausages prepared with only BactoCEASE NV Dry (Treatment #4) resulted in the highest pH-value. All a_{w}-values were approximately 0.98 and not significantly different (p>0.05). The moisture contents ranged from 48.5 to 53.5%. The salt content was calculated based on the sodium content and was significantly higher (1.7% versus 1.5%) when BactoCEASE NV Dry was applied (Treatment #4, 5, 6 and 8). As the amount of salt in the water phase is a restricting factor for microbial growth⁶⁴, the salt content in the aqueous phase was calculated from the salt content and the moisture content according to Equation 4. The salt content in the aqueous phase was significantly (p<0.05) higher for treatments containing BactoCEASE NV Dry (Treatment #4, 5, 6 and 8) compared with the negative control. As expected, the acetic acid content was also higher (p<0.05) for treatments containing BactoCEASE NV Dry (Treatment #4, 5, 6 and 8) than for treatment without BactoCEASE NV Dry.

Appearance and color evaluation. The appearance and color of the emulsified cooked sausages were evaluated after different storage periods up to 8 weeks. One part of the samples was stored in complete darkness. The other part of the samples was exposed to light during the last 72 h of the storage period. Photographs taken at day 0, 7 and 56 are shown in FIG. 37. It was observed that the pink color of the positive control faded during illuminated storage. The initial color of samples including red radish powder (Treatment #3, 5 and 6) mimicked the initial color of the positive control. The initial color of the samples prepared with Exberry® appeared darker and more orange. The color differences compared with the initial color of the positive control (ΔE*) and the redness values (a*) are shown in FIG. 38. During storage in the dark the color differences remained the smallest for the positive control (FIG. 38A). Also, the color difference of the sample prepared with the invented blend remained below the just noticeable difference (JND) (ΔE*<2.3)^{12, 13.} During illuminated storage, the color difference of the positive control rapidly increased while the color differences for samples containing red radish powder (Treatment #3, 5 and 6) were only slightly above the JND FIG. 38B. FIG. 38D shows the rapid loss of redness of the positive control under illuminated condition resulting in the faded color. The high color difference of the samples prepared with Exberry® can be partly attributed to a higher redness value (FIGS. 38C and 38D). However, for these samples also lower L*- and b*-values were observed.

TABLE 26
Physico-chemical parameters (average ± standard deviation) of the treated
emulsified cooked pork sausages. Significant differences (p < 0.05) between
treatments are indicated with different letters.

| | | | | | Red radish | | | |
|---|---|---|---|---|---|---|---|---|
| | | | Red | | powder | | | Exberry ® + |
| Treatment | Positive | Negative | radish | BactoCEASE | BactoCEASE | | | BactoCEASE |
| # | control | control | powder | NV Dry | NV Dry | Blend | Exberry ® | NV Dry |
| Parameter | 1 | 2 | 3 | 4 | 5 | 6 | 7 | 8 |
| Cooking | 100.0 ± | 100.0 ± | 99.9 ± | 100.1 ± | 100.0 ± | 99.9^{a} | 100.0 ± | 100.0 ± |
| yield | 0.0^{a} | 0.0^{a} | 0.1^{a} | 0.3^{a} | 0.1^{a} | | 0.0^{a} | 0.0^{a} |
| (%) | | | | | | | | |
| pH of | 5.87^{ab} | 5.96^{bc} | 5.91^{ab} | 6.04^{c} | 5.88^{ab} | 5.92^{ab} | 5.82^{ab} | 5.86^{a} |
| meat | | | | | | | | |
| batter | | | | | | | | |
| pH of | 6.21^{a} | 6.39^{bc} | 6.32^{ab} | 6.47^{c} | 6.28^{ab} | 6.33^{ab} | 6.25^{ab} | 6.33 ^{ab} |
| cooked | | | | | | | | |
| meat | | | | | | | | |
| a_{w} | 0.978 ± | 0.974 ± | 0.979 ± | 0.979 ± | 0.976 ± | 0.986 ± | 0.978 ± | 0.976 ± |
| | 0.004^{a} | 0.003^{a} | 0.001^{a} | 0.001^{a} | 0.008^{a} | 0.012^{a} | 0.003^{a} | 0.001^{a} |
| Moisture | 52.3 ± | 52.7 ± | 52.8 ± | 52.3 ± | 53.5 ± | 50.9 | 48.5 ± | 50.8 ± |
| content | 0.3^{cd} | 0.7^{d} | 0.0^{d} | 0.5^{cd} | 0.5^{d} | ± 0.5^{bc} | 0.1^{a} | 1.3^{b} |
| (%) | | | | | | | | |
| Salt | 1.55 ± | 1.47 ± | 1.56 ± | 1.74 ± | 1.77 ± | 1.75 ± | 1.53 ± | 1.79 ± |
| content | 0.05^{a} | 0.02^{a} | 0.03^{a} | 0.00^{b} | 0.03^{b} | 0.10^{b} | 0.09^{a} | 0.12^{b} |
| (%) | | | | | | | | |
| Salt | 2.9 ± | 2.7 ± | 2.9 ± | 3.2 ± | 3.2 ± | 3.3 ± | 3.1 ± | 3.4 ± |
| content in | 0.1^{ab} | 0.1^{a} | 0.1^{ab} | 0.0^{bc} | 0.0^{bc} | 0.2^{c} | 0.2^{abc} | 0.3^{c} |
| aqueous | | | | | | | | |
| phase | | | | | | | | |
| (%) | | | | | | | | |
| Acetic | 0.008 ± | 0.015 ± | 0.007 ± | 0.217 ± | 0.215 ± | 0.223 ± | 0.013 ± | 0.217 ± |
| acid | 0.001^{a} | 0.008^{a} | 0.001^{a} | 0.005^{b} | 0.003^{b} | 0.008^{b} | 0.004^{a} | 0.005^{b} |
| content | | | | | | | | |
| (%) | | | | | | | | |

Lipid oxidation. Lipid oxidation in the emulsified cooked pork sausages was evaluated by measuring the TBARS concentration. Results are shown in FIG. 39. All treatments delayed lipid oxidation compared to the negative control. However, only the application of nitrite salt and the special blend could maintain low TBARS values during the entire shelf life of 8 weeks.

Listeria monocytogenes outgrowth. The emulsified cooked sausages were inoculated with 2.6 log₁₀CFU/g of a cocktail of L. monocytogenes and the number of CFU's was followed during 8 weeks (FIG. 40). The number of CFU's in the negative control sample increased from 0 up to 3 weeks to reach more than 7 log₁₀CFU/g. For the positive control the L. monocytogenes count increased slower in the first week, but also reached more than 7 log₁₀CFU/g after 3 weeks. The growth of L. monocytogenes in all sausages containing BactoCEASE NV Dry showed an extended lag time. The combination of Exberry® with BactoCEASE NV Dry resulted in the lowest counts followed by the invented blend.

Clostridium botulinum outgrowth. Duplicate samples were inoculated with a cocktail of C. botulinum spores at approximately 500 spores/g. Before inoculation the anaerobic count was below the detection limit of 1 log₁₀CFU/g. The anaerobic count, presumable C. botulinum, was evaluated during the shelf life (Table 27). In the negative control significant (>0.5 log 10CFU/g) growth was observed after 4 weeks of storage. The challenge test indicated no growth of C. botulinum in the positive control samples. Already after 6 weeks of storage one replicate of the samples prepared with only red radish powder (Treatment #3) showed significant growth. After 8 weeks of storage all replicates showed significant growth. One replicate of the samples prepared with only BactoCEASE NV Dry (Treatment #4) showed significant growth after 8 weeks of storage. Applying a combination of red radish powder and BactoCEASE NV Dry (Treatment #5 and 6) resulted in no significant growth. On the contrary, a decrease in anaerobic count was measured. A similar result was obtained for the combination of Exberry and BactoCEASE NV Dry (Treatment #8) while outgrowth was observed after 6 weeks when only Exberry (Treatment #7) was used.

TABLE 27
Anaerobic count (log₁₀CFU/g) (n = 2) (average ± standard deviation)
of the emulsified cooked pork sausage before and after storage at 7° C.
Significant outgrowth (>0.5 log₁₀CFU/g) in at least one replicate is
indicated with *.

| | | | Storage time (days) at 7° C. | | | |
|---|---|---|---|---|---|---|
| Treatment | # | 0 | 14 | 24 | 42 | 56 |
| Negative | 1 | 3.7 ± 0.0 | 3.9 ± 1.8 | 5.9* ± 0.8 | 6.0* ± 1.0 | 4.3* ± 0.4 |
| control | | | | | | |
| Positive | 2 | 3.7 ± 0.1 | 2.3 ± 0.3 | 2.4 ± 0.0 | 2.2 ± 0.1 | 2.2 ± 0.0 |
| control | | | | | | |
| Red radish | 3 | 3.6 ± 0.2 | 2.4 ± 0.3 | 2.4 ± 0.3 | 4.1* ± 1.4 | 5.2* ± 0.2 |
| powder | | | | | | |
| BactoCEASE | 4 | 3.7 ± 0.1 | 2.5 ± 0.1 | 2.4 ± 0.1 | 2.4 ± 0.4 | 3.2* ± 1.7 |
| NV Dry | | | | | | |
| Red radish | 5 | 3.6 ± 0.1 | 2.4 ± 0.4 | 2.5 ± 0.0 | 2.3 ± 0.2 | 2.4 ± 0.4 |
| powder + | | | | | | |
| BactoCEASE | | | | | | |
| NV Dry | | | | | | |
| Blend | 6 | 3.1 ± 0.8 | 2.7 ± 0.0 | 2.7 ± 0.2 | 2.4 ± 0.1 | 2.3 ± 0.1 |
| Exberry | 7 | 3.8 ± 0.0 | 2.9 ± 0.2 | 2.4 ± 0.1 | 3.9* ± 1.3 | 5.1* ± 0.5 |
| Exberry + | 8 | 3.5 ± 0.3 | 2.8 ± 0.2 | 2.5 ± 0.1 | 2.5 ± 0.1 | 2.1 ± 0.1 |
| BactoCEASE | | | | | | |
| NV Dry | | | | | | |

### Discussion

The different treatments had a minor impact on the pH-values, a_{w}-values and moisture contents of the prepared emulsified cooked sausages, which are important parameters for microbial control. With pH-values ranging from 6.27 to 6.41, the sausages are expected to support the growth of L. monocytogenes and C. botulinum for which respectively a minimum pH for growth of 4.4 and 4.6 has been reported. Also, the a_{w}-values in the sausages were above the growth limits of L. monocytogenes (0.92) and C. botulinum (0.94). As expected, the use of BactoCEASE NV Dry, on its own and in combination, resulted in a higher salt content and elevated acetic acid recovery. The cooking yield stayed unaffected which is of course an important concern for meat producers (Table).

The color values presented in the current study (FIG. 38) indicated that red radish powder is the main constituent in the special blend responsible for the desired pink color of the nitrite-free emulsified cooked pork sausages. Immediately after slicing, the color of all the sausages containing red radish powder (Treatment #3, 5 and 6) mimicked well the color of the positive control sample while the sausages prepared with only BactoCEASE NV Dry had inferior color values. The application of the Exberry products dosed at the concentration suggested by the supplier resulted in sausages with much higher color differences compared to the special blend created by the inventors. The sample containing 0.4% of the blend had numerically the smallest initial color difference with 2.2 just below the just noticeable difference cut off value of 2.3. The color changes occurring during dark storage were limited for all treatments. In Example 5, it was elucidated that the use of ascorbic acid in combination with red radish powder was not preferred as ascorbic acid might accelerate the degradation of the red radish anthocyanins⁴². Therefore, ascorbic acid was used in the positive control sample as curing accelerator but excluded in all other treatments (Table). The color changes occurring during illuminated storage where more favorable for all the sausages prepared with red radish powder than for the positive control as the redness of this latter sample was highly unstable. These results are in alignment with Example 5. It is well known that the pink cured meat color fades to gray when exposed to light and oxygen. Generally, also light exposure promotes degradation of anthocyanin pigments. Acylated anthocyanins, as present in red radish, have an increased light stability, compared to other anthocyanins, perhaps due to intramolecular co-pigmentation. Furthermore, Matsufuji et al. observed a remarkable increase in seven unidentified HPLC peaks when they exposed a red radish extract solution (0.2 w/v %) to light. The results suggest that some unknown anthocyanins were formed by photodegradation.

In this embodiment, the TBARS concentration of the negative control sample increased with increasing storage time and exceeded the threshold for detection of off-odor in pork (0.5 ppm). Hence, the antioxidative capacity of sodium nitrite was also confirmed by the results of the current study (FIG. 29). The current data suggest that all constituents in the compositions of the present invention contributed to delay lipid oxidation. For instance, the application of BactoCEASE NV Dry and red radish powder on their own delayed the lipid oxidation; however, the blended combination resulted in an even slower increase of TBARS values. Further, the special blend that included additional rosemary extract and green tea extract was the only treatment that maintained the TBARS values below the threshold for detection of off-odors with numerically lower values than the positive control. The best antioxidative action was observed with the special blend containing buffered vinegar (BactoCEASE NV Dry), red radish powder, rosemary extract, and green tea extract. The researchers observed that the combination of buffered vinegar, red radish powder, rosemary extract and green tea extract resulted in superior properties.

The results summarized in Table 27 show that the combined presence of red radish powder and BactoCEASE NV Dry is critical to control of C. botulinum in a nitrite-free low salt emulsified cooked sausages as no growth was detected for the samples prepared with red radish powder and BactoCEASE NV Dry, while and growth of C. botulinum was observed in the negative control and the samples prepare with red radish powder (Treatment #3), BactoCEASE NV Dry (Treatment #4) and Exberry (Treatment #7). To the best of the researchers' knowledge, the combination of red radish (powder or extract) and buffered vinegar has not been previously used to control C. botulinum in meat products.

### Conclusion

The results of the current study confirmed that the compositions of the present invention, specifically blends containing buffered vinegar and red radish (powder or extract) can replace nitrite in a more challenging meat matrix using low salt levels. Additional insights were obtained from the study, including color values indicated that the invented solution is capable of conferring the desired pink color of the nitrite-free emulsified cooked pork sausages. The current data indicated that all constituents in the developed blend contributed to delay lipid oxidation, while the presence of BactoCEASE NV Dry was indispensable to delay the outgrowth of L. monocytogenes while the combination of red radish powder and BactoCEASE NV Dry was critical to control outgrowth of C. botulinum in a nitrite-free low salt emulsified cooked sausages. The application of the Exberry products dosed at the concentration suggested by the supplier resulted in sausages resulted in higher color differences compared to the special blend.

### Example 7. Antimicrobial Compounds and Color Pigments in Red Radish Powder

The compositions of the present invention create additional hurdles for microorganisms to grow, where external parameters (packaging atmosphere, storage temperature) and intrinsic meat product parameters (pH, water content and water activity) work in concert with the antimicrobial components from the invented blend.

In at least one embodiment disclosed herein (Example 6), the main antimicrobial component is the combination of red radish, as source of antimicrobial agents and buffered vinegar providing acetic acid. The dry vinegar used is buffered to avoid denaturation of the meat proteins, and limit sensorial impact. In alternative embodiments, natural fermentates containing mixtures of organic acids (e.g. lactic acid and acetic acid) could be used. The researchers also analyzed the antimicrobial compounds present in three batches of the red radish powder as part of the compositions of the present invention. The concentrations of the identified compounds were compared to the radish and carrot containing product Exberry® Shade Intense Strawberry (84150006 lot SAM20-130073) (GNT, New York, USA). Using liquid chromatography and mass spectroscopy, a number of glucosinolates were identified and quantified (Table). A considerable larger concentration of glucosinolates was found in the red radish powder than in the Exberry product. In addition, volatile compounds with potential antimicrobial activity were tracked using gas chromatography and mass spectroscopy. Dimethyl disulphide and dimethyl trisulphide were detected in the red radish powder but not in the Exberry product. Finally, the concentration of allyl isothiocyanate, an enzymatic hydrolysis product of glucosinolates with known antimicrobial activity⁸⁴, was quantified in both products using gas chromatography and flam ionization detection. To the best of our knowledge glucosinolates and their hydrolysis products have never been reported with regard to C. botulinum control. Moreover, the combination with organic acid, as in the presented invention, is a new strategy for the meat industry to provide safety towards this pathogen.

TABLE 28
Glucosinolates and hydrolysis products identified in red
radish powder and in Exberry ® Shade Intense Strawberry.

| | Red radish powder | | | |
|---|---|---|---|---|
| | Batch | Batch | Batch | |
| | G0034.191124 | G0034.200925 | G0484.210702 | Exberry |
| Glucoraphasatin (ppm) | 433 | 376 | 468 | 112 |
| Glucoraphanin (ppm) | 33 | 35 | 38 | 24 |
| Glucoputrajivin (ppm) | 30 | 12 | 27 | 4 |
| Glucosisymbrin (ppm) | 0 | 4 | 0 | 0 |
| Glucosisaustricin (ppm) | 139 | 150 | 188 | 39 |
| Gluconasturtiin (ppm) | 132 | 101 | 177 | 0 |
| Sum (ppm) | 767 | 678 | 898 | 179 |
| Allylisothiocyanate (ppb) | 20 | 11 | 9 | 10 |

An additional and important advantage of the presented invention includes the fact that red radish powder delivers both coloring as well as antimicrobial properties. As discussed in previous examples the coloring properties are attributed to the anthocyanin present in red radish. The anthocyanin profile was analyzed using liquid chromatography (LC)-with mass spectrometry and diode array detection from three batches of red radish powder. The LC chromatogram at 520 nm is depicted in FIG. 41. Many different anthocyanins were identified and quantified based on a standard curve of Cyanidin-3-O[6″-O-(E-p-coum)-2″-O-(beta-xylopyranosyl)-beta-glucopyranoside]-5-O-beta-glucopyranoside. In general, most anthocyanins present were highly glycosylated and esterified (Table).

TABLE 29
Anthocyanins identified in red radish powder.

| | | | Red radish powder | | |
|---|---|---|---|---|---|
| | | | Batch | Batch | Batch |
| | | | G0034.191124 | G0034.200925 | G0484.210702 |
| | RT | | Cone (%, Cy | Cone (%, Cy | Cone (%, Cy |
| Anthocyanin | [M + H] + (min) | | equivalent) | equivalent) | equivalent) |
| Cyanidin-3-O-rhamnoside | 433 | 35.085 | 0.041% | 0.047% | 0.062% |
| Cyanidin-3-O-glucoside | 449 | 36.974 | 0.009% | 0.016% | 0.005% |
| Pelargonidin-3-O-sambubioside | 565 | 35.345 | 0.003% | 0.003% | 0.003% |
| Cyanidin-3-O-sophoroside- | 733 | 35.386 | 0.022% | 0.011% | 0.057% |
| 5-O-glucoside | | | | | |
| Cyanidin-3-O-xylosyl-p- | 889 | 34.95 | 0.017% | 0.012% | 0.000% |
| coumaroyl-glucosylgalactoside | | | | | |
| Pelargonidin-3-O-p-coumaroyl- | 903 | 36.434 | 1.729% | 1.401% | 1.218% |
| diglucoside-5-Oglucoside | | | | | |
| Cyanidin-3-O-xylosyl- | 919 | 36.029 | 2.486% | 2.307% | 1.767% |
| feruloyl-glucosylgalactoside | | | | | |
| Pelargonidin-3-O-feruloyl- | 933 | 36.502 | 2.815% | 2.328% | 1.973% |
| diglucoside-5-O-glucoside | | | | | |
| Pelargonidin-3-O-caffeoyl- | 1005 | 36.174 | 0.621% | 0.480% | 1.002% |
| diglucoside-5-O- | | | | | |
| malonyl-glucoside | | | | | |
| Cyanidin-3-O-caffeoyl- | 1021 | 36.781 | 0.208% | 0.162% | 0.325% |
| sophoroside-5-O- | | | | | |
| malonylglucoside | | | | | |
| Cyanidin-3-O-feruloyl- | 1035 | 36.521 | 0.012% | 0.011% | 0.012% |
| sophoroside-5-O- | | | | | |
| malonylglucoside | | | | | |
| Cyanidin-3-O-[2-O-(xylosyl)-6-O- | 1051 | 37.205 | 0.026% | 0.019% | 0.007% |
| (p-O-(glucosyl)-p-coumaroyl- | | | | | |
| glucoside]5-O-glucoside | | | | | |
| Cyanidin-3-O-caffeoyl- | 1081 | 36.347 | 0.427% | 0.379% | 0.533% |
| p-coumaroyl-sophoroside- | | | | | |
| 5-O-glucoside | | | | | |
| Cyanidin-3-O-p-coumaroyl- | 1095 | 36.646 | 0.548% | 0.464% | 0.428% |
| feruloyl-sophoroside- | | | | | |
| 5-O-glucoside | | | | | |
| Cyanidin-3-O-caffeoyl-feruloyl- | 1111 | 37.089 | 0.211% | 0.206% | 0.140% |
| sophoroside-5-O-glucoside | | | | | |
| Cyanidin-3-O-di-p-coumaroyl- | 1151 | 37.138 | 0.058% | 0.046% | 0.157% |
| sophoroside-5-O- | | | | | |
| malonylglucoside | | | | | |
| Cyanidin-3-O-p-coumaroyl- | 1167 | 37.408 | 0.028% | 0.030% | 0.043% |
| triglucoside-5-O-malonyl- | | | | | |
| glucoside | | | | | |
| Cyanidin-3-O-p-coumaroyl- | 1181 | 36.887 | 0.155% | 0.151% | 0.285% |
| feruloyl-sophoroside-5-O- | | | | | |
| malonyl-glucoside | | | | | |
| Cyanidin-3-O-p-coumaroyl- | 1181 | 37.167 | 0.252% | 0.221% | 0.676% |
| caffeoyl-sophoroside-5-O- | | | | | |
| succinoyl-glucoside | | | | | |
| Cyanidin-3-O-caffeoyl-feruloyl- | 1197 | 37.427 | 0.117% | 0.084% | 0.173% |
| sophoroside-5-O-malonyl- | | | | | |
| glucoside | | | | | |
| Cyanidin-3-O-p-coumaroyl- | 1343 | 36.916 | 0.047% | 0.043% | 0.136% |
| feruloyl-sophoroside-5-O- | | | | | |
| malonyl-sophoroside | | | | | |
| Cyanidin-3-O-caffeoyl-feruloyl- | 1359 | 37.176 | 0.023% | 0.017% | 0.025% |
| sophoroside-5-O-malonyl- | | | | | |
| sophoroside | | | | | |
| Cyanidin-3-O-p-coumaroyl- | 1373 | 36.685 | 0.002% | 0.001% | 0.002% |

sinapoyl-sophoroside-5-O-
malonyl-sophoroside

RT: retention time, Cy: Cyanidin-3-O-[6″-O-(E-p-coum)-2″-O-(beta-xylopyranosyl)-beta-glucopyranoside]-5-O-beta-glucopyranoside

### Example 8: Nitrite and Nitrate Content of the Special Blend

Recognizing that the goal of any nitrite replacement is to replace or eliminate the nitrite content in the final product, the researchers tested the total content of nitrite and nitrate of the composition of the present invention. Radishes are reported to contain high amounts of nitrate. Alahakoon, A. U., D. D. Jayasena, S. Ramachandra, and C. Jo., Alternatives to nitrite in processed meat: Up to date. Trends in Food Science & Technology, 45: 37-49 (2015). For this reason, radishes and its derivatives, such as red radish powder, had not been considered a suitable nitrite replacement as this characteristic renders it an unlikely choice for a nitrite replacement, where the general objective is to develop a natural product that is low in nitrite and nitrate.

With this in mind, the nitrite and nitrate content in the red radish powder and in the compositions of the present invention were analyzed by Neotron SpA (Modena, Italy) by ion chromatography with a detection limit of 10.0 mg/kg. The researchers concluded that there was no nitrite (<10 ppm) in the red radish powder or in the special blend. Nitrate was present in the red radish powder (827 ppm) and in the special blend (191 ppm). According to at least one embodiment, when the blend was dosed at 0.4-0.5%, the final composition included an acceptably low content, approximately 0.8-1.0 ppm nitrate to the end product.

### Example 9: Color Characterization

### Materials and Methods

Cooked cured products. Six different commercial emulsified cooked cold cuts were sourced from local supermarkets. All samples contained nitrite salt and four of them also contained carmine. In addition, one commercial cooked ham was included which did not contain additional food colorants. An emulsified cooked sausage (luncheon meat type) was prepared on lab scale as described in Example 1, including the nitrite control and the special blend. No carmine was added to the cooked sausage sample.

Color parameters. The color of the sliced cooked cured products was measured by determining CIE L*a*b* values as described in Example 1. The L*a*b-values were converted into polar coordinates L*C*h as described in Example 2. The L*a*b-values were also converted to red-green-blue-values (RGB-values) using a free online converter (available at https://www.nixsensor.com/free-color-converter/). Only for the lab made mortadella samples reflectance at different wavelengths was measured using a Hunterlab ColorFlex® Colorimeter (Elscolab NV, Kruibeke, Belgium). Next, the following ratio was calculated: reflectance at 650 nm/reflectance at 570 nm.

### Results & Discussion

Calculating the color values. The color values L*, a*, b*, C*, h and RGB of the cured cooked meat products are listed in Table 3. As summarized, cooked cured meat products display a wide variety of colors. As expected, products containing carmine as food colorant appeared pinker while products without carmine had higher hue-vales and appeared brown. The color of the nitrite-free alternatives prepared with the prototype was well within the color range of nitrite-cured cooked meats.

TABLE 30
Color values of commercial and lab made cured cooked
meat products.

| | | | | | | | |
|---|---|---|---|---|---|---|---|
| | Producer | | | | | | |
| Product | code | L* | a* | b* | c* | h | RGB |

With carmine

| | | | | | | | |
|---|---|---|---|---|---|---|---|
| Luncheon | B650 | 68.2 | 12.1 | 12.9 | 17.7 | 46.8 | 196/158/ |
| meat | | | | | | | 144 |
| Luncheon | B148 | 65.3 | 13.7 | 11.0 | 17.5 | 38.9 | 190/149/ |
| meat | | | | | | | 140 |
| Luncheon | NL101 | 67.7 | 12.3 | 11.2 | 16.6 | 42.3 | 195/157/ |
| meat | | | | | | | 145 |
| Luncheon | B75 | 65.6 | 13.4 | 11.9 | 18.0 | 41.6 | 191/150/ |
| meat | | | | | | | 139 |
| Luncheon | B808 | 68.9 | 11.0 | 12.4 | 16.6 | 48.5 | 196/161/ |
| meat | | | | | | | 146 |
| Nitrite control | | | | | | | |
| Nitrite-free | B808 | 64.7 | 9.9 | 11.7 | 15.4 | 49.8 | 182/150/ |
| luncheon meat | | | | | | | 137 |
| 0.9% blend | | | | | | | |
| Mortadella - | Protoype | 66.6 | 16.0 | 9.5 | 18.6 | 30.6 | 196/151/ |
| nitrite control | | | | | | | 146 |
| Nitrite-free | Prototype | 62.3 | 15.6 | 7.8 | 17.5 | 26.6 | 183/141/ |
| mortadella: | | | | | | | 137 |
| 0.75% blend | | | | | | | |

Without carmine

| | | | | | | | |
|---|---|---|---|---|---|---|---|
| Luncheon | B199 | 61.2 | 11.5 | 14.4 | 18.4 | 51.5 | 177/140 |
| meat | | | | | | | 123 |
| Fine meat | B650 | 69.0 | 8.0 | 15.0 | 17.0 | 61.9 | 193/163 |
| loaf | | | | | | | 142 |
| Cooked ham | 1T1482L | 64.6 | 9.0 | 10.7 | 14.0 | 50.1 | 180/151 |
| | | | | | | | 138 |
| Luncheon | Protoype | 73.9 | 5.4 | 11.3 | 12.5 | 64.6 | 200/178 |
| meat | | | | | | | 161 |
| nitrite control | | | | | | | |
| (n = 2)⁴ | | | | | | | |
| Nitrite-free | Prototype | 71.8 | 5.6 | 10.8 | 12.2 | 62.4 | 194/172 |
| luncheon meat: | | | | | | | 157 |
| 0.4% blend | | | | | | | |
| (n = 2)⁴ | | | | | | | |

Reflectance ratio. The reflectance of the mortadella style products was measured at 650 nm and 570 nm. The values, together with the reflectance ratio, are listed in Table 33. According to the reported scale in the Meat Color Measurements Guideline, the nitrite control mortadella sample showed a noticeable cured color. The nitrite-free alternative prepared with the invented blend had even a higher reflectance ratio, suggesting a desired ‘cured’ color.

TABLE 31
Reflectance values of lab-scale mortadella style products.

| | Reflectance | Reflectance | |
|---|---|---|---|
| Product | at 650 nm | at 570 nm | Ratio |
| With carmine | | | |
| Mortadella- | 67.50 | 37.63 | 1.81 |
| nitrite control | | | |
| Nitrite-free | 51.32 | 24.52 | 2.09 |
| mortadella- | | | |
| 0.75% blend | | | |

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

It should be further appreciated that minor dosage and formulation modifications of the composition and the ranges expressed herein may be made and still come within the scope and spirit of the present invention.

The foregoing description has been presented for the purposes of illustration and description. It is not intended to be an exhaustive list or limit the invention to the precise forms disclosed. It is contemplated that other alternative processes and methods obvious to those skilled in the art are considered included in the invention. The description is merely examples of embodiments. It is understood that any other modifications, substitutions, and/or additions may be made, which are within the intended spirit and scope of the disclosure. From the foregoing, it can be seen that the exemplary aspects of the disclosure accomplishes at least all of the intended objectives.

1. A curing aid comprising buffered vinegar and red radish in an amount capable of controlling microbial growth, providing a desired color to a meat product, and maintaining the color stability at pH levels ranging from 5.5 to 6.5, wherein the curing aid contains less than 250 ppm nitrate.

2. The curing aid of claim 1, further comprising one or more antioxidants.

3. The curing aid of claim 1, further comprising rosemary extract, green tea extract, or both.

4. The curing aid of claim 1, wherein the desired color is red, pink, or the color of the meat product when nitrite is used as the curing aid.

5. The curing aid of claim 1, wherein the ratio of buffered vinegar to red radish extract falls within the range of 5:1 to 2:1.

6. The curing aid of claim 1, wherein the curing aid is added to the meat product in an amount ranging from 0.4 to 1.5% by weight.

7. The curing aid of claim 1, wherein controlling microbial growth includes preventing the outgrowth of Clostridium botulinum and Listeria monocytogenes.

8. A method of making a nitrite-free meat product that has the properties of a meat product that has been cured with nitrites, comprising the step of adding a composition to the meat product that contains buffered vinegar and red radish extract in an amount capable of controlling microbial growth, providing a desired color to the meat, and maintaining color stability at pH levels ranging from 5.5 to 6.5, wherein the composition contains less than 250 ppm nitrate.

9. The method of claim 8, wherein the composition further comprises one or more antioxidants.

10. The method of claim 8, wherein the composition further comprises rosemary extract, green tea extract, or both.

11. The method of claim 8, where the desired color is a pink or red color.

12. The method of claim 8, wherein the ratio of buffered vinegar to red radish extract falls within the range of 5:1 to 2:1.

13. The method of claim 8, wherein the composition is added to meat in an amount ranging from 0.4 to 1.5% by weight.

14. The method of claim 8, wherein controlling the microbial growth includes controlling outgrowth of Clostridium botulinum and Listeria monocytogenes.

15. The method of claim 8, wherein the composition is a dry powder or liquid.

16. A method of using a nitrite-free curing aid comprising the step of adding to the meat buffered vinegar and red radish in amounts capable of controlling the outgrowth of Clostridium botulinum spores, providing a desired color to the meat, and maintaining color stability at pH levels ranging from 5.5 to 6.5.

17. The method of claim 16, wherein the use of the curing aid results in a meat product showing a cured effect without the use of nitrites.

18. The method of claim 16, wherein the desired color is a pink or red color.

19. The method of claim 16, wherein the ratio of buffered vinegar to red radish extract falls within the range of 5:1 to 2:1.

20. The method of claim 16, wherein the composition is added to meat in an amount ranging from 0.4 to 1.5% by weight.
